(19) United States
(12) Patent Application Publication
(10) Pub. No.: US 2025/0310810 A1
(43) Pub. Date: Oct. 2, 2025

(54) INDICATION FOR UE-INITIATED BEAM REPORTING

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 19/084,733

(22) Filed: Mar. 19, 2025

Related U.S. Application Data
(60) Provisional application No. 63/573,256, filed on Apr. 2, 2024.
(60) Provisional application No. 63/634,044, filed on Apr. 15, 2024.
(60) Provisional application No. 63/643,171, filed on May 6, 2024.
(60) Provisional application No. 63/644,358, filed on May 8, 2024.
(60) Provisional application No. 63/700,353, filed on Sep. 27, 2024.
(60) Provisional application No. 63/701,321, filed on Sep. 30, 2024.

(51) Int. Cl. H04W 24/10; H04B 7/06; H04W 72/21

(52) U.S. Cl. CPC H04W 24/10; H04B 7/0626; H04B 7/06968; H04W 72/21

(57) ABSTRACT

Methods and apparatuses for indication of UE-Initiated beam reporting are provided. A method performed by a user equipment (UE) includes receiving a transmission configuration indication (TCI) state, receiving information related to transmission of a user equipment (UE)-initiated beam report indication (UEIBRI) on a physical uplink control channel (PUCCH), and determining, based on the TCI state, one or more measurement reference signals (RSs) for evaluation of an event. The method further includes measuring the one or more measurement RSs, determining the event based on the measurement of the one or more measurement RSs, and transmitting, based on the determination of the event and the information, the UEIBRI.

### CROSS-REFERENCE TO RELATED AND CLAIM OF PRIORITY

The present application claims priority under 35 U.S.C. § 119 (e) to U.S. Provisional Patent Application No. 63/573,256 filed on Apr. 2, 2024; U.S. Provisional Patent Application No. 63/634,044 filed on Apr. 15, 2024; U.S. Provisional Patent Application No. 63/643,171 filed on May 6, 2024; U.S. Provisional Patent Application No. 63/644,358 filed on May 8, 2024; U.S. Provisional Patent Application No. 63/700,353 filed on Sep. 27, 2024; and U.S. Provisional Patent Application No. 63/701,321 filed on Sep. 30, 2024, which are hereby incorporated by reference in their entirety.

### TECHNICAL FIELD

The present disclosure relates generally to wireless communication systems and, more specifically, the present disclosure relates to methods and apparatus for indication of UE-Initiated beam reporting.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to indication for UE-Initiated beam reporting.

In one embodiment, a user equipment (UE) is provided. The UE includes a transceiver configured to receive a transmission configuration indication (TCI) state and receive information related to transmission of a user equipment (UE)-initiated beam report indication (UEIBRI) on a physical uplink control channel (PUCCH). The UE further includes a processor operably coupled with the transceiver. The processor is configured to determine, based on the TCI state, one or more measurement reference signals (RSs) for evaluation of an event; measure the one or more measurement RSs; and determine the event based on the measurement of the one or more measurement RSs. The transceiver is further configured to transmit, based on the determination of the event and the information, the UEIBRI.

In another embodiment, a base station (BS) is provided. The BS includes a processor, and a transceiver operably coupled with the transceiver. The processor is configured to transmit a TCI state; transmit information related to reception of a UEIBRI on a PUCCH; transmit one or more measurement RSs associated with the TCI state and evaluation of an event; and receive the UEIBRI after occurrence of the event.

In yet another embodiment, a method performed by a UE is provided. The method includes receiving a TCI state, receiving information related to transmission of a UEIBRI on a PUCCH, and determining, based on the TCI state, one or more measurement RSs for evaluation of an event. The method further includes measuring the one or more measurement RSs, determining the event based on the measurement of the one or more measurement RSs, and transmitting, based on the determination of the event and the information, the UEIBRI.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure; and

FIG. 7 illustrates an example method performed by a UE in a wireless communication system according to embodiments of the present disclosure.

### DETAILED DESCRIPTION

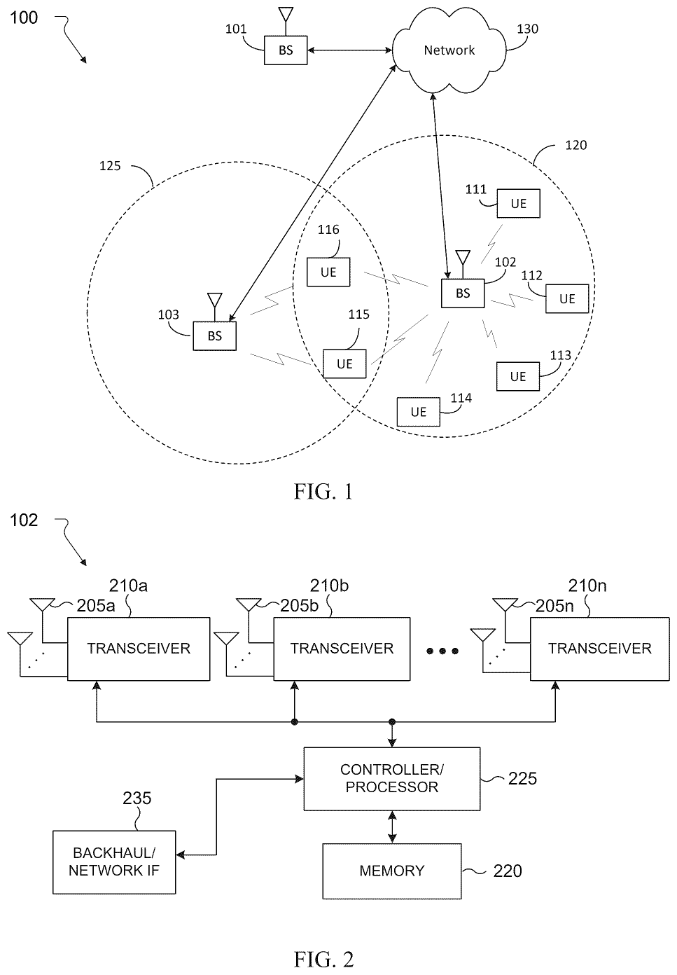

FIGS. 1-6, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1] 3GPP TS 38.211 v16.1.0, “NR; Physical channels and modulation;” [2] 3GPP TS 38.212 v16.1.0, “NR; Multiplexing and Channel coding;” [3] 3GPP TS 38.213 v16.1.0, “NR; Physical Layer Procedures for Control;” [4] 3GPP TS 38.214 v16.1.0, “NR; Physical Layer Procedures for Data;” [5] 3GPP TS 38.321 v16.1.0, “NR; Medium Access Control (MAC) protocol specification;” and [6] 3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for performing indication for UE-Initiated beam reporting. In certain embodiments, one or more of the BSs 101-103 include circuitry, programing, or a combination thereof to support indication for UE-Initiated beam reporting.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for indication of UE-Initiated beam reporting. Any of a wide variety of other functions could be supported in the gNB 102 by the controller/processor 225.

The controller/processor 225 is also capable of executing programs and other processes resident in the memory 230, such as to support indication for UE-Initiated beam reporting. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

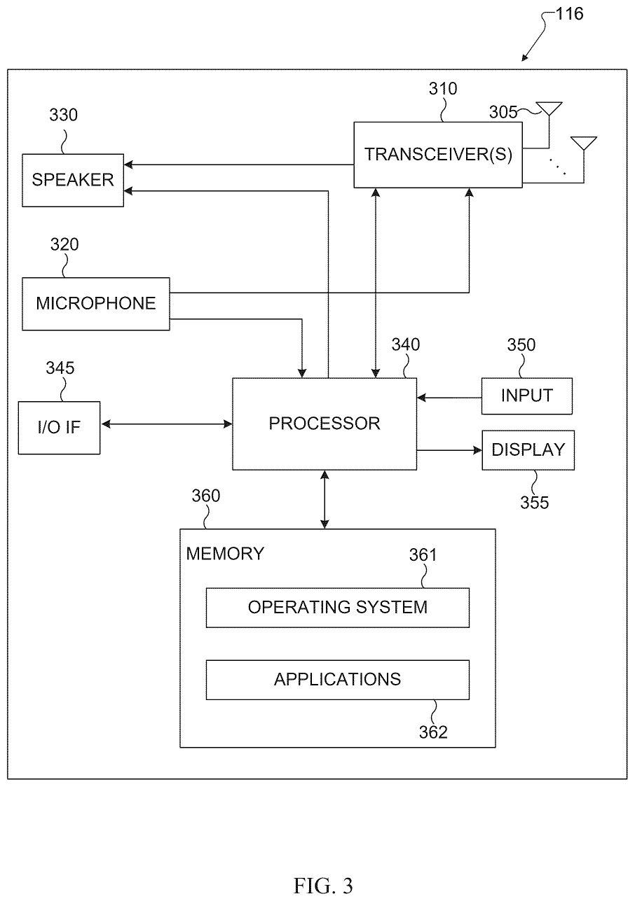

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for performing indication for UE-Initiated beam reporting as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

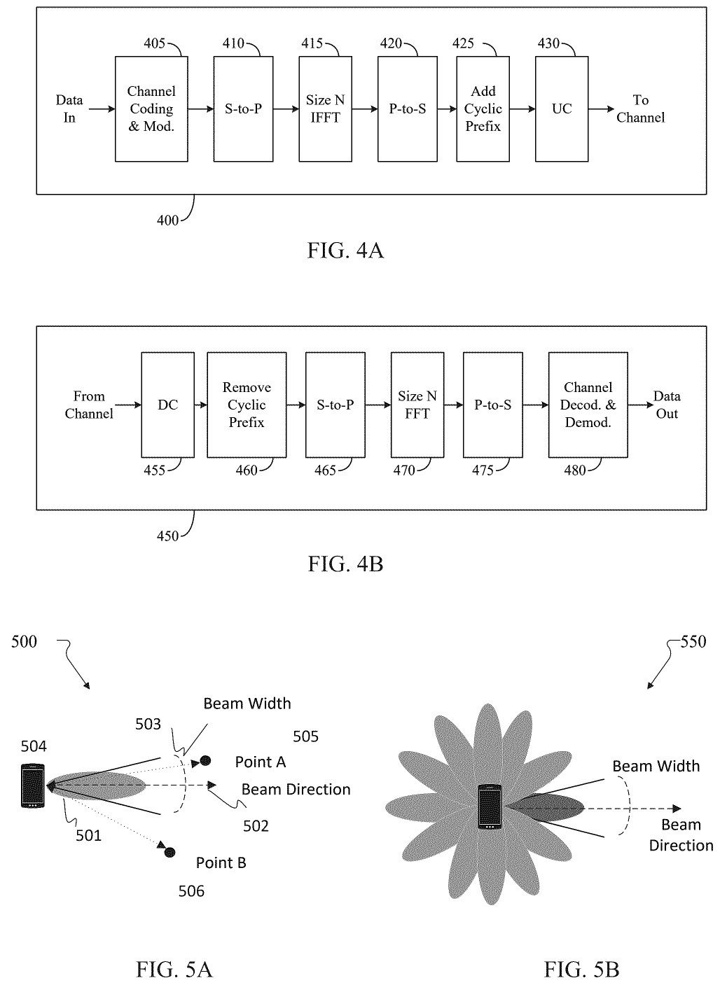

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the transmit path 400 is configured to transmit indication for UE-Initiated beam reporting as described in embodiments of the present disclosure. In some embodiments, the receive path 450 is configured to receive indication for UE-Initiated beam reporting as described in embodiments of the present disclosure.

As illustrated in FIG. 4A, the transmit path 400 includes a channel coding and modulation block 405, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding reference signal (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE.

As illustrated in FIG. 5A, in a wireless system 500, a beam 501 for a device 504 can be characterized by a beam direction 502 and a beam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by gNB 102 of FIG. 2. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

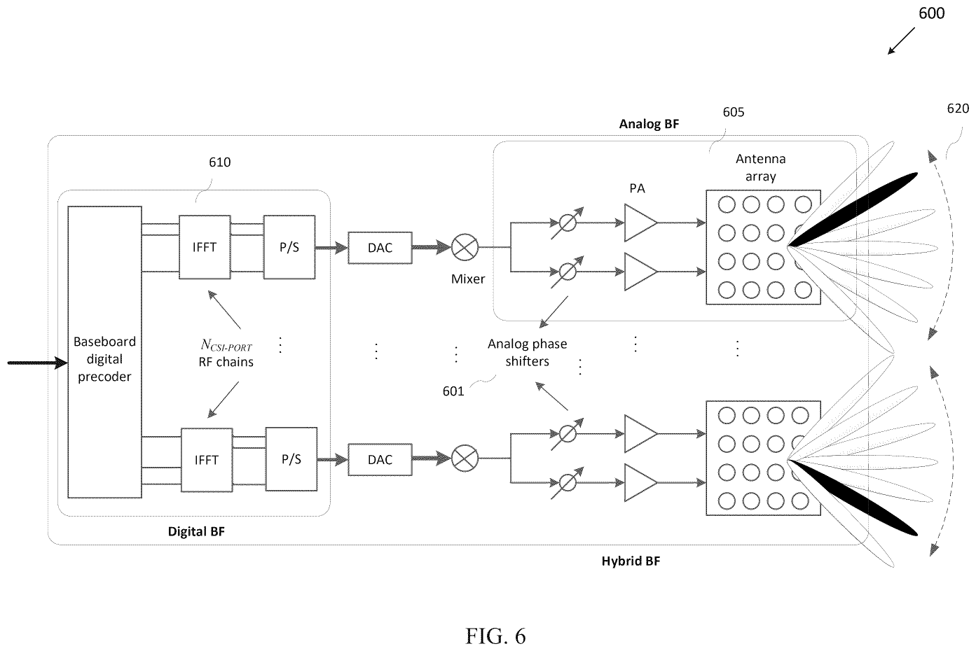

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports NCSI-PORT. A digital beamforming unit 610 performs a linear combination across NCSI-PORT analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as >52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

In (up to Rel.17) NR specification, the most resource-efficient reporting mechanism for a content (e.g. beam, CSI etc., or in general different report quantities) is aperiodic (in conjunction with aperiodic CSI-RS). On the other hand, with a well-chosen periodicity, periodic reporting (followed by semi-persistent) results in the lowest latency at the expense of resources. Although aperiodic reporting seems preferred from the overall operational perspective, in a few relevant scenarios the NW/gNB (e.g., the BS 102) lacks knowledge on the DL channel condition—or, in other words, the UE knows the DL channel condition better. In this case, it is clearly beneficial if the UE can initiate its own aperiodic reporting for a content (e.g. beam, CSI etc.) or trigger a beam switching for a condition or event. For instance, when the UE is configured only with aperiodic beam reporting and the channel condition is worsened to the point of beam failure, the loss of link due to beam failure can be avoided if the UE can transmit an aperiodic beam report without having to wait for a beam report request/trigger from the NW/gNB or trigger a new beam update without having to wait for a beam change or update indication from the NW/gNB. Likewise, when the UE is configured only with aperiodic CSI reporting and the channel condition is worsened due to UE speed/movement, the performance degradation due to faster link quality degradation can be avoided if the UE can transmit an aperiodic CSI report without having to wait for a CSI request/trigger from the NW/gNB or trigger a new beam update without having to wait for a beam change or update indication from the NW/gNB. Such UE-initiated reporting and/or beam switching for a content can be enabled for other types of report quantities (different from common beam or CSI reports) and application scenarios.

Although UE-initiated reporting and/or beam switching and/or beam activation/deactivation can be beneficial, efficient designs are needed to ensure that the latency is reduced and, at the same time, error events can be minimized. Accordingly, embodiments of the present disclosure recognize that there is a need for efficient designs for UE-initiated reporting and/or beam switching and/or beam activation/deactivation for a content that can offer good trade-off between latency and reliability, in particular, when the UE-initiated beam management framework can include multiple report types (or report quantities), or/and multiple event types when a report types can be associated with an event (e.g. for beam report, the event can be beam failure, and for CSI, the event can be user throughput degradation or increasing retransmission rate).

The present disclosure provides various aspects and detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means and/or procedures of transmitting the UE-initiated report(s) along with its indicator(s) via various uplink channels, and configuring and determining measurement RS resource(s) for the UE-initiated beam operations. This disclosure also specifies various resource allocation and indication methods for the UE-initiated beam operations.

In the present disclosure, a UE detects (or determines) a need for transmitting a UE-initiated/UE-triggered report (or initiation/triggering) of a (report-) type (A), (B), or (C), where
(A) includes an initiator/trigger/pre-notification message
(B) includes a report/content (comprising one or multiple report quantities)
(C) includes both a trigger/pre-notification message and a (corresponding) report/content

The UE could send to the network (e.g., the network 130) the UE-initiated (UEI)/UE-triggered report of a (report-) type (A), (B) and/or (C) according to one or more of:
Fixed rule(s) in system specification(s): for example, the UE could send to the network a UEI report of a (report-) type (A), or a (report-) type (B), or a (report-) type (C), or a (report-) type (A) followed by a (report-) type (B).
Network's configuration(s)/indication(s), e.g., via higher layer RRC signaling(s)/parameter(s) and/or MAC CE command(s) and/or dynamic downlink control information (DCI) based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report of a (report-) type (A), ‘01’ indicating a UEI report of a (report-) type (B), ‘10’ indicating a UEI report of a (report-) type (C), and ‘11’ indicating a UEI report of a (report-) type (A) followed by a (report-) type (B).
UE's autonomous determination, which could be further sent to the network, e.g., via/in part of a beam/CSI report or UE's capability signaling(s).

The report is to facilitate/enable efficient/timely/fast/reliable communication over the link/channel between a target entity (e.g. NW/gNB or another device) and the UE, and the content (if reported) can include a quantity or quantities. At least one of the following examples can be used/configured for the content:
In one example, the content includes beam-related quantity/quantities. For example, up to N≥1 indicators {Iᵢ} or pairs of {(Iᵢ,Jᵢ)}, where Iᵢ is an beam (source RS) indicator (e.g. CRI, SSB resource indicator (SSBRI)) and Jᵢ is a beam metric (e.g. L1-reference signal received power (RSRP)/L1-signal-to-interference-plus-noise ratio (SINR)).
In one example, the content includes CSI-related quantity/quantities. For example, at least one of rank indicator (RI), precoding matrix indicator (PMI), channel quality indicator (CQI), CQI report interval (CRI), layer index (L1).
In one example, the content includes TDCP-related quantity/quantities. For example, an indicator about the Doppler profile (e.g. Doppler spread or Doppler shift, relative Doppler spreads, or relative Doppler shifts), or an indicator about the auto-correlation profiles (e.g. (auto-) correlation values corresponding to a few dominant lags/delays).
In one example, the content includes other (e.g. non-beam, non-CSI, non-TDCP) quantity/quantities.
   In one example, quantity/quantities comprises a selector/indicator indicating selection of one (or >1) of either
      beam (TCI state) TCI states (e.g. DL TCI state, UL TCI state, or unified (joint) DL/UL TCI state), or
      panel(s) (e.g. UE panels for DL reception or/and UL transmission), or
      antenna (e) (e.g. UE antennae for DL reception or/and UL transmission), or
      antenna port(s) (e.g. UE antenna ports for DL reception or/and UL transmission).
   In one example, quantity/quantities comprises an indicator indicating switching from one beam to another beam, or from one panel to another, or from one antenna port group to another antenna port group, or from N₁ SRS ports to N₂ SRS ports, where N₁≠N₂ (e.g. this switching is for DL reception or/and UL transmission).
In one example, the content includes beam-related quantity/quantities (examples herein) and at least one other quantity/quantities (examples herein).
In one example, the content includes CSI-related quantity/quantities (examples herein) and at least one other quantity/quantities (examples herein).
In one example, the content includes TDCP-related quantity/quantities (examples herein) and at least one other quantity/quantities (examples herein).
In one example, the content includes beam-related quantity/quantities (examples herein) and CSI-related quantity/quantities (examples herein).
In one example, the content includes beam-related quantity/quantities (examples herein) and TDCP-related quantity/quantities (examples herein).
In one example, the content includes TDCP-related quantity/quantities (examples herein) and CSI-related quantity/quantities (examples herein).

In one example, the report is targeting a physical layer (L1) communication (e.g. L1 DL/UL, or L1 SL), i.e. such reporting is to enable fast/reliable DL/UL or SL transmission/reception.

In one example, the link/channel between the target entity and the UE is a Uu interface (i.e. DL, UL).

In one example, the link/channel between the target entity and the UE is a sidelink (SL), or a device-to-device (D2D) or PC5 interface.

In one example, such reporting can be non-event-based or autonomous, the UE can initiate/trigger the report autonomously (i.e. without being associated with any event) or unconditionally/freely. For example, the UE can be configured with a triggering time window (or multiple UL slots), and the UE can trigger the report during this window.

In one example, such reporting can be event-based, i.e., the UE can initiate/trigger the report only when it detects an event associated with the report, where the event can be of a (event-) type: type 0, type 1, and so on. In one example, type 0 corresponds to a beam-related event, type 1 corresponds to a CSI-related event, type 2 corresponds to a time-domain channel property (TDCP)-related event, and type 3 can be a non-CSI-related event (examples provided later). In one example, if a metric (depending on the event-type) is less than or equal to a threshold (or greater than or equal to a threshold), the event is detected or declared positive. The threshold is chosen such that a failure (e.g. beam/link failure) can be detected before it actually happens, and the UE-initiated report can avoid the failure.

In one example, such reporting can be non-event-based or event-based, based on report-type.

In one example, such reporting can be non-event-based or event-based, based on a configuration.

A few examples of the event-types and the report-types are provided in Table 1 (for joint) and Table 2/Table 3 (for separate). In these examples, the event-types and the report-types are separate (explicit). However, they can also be joint, as shown in Table 4. A few examples of the autonomous UE-initiated report are shown in Table 5.

TABLE 1
event-based UE-initiated report

| | Report | | |
|---|---|---|---|
| Event type | Type | Trigger/pre-notification message | Content |
| 0: beam | (A) | Yes (e.g. beam-related event) | No |
| | (B) | No | Yes |
| | (C) | Yes (e.g. beam-related event) | Yes |
| 1: CSI | (A) | Yes (e.g. CSI-related event) | No |
| | (B) | No | Yes |
| | (C) | Yes (e.g. CSI-related event) | Yes |
| 2: TDCP | (A) | Yes (e.g. TDCP-related event) | No |
| | (B) | No | Yes |
| | (C) | Yes (e.g. TDCP-related event) | Yes |
| 3: non-CSI/ | (A) | Yes (e.g. non-CSI-related event) | No |
| beam/TDCP | (B) | No | Yes |
| | (C) | Yes (e.g. non-CSI-related event) | Yes |
| 4. other (content- | (A) | Yes (no need for content) | No |
| free/less events) | | | |

TABLE 2
event-based UE-initiated report

| Event-type | Event |
|---|---|
| 0 | Beam-related |
| 1 | CSI-related |
| 2 | TDCP-related |
| 3 | Non-beam/CSI/TDCP |
| 4 | Other |

TABLE 3
event-based UE-initiated report

| Report-type | Trigger/pre-notification message | Content |
|---|---|---|
| (A) | Yes | No |
| (B) | No | Yes |
| (C) | Yes | Yes |

TABLE 4
event-based UE-initiated report
Report

| Type | Trigger/pre-notification message | Content |
|---|---|---|
| 0 | Yes (e.g. beam-related event), | No |
| | content-specific or event-specific | |
| 1 | No | Beam |
| 2 | Yes (e.g. beam-related event) | Beam |
| 3 | Yes (e.g. CSI-related event) | No |
| 4 | No | CSI |
| 5 | Yes (e.g. CSI-related event) | CSI |
| 6 | Yes (e.g. TDCP-related event) | No |
| 7 | No | TDCP |
| 8 | Yes (e.g. TDCP-related event) | TDCP |
| 9 | Yes (e.g. non-CSI-related event) | No |
| 10 | No | Non-CSI |
| 11 | Yes (e.g. non-CSI-related event) | Non-CSI |

TABLE 5
non-event-based or autonomous UE-initiated report
Report

| Type | Trigger/pre-notification message | Content |
|---|---|---|
| 0 | Yes (content-agnostic/transparent) | No |
| 1 | No | Beam |
| 2 | Yes | Beam |
| 3 | No | CSI |
| 4 | Yes | CSI |
| 5 | No | TDCP |
| 6 | Yes | TDCP |
| 7 | No | Non-CSI |
| 8 | Yes | Non-CSI |

In one example, when there is no content associated with a pre-notification (PN) message/trigger, i.e., the report-type is (A), the trigger/pre-notification message could simply provide a ‘hint/alarm/cue’ to the target entity (or purpose of the PN message/trigger as specified herein in the present disclosure) according to at least one of the following examples.
For example, the hint (or purpose of the PN message/trigger as specified herein in the present disclosure) is about the communication link/channel. For example, it can imply a need for a new or updated report (e.g. beam or CSI or TDCP). In this case, it is up to NW whether to configure a report for the content (separately).
For another example, the hint (or purpose of the PN message/trigger as specified herein in the present disclosure) is about an RS transmission. For example, it can imply a need for an aperiodic or semi-persistent RS (e.g. CSI-RS, SRS) transmission. The RS transmission can be from the target entity, or from the UE.
For another example, the hint (or purpose of the PN message/trigger as specified herein in the present disclosure) is about a selection/switch. For example, it can imply a need for switching from current A to another A, where A is one of current panel(s), TRP(s)/RRH(s), resource sets, antenna groups, antenna port groups.
For another example, the hint (or purpose of the PN message/trigger as specified herein in the present disclosure) is about beam/CSI parameters. For example, the parameter can be codebook type (e.g. from Type I to Type II or vice versa), or rank restriction (e.g. from high rank to low rank or vice versa).
For another example, the hint (or purpose of the PN message/trigger as specified herein in the present disclosure) is about RS parameters. For example, the parameter can be related to a AP RS trigger, or RS periodicity, or number of SRS ports (panel switch, 1 panel to 2 panel or vice versa) or number of RS resources.
For another example, the hint (or purpose of the PN message/trigger as specified herein in the present disclosure) is about transmission scheme, which can be one of PMI-based, diversity (cyclic delay diversity (CDD), cycling, space frequency block code (SFBC)), reciprocity (non-codebook (NCB), or non-PMI-feedback), or based on partial CSI (e.g. CRI-i1 or CRI-i1-CQI or LI-CRI-i1 or LI-CRI-i1-CQI), or based on single TRP to multi-TRP switch (or vice versa).
For another example, the hint (or purpose of the PN message/trigger as specified herein in the present disclosure) is about transmission parameters, e.g. modulation and coding scheme (MCS), or number of carrier waves (CWs).
For another example, when there is no pre-notification message/trigger associated with a content, i.e., the report-type is (B), the content can be transmitted using UL resource(s) configured (e.g. configured-grant physical uplink shared channel (PUSCH)), or reserved for the UE-initiated report, or via a random access channel (RACH) procedure.
For another example, the pre-notification (PN) message/trigger is to initiate or request or notify to the network (or the hint/purpose of the PN message/trigger as specified herein in the present disclosure is about) a transmission of a (beam) report/content—e.g., associated to the PN message/trigger, which could comprise one or more report quantities as specified/described herein in the present disclosure.

In the present disclosure, the UE could determine one or more purposes of the PN message/trigger and send the corresponding PN message(s)/trigger(s) to the network according to one or more of:
Fixed rule(s) in system specification(s): for example, the PN message is used to initiate or request or notify to the network (or the purpose of the PN message is about) a transmission of a (beam) report/content, which could comprise one or more indicators/triggers and/or report quantities as specified/described herein in the present disclosure.
Network's configuration(s)/indication(s), e.g., via higher layer RRC signaling(s)/parameter(s) and/or MAC CE command(s) and/or dynamic DCI based L1 signaling(s), based on/according to a corresponding UE's capability signaling: for example, the UE could receive from the network, e.g., via higher layer RRC signaling(s)/parameter(s) and/or MAC CE command(s) and/or dynamic DCI based L1 signaling(s), one or more indicators indicating one or more of the purposes of the PN message/trigger as specified herein in the present disclosure; for another example, the UE could be first higher layer RRC configured/provided by the network a list/set/pool of purposes of PN/trigger according to those specified herein in the present disclosure; the UE could then receive from the network a MAC CE/DCI to activate/indicate one or more purposes of the PN/trigger from the configured list/set/pool.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-) type (A) or (report-) type (C) as specified herein in the present disclosure, and/or the (corresponding) content—e.g., of (report-) type (B) or (report-) type (C) as specified herein in the present disclosure, the UE could send to the network a pre-notification (PN) message/trigger and/or the corresponding content(s) according to one or more of:
Fixed rule(s) in system specification(s): for example, the UE could send to the network a UEI report comprising only a PN message, or comprising only a content according to those specified herein in the present disclosure, or comprising both a PN message and a corresponding content.
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a 2-bit indicator with ‘00’ indicating a UEI report comprising only a PN message, ‘01’ indicating a UEI report comprising only a content according to those specified herein in the present disclosure, ‘10’/‘11’ indicating a UEI report comprising both a PN message and a corresponding content.
UE's autonomous determination, which could be further sent to the network, e.g., via/in part of a beam/CSI report or UE's capability signaling(s).

In one example, when a UE could or is able to or is configured to send to the network a UEI report comprising at least a pre-notification message/trigger—e.g., of (report-) type (A) or (report-) type (C) as specified herein in the present disclosure, and/or the (corresponding) content—e.g., of (report-) type (B) or (report-) type (C) as specified herein in the present disclosure, the UE could send to the network a pre-notification (PN) message/trigger and the same corresponding content(s) via/in a report/reporting instance/transmission/transmission occasion (e.g., via/in a same set of uplink resources including PUCCH(s), PUSCH(s), MAC CE(s), PRACH(s) and etc.) or different reports/reporting instances/transmissions/transmission occasions (e.g., via/in different sets of uplink resources including PUCCH(s), PUSCH(s), MAC CE(s), PRACH(s) and etc.) according to one or more of:
Fixed rule(s) in system specification(s): for example, the UE (e.g., the UE 116) could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), or the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
Network's configuration(s)/indication(s), e.g., via higher layer RRC signaling(s)/parameter(s) and/or MAC CE command(s) and/or dynamic DCI based L1 signaling(s), based on/according to a corresponding UE's capability reporting: for example, the UE could receive from the network, e.g., via higher layer RRC signaling(s)/parameter(s) and/or MAC CE command(s) and/or dynamic DCI based L1 signaling(s), a one-bit indicator with ‘0’ (or ‘1’) indicating that the UE could send to the network UEI report(s) comprising a pre-notification (PN) message/trigger and the corresponding content(s) via/in a same report/reporting instance/transmission/transmission occasion (e.g., via/in a same set of uplink resources including PUCCH(s), PUSCH(s), MAC CE(s), PRACH(s) and etc.), and ‘1’ (or ‘0’) indicating that the UE could send to the network UEI report(s) comprising a pre-notification (PN) message/trigger and the corresponding content(s) via/in different reports/reporting instances/transmissions/transmission occasions (e.g., via/in different sets of uplink resources including PUCCH(s), PUSCH(s), MAC CE(s), PRACH(s) and etc.).
UE's autonomous determination, which could be further sent to the network, e.g., via/in part of a beam/CSI report or UE's capability signaling(s).

The indicator(s)/trigger(s) described herein in the present disclosure could correspond to (or could be in part of) the trigger/pre-notification (PN) message in a (report-) type (A) based report or a (report-) type (C) based report, or could correspond to (or could be in part of) the (corresponding) content in a (report-) type (B) based report or a (report-) type (C) based report. Furthermore, the signaling medium/container for reporting a UE-initiated (UEI) report comprising at least the indicator(s)/trigger(s) or the report quantities or the pre-notification message/trigger or the corresponding content(s) as specified herein in the present disclosure (or equivalently, the trigger/pre-notification message in a (report-) type (A) based report or a (report-) type (C) based report, or part of the (corresponding) content in a (report-) type (B) based report or a (report-) type (C) based report) could be PUCCH, PUSCH, PRACH, MAC CE, uplink control information (UCI) and etc.

In one embodiment, the UEI report could comprise (1) report content(s)/quantity(s) including resource indicators including SSBRI(s) and/or CRI(s) and the corresponding beam metric(s) including L1-RSRP(s)/L1-SINR(s) for current serving beam(s) only, (2) report content(s)/quantity(s) including resource indicators including SSBRI(s) and/or CSI(s) and the corresponding beam metric(s) including L1-RSRP(s)/L1-SINR(s) for candidate beam(s) only, and/or (3) report quantity(s)/content(s) including resource indicators including SSBRI(s) and/or CSI(s) and the corresponding beam metric(s) including L1-RSRP(s)/L1-SINR(s) for both current serving beam(s) and candidate beam(s).
For example, the UE could be provided/indicated/configured by the network, e.g., via higher layer RRC signaling(s)/parameter(s) and/or MAC CE command(s) and/or dynamic DCI based L1 signaling(s)-according to or based on a corresponding UE's capability or capability signaling, whether or not the UEI report should or could comprise (1), (2) and/or (3) as described herein; for instance, when/if a higher layer RRC signaling/parameter denoted by ‘servBeamInclusion’ is provided or configured or set to ‘enabled’, the UEI report could or should comprise (1) and/or (3); otherwise, e.g., when/if the higher layer RRC signaling/parameter denoted by ‘servBeamInclusion’ is not provided or configured or set to ‘disabled’, or when/if a higher layer RRC signaling/parameter ueiReportContent is set to ‘candBeamOnly’ (or ‘noServBeam’) wherein the UEI report could or should comprise (2) as described herein
   In one example, the UEI report could or should comprise (1), which could be autonomously determined or decided by the UE. In this case, the UE could indicate to the network, e.g., via/in part of the UEI report, that the UEI report could comprise report content(s)/quantity(s) as defined/specified herein in the present disclosure for current serving beam(s) only—for instance, the UEI report could include, contain, comprise or provide an (one-bit/multi-bit) indicator; when/if the indicator is set to ‘1’ (or ‘0’ or ‘00’ or ‘01’ or ‘10’ or ‘11’), the UEI report could comprise (1); otherwise, the UEI report could comprise (2) or (3). Or the UE is expected to send or transmit the UEI report comprising (1).
   In another example, the UEI report could or should comprise (2), which could be autonomously determined or decided by the UE. In this case, the UE could indicate to the network, e.g., via/in part of the UEI report, that the UEI report could comprise report content(s)/quantity(s) as defined/specified herein in the present disclosure for candidate beam(s) only—for instance, the UEI report could include, contain, comprise or provide an (one-bit/multi-bit) indicator; when/if the indicator is set to ‘1’ (or ‘0’ or ‘00’ or ‘01’ or ‘10’ or ‘11’), the UEI report could comprise (2); otherwise, the UEI report could comprise (1) or (3). Or the UE is expected to send or transmit the UEI report comprising (2).
   In another example, the UE report could or should comprise (3), which could be autonomously determined or decided by the UE. In this case, the UE could indicate to the network, e.g., via/in part of the UEI report, that the UEI report could comprise report content(s)/quantity(s) as defined/specified herein in the present disclosure for both current serving beam(s) and candidate beam(s)—for instance, the UEI report could include, contain, comprise or provide a first (one-bit/multi-bit) indicator; when/if the first indicator is set to ‘1’ (or ‘0’ or ‘00’ or ‘01’ or ‘10’ or ‘11’), the UEI report could comprise (3); otherwise, the UEI report could comprise (1) or (2); furthermore, the UEI report could include, contain, comprise or provide one or more second indicators:
      For example, each of the one or more second indicators could correspond to or be associated to/with one or more report contents/quantities in the UEI report; when/if a second indicator is set to ‘1’ (or ‘0’ or ‘00’ or ‘01’ or ‘10’ or ‘11’), the report content(s)/quantity(s) corresponding/associated to the second indicator could be for current serving beam(s); otherwise, i.e., when/if a second indicator is set to ‘0’ (or ‘l’ or ‘00’ or ‘01’ or ‘10’ or ‘11’), the report content(s)/quantity(s) corresponding/associated to the second indicator could be for candidate beam(s).
      For example, the second indicator(s) could be in form of a bitmap with each entry/bit position of the bitmap corresponding or associated to/with one or more report contents/quantities in the UEI report; when/if an entry/bit position of the bitmap is set to ‘1’ (or ‘0’), the report content(s)/quantity(s) corresponding/associated to the entry/bit position in the bitmap could be for current serving beam(s); otherwise, i.e., when/if an entry/bit position of the bitmap is set to ‘0’ (or ‘1’), the report content(s)/quantity(s) corresponding/associated to the entry/bit position in the bitmap could be for candidate beam(s).
         Or the UE is expected to send or transmit the UEI report comprising (3).

Alternatively, when/if a higher layer RRC signaling/parameter, e.g., denoted by ueiReportContent is set to ‘servBeamOnly’, the UEI report could or should comprise (1), when/if the higher layer RRC signaling/parameter ueiReportContent is set to ‘candBeamOnly’ (or ‘noServBeam’), the UEI report could or should comprise (2), and/or when/if the higher layer RRC signaling/parameter ueiReportContent is set to ‘bothServAndCandBeam’, the UEI report could or should comprise (3). In this case, for (3), i.e., when/if the UE is configured to send a UEI report comprising report quantity(s)/content(s)-including resource indicator(s) such as SSBRI(s)/CRI(s) and/or beam metric(s) such as L1-RSRP(s)/L1-SINR(s)—for both the current serving beam(s) and the candidate beam(s), the UE could be further provided/indicated/configured by the network (e.g., the network 130), e.g., via higher layer RRC signaling(s)/parameter(s) and/or MAC CE command(s) and/or dynamic DCI based L1 signaling(s)-according to or based on a corresponding UE's capability or capability signaling, the position(s)/ordering(s)/CSI report number(s)/CSI report index(es)/CSI report field(s) of the report content(s)/quantity(s) for the current serving beam(s) and/or the report content(s)/quantity(s) for the candidate beam(s) in the UEI report(s).
For another example, the UE could autonomously determine, select or decide whether or not the UEI report should or could comprise (1), (2) and/or (3) as described herein, and indicate to the network, e.g., in/by part of the UEI report including the PN message, their determination or selection or decision.

In the design examples specified/described herein in the present disclosure, the value(s) of Nserv and/or Ncand could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). For instance, the UE could send or transmit PN message(s) to indicate the value(s) of Nserv and/or Ncand, and/or to indicate information related to the value(s) of Nserv and/or Ncand, wherein the PN message(s) could be in part 1 of a two-part UEI report (or a two-part UCI). Optionally, according to those specified herein in the present disclosure, a UEI report could comprise a mixture of both CRI(s) and SSBRI(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the CRI(s) and/or SSBRI(s) reported in the same UEI report. In addition, one or more of the resource indicators reported in the UEI report could be associated or corresponding or specific to an indicator (provided, indicated, contained, included or comprised in the same UEI report). The indicator(s) could indicate whether the resource indicator(s) associated or corresponding or specific to the indicator(s) is CRI(s) or SSBRI(s). For instance, the indicator(s) could be one-bit indicator(s), and when/if an indicator is set to ‘0’ (or ‘1’), the resource indicator(s) associated or corresponding or specific to the indicator in a UEI report could correspond to a SSBRI, and when/if an indicator is set to ‘1’ (or ‘0’), the resource indicator(s) associated or corresponding or specific to the indicator in the UEI report could correspond to a CRI. Furthermore, a UEI report could also comprise a mixture of both L1-RSRP(s) and L1-SINR(s). For this case, the UE could indicate to the network, e.g., via/in part of the UEI report—for instance, via/by/in the PN message wherein the PN message could be in part 1 of a two-part UEI report (or a two-part UCI), the number(s)/value(s)/quantity(s) of the L1-RSRP(s) and/or L1-SINR(s) reported in the same UEI report. In addition, one or more of the radio link/beam quality(s) or metric(s) reported in the UEI report could be associated or corresponding or specific to an indicator (provided, indicated, contained, included or comprised in the same UEI report). The indicator(s) could indicate whether the radio link/beam quality(s)/metric(s) associated or corresponding or specific to the indicator(s) is L1-RSRP(s) or L1-SINR(s). For instance, the indicator(s) could be one-bit indicator(s), and when/if an indicator is set to ‘0’ (or ‘1’), the radio link/beam quality(s)/metric(s) associated or corresponding or specific to the indicator in a UEI report could correspond to a L1-RSRP, and when/if an indicator is set to ‘1’ (or ‘0’), the radio link/beam quality(s)/metric(s) associated or corresponding or specific to the indicator in the UEI report could correspond to a L1-SINR.

For a first event, wherein the radio link or beam quality(s) of one or more current serving beams is below or less than or equal to a threshold-A (an instance for the first event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s). In this case, a/the UEI report, e.g., for the first event, could comprise one or more of the following components for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure:
Component-1a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-1b: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-1c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1a for the one or more first current serving beams; differential RSRP/SINR reporting could be applied to Component-1c according to those specified herein in the present disclosure.
Component-1d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1b for the one or more second current serving beams; differential RSRP/SINR reporting could be applied to Component-1d according to those specified herein in the present disclosure.
Component-1e: indicator(s) or bitmap(s) indicating the one or more first current serving beams—e.g., out of the current serving beams
Component-1f: indicator(s) or bitmap(s) indicating the one or more second current serving beams—e.g., out of the current serving beams or out of the first current serving beam(s)
Component-1g: a number of the one or more first current serving beams in the UEI report(s)
Component-1h: a number of the one or more second current serving beams in the UEI report(s)
Component-1i: indicator(s) indicating occurrence of the first event and/or an event index/ID associated/specific/corresponding to the first event
Component-1j: difference(s) between the beam metric(s) such as L1-RSRP(s)/L1-SINR(s) for the one or more first current serving beams and the threshold-A; For instance, if a (differential) L1-RSRP/L1-SINR value computed with respect to or regarding or for a first current serving beam is x dBm, and the threshold-A is y dBm, a difference delta_diff_A=|x−y| dBm could be reported in the UEI report as a report content/quantity, and a corresponding one-bit sign indicator indicating either positive or negative of the difference could also be reported in the same UEI report. Or the difference delta_diff_A=(x−y) and/or (y−x) dBm could be reported in the UEI report as a report content/quantity. Optionally, the value of delta_diff_A could be quantized to a u-bit value with a v dB step size with respect to the threshold-A.
Component-1k: difference(s) between the beam metric(s) such as L1-RSRP(s)/L1-SINR(s) for the one or more second current serving beams and the threshold-A; For instance, if a (differential) L1-RSRP/L1-SINR value computed with respect to or regarding or for a second current serving beam is x′ dBm, and the threshold-A is y dBm, a difference delta_diff_A′=|x′−y| dBm could be reported in the UEI report as a report content/quantity, and a corresponding one-bit sign indicator indicating either positive or negative of the difference could also be reported in the same UEI report. Or the difference delta_diff_A′=(x′−y) and/or (y−x′) dBm could be reported in the UEI report as a report content/quantity.
Component-1l: indicator(s) indicating presence or absent of Component-1a in the UEI report(s); e.g., the indicator(s) could be a one-bit indicator with ‘1’ (or ‘0’) indicating presence and ‘0’ (or ‘1’) indicating absence of Component-1a in the UEI report(s). Optionally, the value of delta_diff_A′ could be quantized to a u-bit value with a v dB step size with respect to the threshold-A.
Component-1m: indicator(s) indicating presence or absent of Component-1b in the UEI report(s); e.g., the indicator(s) could be a one-bit indicator with ‘1’ (or ‘0’) indicating presence and ‘0’ (or ‘1’) indicating absence of Component-1b in the UEI report(s).
Component-1n: indicator(s) indicating presence or absent of Component-lc in the UEI report(s); e.g., the indicator(s) could be a one-bit indicator with ‘1’ (or ‘0’) indicating presence and ‘0’ (or ‘1’) indicating absence of Component-1c in the UEI report(s).
Component-1o: indicator(s) indicating presence or absent of Component-Id in the UEI report(s); e.g., the indicator(s) could be a one-bit indicator with ‘1’ (or ‘0’) indicating presence and ‘0’ (or ‘1’) indicating absence of Component-1d in the UEI report(s).
Component-1p: indicator(s) indicating presence or absence of Component-1j in the UEI report(s); e.g., the indicator(s) could be a one-bit indicator with ‘1’ (or ‘0’) indicating presence and ‘0’ (or ‘1’) indicating absence of Component-1j in the UEI report(s).
Component-1q: indicator(s) indicating presence or absence of Component-1k in the UEI report(s); e.g., the indicator(s) could be a one-bit indicator with ‘1’ (or ‘0’) indicating presence and ‘0’ (or ‘1’) indicating absence of Component-1k in the UEI report(s).

The value(s) of threshold-A, threshold-A′, Ns, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Ns>1. In another example, Ns≥1.

For a second event, wherein the radio link or beam quality(s) of one or more candidate beams is beyond or greater than or equal to a threshold-B (an instance for the second event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s)-throughout the present disclosure, a candidate beam is equivalent to a candidate new beam or a new beam. In this case, a/the UEI report, e.g., for the second event, could comprise one or more of the following components for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure:
Component-2a: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-2b: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-2c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2a for the one or more first candidate beams; differential RSRP/SINR reporting could be applied to Component-2c according to those specified herein in the present disclosure.
Component-2d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2b for the one or more second candidate beams; differential RSRP/SINR reporting could be applied to Component-2d according to those specified herein in the present disclosure.
Component-2e: indicator(s) or bitmap(s) indicating the one or more first candidate beams—e.g., out of the candidate beams
Component-2f: indicator(s) or bitmap(s) indicating the one or more second candidate beams—e.g., out of the candidate beams or out of the first candidate beam(s)
Component-2g: a number of the one or more first candidate beams in the UEI report(s)
Component-2h: a number of the one or more second candidate beams in the UEI report(s)
Component-2i: indicator(s) indicating occurrence of the second event and/or an event index/ID associated/specific/corresponding to the second event
Component-2j: difference(s) between the beam metric(s) such as L1-RSRP(s)/L1-SINR(s) for the one or more first candidate beams and the threshold-B; For instance, if a (differential) L1-RSRP/L1-SINR value computed with respect to or regarding or for a first candidate beam is x dBm, and the threshold-B is y dBm, a difference delta_diff_B=|x−y| dBm could be reported in the UEI report as a report content/quantity, and a corresponding one-bit sign indicator indicating either positive or negative of the difference could also be reported in the same UEI report. Or the difference delta_diff_B=(x−y) and/or (y−x) dBm could be reported in the UEI report as a report content/quantity. Optionally, the value of delta_diff_B could be quantized to a u-bit value with a v dB step size with respect to the threshold-B.
Component-2k: difference(s) between the beam metric(s) such as L1-RSRP(s)/L1-SINR(s) for the one or more second candidate beams and the threshold-B; For instance, if a (differential) L1-RSRP/L1-SINR value computed with respect to or regarding or for a second candidate beam is x′ dBm, and the threshold-B is y dBm, a difference delta_diff_B′=|x′−y| dBm could be reported in the UEI report as a report content/quantity, and a corresponding one-bit sign indicator indicating either positive or negative of the difference could also be reported in the same UEI report. Or the difference delta_diff_B′=(x′−y) and/or (y−x′) dBm could be reported in the UEI report as a report content/quantity. Optionally, the value of delta_diff_B′ could be quantized to a u-bit value with a v dB step size with respect to the threshold-B.
Component-2l: indicator(s) indicating presence or absent of Component-2a in the UEI report(s); e.g., the indicator(s) could be a one-bit indicator with ‘1’ (or ‘0’) indicating presence and ‘0’ (or ‘1’) indicating absence of Component-2a in the UEI report(s).
Component-2m: indicator(s) indicating presence or absent of Component-2b in the UEI report(s); e.g., the indicator(s) could be a one-bit indicator with ‘1’ (or ‘0’) indicating presence and ‘0’ (or ‘1’) indicating absence of Component-2b in the UEI report(s).
Component-2n: indicator(s) indicating presence or absent of Component-2c in the UEI report(s); e.g., the indicator(s) could be a one-bit indicator with ‘1’ (or ‘0’) indicating presence and ‘0’ (or ‘1’) indicating absence of Component-2c in the UEI report(s).
Component-2o: indicator(s) indicating presence or absent of Component-2d in the UEI report(s); e.g., the indicator(s) could be a one-bit indicator with ‘1’ (or ‘0’) indicating presence and ‘0’ (or ‘1’) indicating absence of Component-2d in the UEI report(s).
Component-2p: indicator(s) indicating presence or absence of Component-2j in the UEI report(s); e.g., the indicator(s) could be a one-bit indicator with ‘1’ (or ‘0’) indicating presence and ‘0’ (or ‘1’) indicating absence of Component-2j in the UEI report(s).
Component-2q: indicator(s) indicating presence or absence of Component-2k in the UEI report(s); e.g., the indicator(s) could be a one-bit indicator with ‘1’ (or ‘0’) indicating presence and ‘0’ (or ‘1’) indicating absence of Component-2k in the UEI report(s).

The value(s) of threshold-B, threshold-B′, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. In one example, Nc>1. In another example, Nc≥1.

For a third event, wherein the radio link or beam quality(s) of one or more current serving beams is below or less than or equal to a threshold-A (an instance for the third event), and the radio link or beam quality(s) of one or more candidate beams is beyond or greater than or equal to a threshold-B, a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s), and/or report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s). In this case, a/the UEI report, e.g., for the third event, could comprise one or more of the Component-1a to Component-1q as specified/defined herein in the present disclosure for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure, and one or more of the Component-2a to Component-2q for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure, and/or Component-3: indicator(s) indicating occurrence of the third event and/or an event index/ID associated/specific/corresponding to the third event.

For a fourth event, wherein the radio link or beam quality(s) of one or more (or at least one) candidate beams is beyond or greater than the radio link or beam quality(s) of one or more current serving beams by a threshold-C (an instance for the fourth event), a/the UEI report could comprise report content(s)/quantity(s) including resource indicator(s) such as SSBRI(s)/CRI(s) and/or beam metric(s) such as L1-RSRP(s)/L1-SINR(s) for the current serving beam(s), and/or report content(s)/quantity(s) including resource indicator(s) such as SSBRI(s)/CRI(s) and/or beam metric(s) such as L1-RSRP(s)/L1-SINR(s) for the candidate beam(s), and/or information related to presence or absence of one or more of the report contents/quantities as described/specified herein in the present disclosure for the current serving beam(s), and/or information related to presence or absence of one or more of the report contents/quantities as described/specified herein in the present disclosure for the candidate beam(s), and/or quality metric(s) such as first difference(s) between the beam metric(s) such as L1-RSRP(s)/L1-SINR(s) for the current serving beam(s) and the beam metric(s) such as L1-RSRP(s)/L1-SINR(s) for the candidate beam(s), second difference(s) between the first difference(s) and the threshold-C. In this case, a/the UEI report, e.g., for the fourth event, could comprise one or more of the following components for one or more first current serving beams, wherein the one or more first current serving beams could comprise one or more (e.g., Ns) second current serving beams with their associated/corresponding radio link/beam quality(s) greater than or equal to or beyond a threshold-C′ or with their associated/corresponding radio link/beam quality(s) corresponding to the highest (or lowest) Ns radio link/beam quality(s) among the one or more first current serving beams as defined/specified herein in the present disclosure, and/or for one or more first candidate beams, wherein the one or more first candidate beams could comprise one or more (e.g., Nc) second candidate beams with their associated/corresponding radio link/beam quality(s) greater than or equal to or beyond a threshold-C″ or with their associated/corresponding radio link/beam quality(s) corresponding to the highest (or lowest) Nc radio link/beam quality(s) among the one or more first candidate beams as defined/specified herein in the present disclosure; in this case, as specified/described herein in the present disclosure, the radio link or beam quality(s) of the first candidate beam(s) is beyond or greater than the radio link or beam quality(s) of the first current serving beam(s) by the threshold-C.
Component-4a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE (e.g., the UE 116) uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-4b: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-4c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4a for the one or more first current serving beams; differential RSRP/SINR reporting could be applied to Component-4c according to those specified herein in the present disclosure.
Component-4d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4b for the one or more first candidate beams; differential RSRP/SINR reporting could be applied to Component-4c according to those specified herein in the present disclosure.
Component-4e: first difference(s) between the beam metric(s) such as L1-RSRP(s)/L1-SINR(s) for the one or more first current serving beams and the beam metric(s) such as L1-RSRP(s)/L1-SINR(s) for the one or more first candidate beams; For instance, if a (differential) L1-RSRP/L1-SINR value computed with respect to or regarding or for a first current serving beam is x1 dBm, and a (differential) L1-RSRP/L1-SINR value computed with respect to or regarding or for a first candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4f: second difference(s) between the first difference(s) in Component-4e and the threshold-C; For instance, for a first difference delta_diff_C (or |delta_diff_C|) specified/defined or obtained in Component-4e and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z-delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4g: indicator(s) or bitmap(s) indicating the one or more first current serving beams—e.g., out of the current serving beams
Component-4h: indicator(s) or bitmap(s) indicating the one or more first candidate beams—e.g., out of the candidate beams.
Component-4i: a number of the one or more first current serving beams in the UEI report(s)
Component-4j: a number of the one or more first candidate beams in the UEI report(s)
Component-4k: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-4l: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-4m: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4k for the one or more second current serving beams; differential RSRP/SINR reporting could be applied to Component-4m according to those specified herein in the present disclosure.
Component-4n: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4l for the one or more second candidate beams; differential RSRP/SINR reporting could be applied to Component-4n according to those specified herein in the present disclosure.
Component-4o: first difference(s) between the beam metric(s) such as L1-RSRP(s)/L1-SINR(s) for the one or more second current serving beams and the beam metric(s) such as L1-RSRP(s)/L1-SINR(s) for the one or more second candidate beams; For instance, if a (differential) L1-RSRP/L1-SINR value computed with respect to or regarding or for a second current serving beam is x1 dBm, and a (differential) L1-RSRP/L1-SINR value computed with respect to or regarding or for a second candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4p: second difference(s) between the first difference(s) in Component-4o and the threshold-C; For instance, for a first difference delta_diff_C (or |delta_diff_C|) specified/defined or obtained in Component-4o and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z-delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4q: indicator(s) or bitmap(s) indicating the one or more second current serving beams—e.g., out of the current serving beams or out of the first current serving beam(s)
Component-4r: indicator(s) or bitmap(s) indicating the one or more second candidate beams—e.g., out of the candidate beams or out of the first candidate beam(s).
Component-4s: a number of the one or more second current serving beams in the UEI report(s)
Component-4t: a number of the one or more second candidate beams in the UEI report(s)
Component-4u: indicator(s) indicating occurrence of the fourth event and/or an event index/ID associated/specific/corresponding to the fourth event
Component-5a: indicator(s) indicating presence or absent of Component-4a in the UEI report(s); e.g., the indicator(s) could be a one-bit indicator with ‘1’ (or ‘0’) indicating presence and ‘0’ (or ‘1’) indicating absence of Component-4a in the UEI report(s).
Component-5b: indicator(s) indicating presence or absent of Component-4b in the UEI report(s); e.g., the indicator(s) could be a one-bit indicator with ‘1’ (or ‘0’) indicating presence and ‘0’ (or ‘1’) indicating absence of Component-4b in the UEI report(s).
Component-5c: indicator(s) indicating presence or absent of Component-4c in the UEI report(s); e.g., the indicator(s) could be a one-bit indicator with ‘1’ (or ‘0’) indicating presence and ‘0’ (or ‘1’) indicating absence of Component-4c in the UEI report(s).
Component-5d: indicator(s) indicating presence or absent of Component-4d in the UEI report(s); e.g., the indicator(s) could be a one-bit indicator with ‘1’ (or ‘0’) indicating presence and ‘0’ (or ‘1’) indicating absence of Component-4d in the UEI report(s).
Component-5e: indicator(s) indicating presence or absence of Component-4e in the UEI report(s); e.g., the indicator(s) could be a one-bit indicator with ‘1’ (or ‘0’) indicating presence and ‘0’ (or ‘1’) indicating absence of Component-4e in the UEI report(s).
Component-5f: indicator(s) indicating presence or absence of Component-4f in the UEI report(s); e.g., the indicator(s) could be a one-bit indicator with ‘1’ (or ‘0’) indicating presence and ‘0’ (or ‘1’) indicating absence of Component-4f in the UEI report(s).
Component-5g: indicator(s) indicating presence or absent of Component-4k in the UEI report(s); e.g., the indicator(s) could be a one-bit indicator with ‘1’ (or ‘0’) indicating presence and ‘0’ (or ‘1’) indicating absence of Component-4k in the UEI report(s).
Component-5h: indicator(s) indicating presence or absent of Component-4l in the UEI report(s); e.g., the indicator(s) could be a one-bit indicator with ‘1’ (or ‘0’) indicating presence and ‘0’ (or ‘1’) indicating absence of Component-4l in the UEI report(s).
Component-5i: indicator(s) indicating presence or absent of Component-4m in the UEI report(s); e.g., the indicator(s) could be a one-bit indicator with ‘1’ (or ‘0’) indicating presence and ‘0’ (or ‘1’) indicating absence of Component-4m in the UEI report(s).
Component-5j: indicator(s) indicating presence or absent of Component-4n in the UEI report(s); e.g., the indicator(s) could be a one-bit indicator with ‘1’ (or ‘0’) indicating presence and ‘0’ (or ‘1’) indicating absence of Component-4n in the UEI report(s).
Component-5k: indicator(s) indicating presence or absence of Component-4o in the UEI report(s); e.g., the indicator(s) could be a one-bit indicator with ‘1’ (or ‘0’) indicating presence and ‘0’ (or ‘1’) indicating absence of Component-4o in the UEI report(s).
Component-5l: indicator(s) indicating presence or absence of Component-4p in the UEI report(s); e.g., the indicator(s) could be a one-bit indicator with ‘1’ (or ‘0’) indicating presence and ‘0’ (or ‘1’) indicating absence of Component-4p in the UEI report(s).

The value(s) of threshold-C, threshold-C′, threshold-C″, Ns, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Nc>1 and/or Ns>1. In another example, Nc≥1 and/or Ns≥1.

For each (or one or more) of the first, second, third and fourth events, and/or for a UE to declare each (or one or more) of the first, second, third and fourth events, and/or for a UE to formulate, construct, transmit and/or send the UEI report(s) with the report content(s)/quantity(s) corresponding to each (or one or more) of the first, second, third and fourth events according to or following those specified herein in the present disclosure, and/or for a UE to use/apply each (or one or more) of the first, second, third and fourth events for triggering or initiating the UEI reporting according to or following those specified herein in the present disclosure, the corresponding MAC entity could or shall for each Serving Cell configured for UEI reporting according to those specified herein in the present disclosure:
1> to initiate or trigger a UEI reporting based on or according to detection or declaration of one or each of the first, second, third and fourth events, individually:
   2> if an indication for an instance for an event (e.g., the first, second, third or fourth event) has been received from lower layers:
      3> start or restart the firstEventInstanceDetectionTimer, secondEventInstanceDetectionTimer, thirdEventInstanceDetectionTimer or fourthEventInstanceDetectionTimer (higher layer configured respectively for the first, second, third or fourth event-when/if applicable)
      3> increment firstEvent_COUNTER, secondEvent_COUNTER, thirdEvent_COUNTER or fourthEvent_COUNTER (higher layer configured respectively for the first, second, third or fourth event-when/if applicable) by 1;
      3> if firstEvent_COUNTER>=firstEventInstanceMaxCount, secondEvent_COUNTER>=secondEventInstanceMaxCount, thirdEvent_COUNTER>=thirdEventInstanceMaxCount or fourthEvent_COUNTER>=fourthEventInstanceMaxCount (respectively for the first, second, third or fourth event—when/if applicable), wherein the firstEventInstanceMaxCount, secondEventInstanceMaxCount, thirdEventInstanceMaxCount or fourthEventInstanceMaxCount is higher layer configured respectively for the first, second, third or fourth event—when/if applicable:
         4> trigger a UEI (beam) reporting specific to the first, second, third or fourth event-when/if applicable—for this Serving Cell, wherein the report content(s)/quantity(s) in the UEI report(s) is specific to the first, second, third or fourth event-when/if applicable-according to or following those specified herein in the present disclosure.
   2> if the firstEventInstance DetectionTimer, secondEventInstance DetectionTimer, thirdEventInstance DetectionTimer or fourthEventInstance DetectionTimer (respectively for the first, second, third or fourth event-when/if applicable) expires; or
   2> if the firstEventInstanceDetectionTimer, secondEventInstance DetectionTimer, thirdEventInstance DetectionTimer or fourthEventInstance DetectionTimer (respectively for the first, second, third or fourth event-when/if applicable), firstEvent_COUNTER, secondEvent_COUNTER, thirdEvent_COUNTER or fourthEvent_COUNTER (respectively for the first, second, third or fourth event-when/if applicable), or any of the reference signals used for UEI reporting—e.g., including that/those specific to/for the current serving beam(s) and/or the candidate beam(s) as specified or defined herein in the present disclosure specific to/for the first, second, third or fourth event—is reconfigured by upper layers associated with this Serving Cell; or
   2> if the reference signal(s) associated with this Serving Cell used for detection/declaration/indication for the first, second, third or fourth event as specified/defined herein in the present disclosure is changed and/or reconfigured by upper layers associated with this Serving Cell:
      3> set firstEvent_COUNTER, secondEvent_COUNTER, thirdEvent_COUNTER or fourthEvent_COUNTER (respectively for the first, second, third or fourth event—when/if applicable) to 0; and/or
      3> stop the ueiReportingTimer, if configured; and/or
      3> expect the UE-initiated (UEI) reporting procedure triggered or initiated with respect to the first, second, third or fourth event successfully completed, and/or cancel the UEI report(s) triggered or initiated with respect to the first, second, third or fourth event for this Serving Cell.

The described or specified MAC entity and the corresponding operation(s)/procedure(s) herein are for triggering or initiating one or more UEI report(s) according to or based on detection or declaration of one of the first, second, third and fourth events according to or following those specified herein in the present disclosure. To trigger or initiate a UEI reporting based on or according to detection or declaration of more than one or multiple events—e.g., the third and fourth events—jointly or simultaneously, the corresponding MAC entity—e.g., for the third and fourth events-could or shall for each Serving Cell configured for UEI reporting according to those specified herein in the present disclosure:
1> to initiate or trigger a UEI reporting based on or according to detection or declaration of the third and fourth events, jointly or simultaneously:
   2> if an indication for an instance for the third event has been received from lower layers, and/or if an indication for an instance for the fourth event has been received from lower layers:
      3> start or restart the thirdEventInstanceDetectionTimer and/or fourthEventInstanceDetectionTimer (higher layer configured for the third and/or fourth event(s)—when/if applicable)
      3> increment thirdEvent_COUNTER and/or fourthEvent_COUNTER (higher layer configured for the third and/or fourth event(s)-when/if applicable) by 1;
      3> if both thirdEvent_COUNTER>=thirdEventInstanceMaxCount and fourthEvent_COUNTER>=fourthEventInstanceMaxCount (for the third and fourth events—when/if applicable), wherein the thirdEventInstanceMaxCount and fourthEventInstanceMaxCount are higher layer configured respectively for the third and fourth events—when/if applicable:
         4> trigger a UEI (beam) reporting specific to the third and fourth events for this Serving Cell, wherein the report content(s)/quantity(s) in the UEI report(s) is specific to the third and fourth events-when/if applicable-according to or following those specified herein in the present disclosure.
   2> if the thirdEventInstanceDetectionTimer and/or fourthEventInstanceDetectionTimer (respectively for the third and/or fourth event(s)—when/if applicable) expires; or
   2> if the thirdEventInstanceDetectionTimer and/or fourthEventInstanceDetectionTimer (respectively for the third and/or fourth event(s)—when/if applicable), thirdEvent_COUNTER and/or fourthEvent_COUNTER (respectively for the third and/or fourth event(s)—when/if applicable), or any of the reference signals used for UEI reporting—e.g., including that/those specific to/for the current serving beam(s) and/or the candidate beam(s) as specified or defined herein in the present disclosure for the third and/or fourth event(s)—is reconfigured by upper layers associated with this Serving Cell; or
   2> if the reference signal(s) associated with this Serving Cell used for detection/declaration/indication for the third and/or fourth event(s) as specified/defined herein in the present disclosure is changed and/or reconfigured by upper layers associated with this Serving Cell:
      3> set thirdEvent_COUNTER and/or fourthEvent_COUNTER (respectively for the third and/or fourth event(s)—when/if applicable) to 0; and/or
      3> stop the ueiReportingTimer, if configured; and/or
      3> expect the UE-initiated (UEI) reporting procedure triggered or initiated with respect to both the third and fourth events successfully completed, and/or cancel the UEI report(s) triggered or initiated with respect to the third and fourth events for this Serving Cell.

The described/specified MAC entity(s) and the corresponding operation(s)/procedure(s) herein could be applied or extended to when/if more than two events could be configured and/or enabled by the network and/or applied or used by the UE for initiating or triggering the UEI reporting.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH.
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a single-TRP system, a UE could be indicated/provided/configured by the network (e.g., the network 130), e.g., via a beam indication MAC CE or a DCI (e.g., via one or more TCI codepoints of one or more TCI fields in the corresponding DCI 1_1/1_2 with or without DL assignment), a TCI state/pair of TCI states for at least UE-dedicated reception on PDSCH/PDCCH or dynamic-grant/configured-grant based PUSCH or dedicated PUCCH resources, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

The RS(s) or RS resource(s) or RS resource index(es) of/for a current serving beam-denoted by current serving beam RS(s) or RS resource(s) or RS resource index(es)-could be identified or determined according to one or more of:
(implicit determination): One or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a tracking reference signal (TRS) is also a type of CSI-RS.
(implicit determination): One or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(explicit configuration): a set s̅₀ of (periodic) CSI-RS resource configuration indexes and/or SS/PBCH block indexes by currentServBeamRSList (e.g., via higher layer RRC signalling(s)/parameter(s) and/or MAC CE command(s) and/or dynamic DCI based L1 signaling(s)) for monitoring/assessing the radio link and/or beam qualities for the current serving beam(s) according to those specified herein in the present disclosure. The serving beam(s) set s̅₀ of (periodic) CSI-RS resource configuration indexes and/or SS/PBCH block indexes could be provided in higher layer parameter(s) CSI-ReportConfig, CSI-ResourceConfig, nzp-CSI-RS-ResourceSet, CSI-SSB-ResourceSet, and/or higher layer parameter(s) UEI-ReportConfig, UEI-ResourceConfig and/or etc. dedicated/configured for the UEI reporting as specified herein in the present disclosure.

Furthermore, the UE could assess or evaluate the radio link/beam quality(s), e.g., by measuring L1-RSRP(s)/L1-SINR(s), of a current serving beam based on or according to one or more of:
The UE could assess or evaluate the radio link/beam quality(s), e.g., by measuring L1-RSRP(s)/L1-SINR(s), of the RS(s) or RS resource(s) or RS resource index(es) determined (e.g., following those specified/described in the one or more implicit determinations described herein in the present disclosure) and/or configured (e.g., following those specified/described in the explicit configuration in the present disclosure) for the current serving beam(s) in the UEI/event-driven beam reporting.
The UE (e.g., the UE 116) could assess or evaluate the radio link/beam quality(s), e.g., by measuring L1-RSRP(s)/L1-SINR(s), of one or more of the RS(s) or RS resource(s) or RS resource index(es) determined (e.g., following those specified/described in the one or more implicit determinations described herein in the present disclosure) and/or configured (e.g., following those specified/described in the explicit configuration in the present disclosure) for the current serving beam(s) in the UEI/event-driven beam reporting according to (or that has the same RS(s) or RS resource(s) or RS resource index(es) as to)
   one or more RSs or RS resources or RS resource indexes provided in/by an indicated TCI state, wherein the indicated TCI state could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
   one or more first RSs or RS resources or RS resource indexes quasi-co-located (QCL'ed) with second RS(s)/RS resource(s)/RS resource index(es) provided in/by an indicated TCI state, e.g., of QCL-TypeD, wherein the indicated TCI state could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by an indicated TCI state, and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In the present disclosure, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, which one or more of the implicit determination and explicit configuration examples as specified/defined herein in the present disclosure to use or follow or apply for determining or identifying the current serving beam RS(s) or RS resource(s) or RS resource index(es). For instance, a higher layer parameter currentBeamRSDetermination could be provided in the higher layer parameter(s) CSI-ReportConfig, CSI-ResourceConfig, UEI-ResourceConfig and/or UEI-ReportConfig that configures or provides information related to or for the UEI beam reporting. When/if the higher layer parameter currentBeamRSDetermination is set to ‘CSIRS’, the UE could follow those specified or described in the implicit determination to determine or identify the current serving beam RS(s) or RS resource(s) or RS resource index(es). When/if the higher layer parameter currentBeamRSDetermination is set to ‘SSB’, the UE could follow those specified or described in the implicit determination to determine or identify the current serving beam RS(s) or RS resource(s) or RS resource index(es).

Candidate RS(s) or RS resource(s) or RS resource index(es)-denoted by candidate candidate/new beam RS(s) or RS resource(s) or RS resource index(es)—for determining the RS(s) or RS resource(s) or RS resource index(es) for actual measurement of/for a candidate/new beam-denoted by actual candidate/new beam RS(s) or RS resource(s) or RS resource index(es)-could be identified or determined according to one or more of:
(explicit configuration): a set s̅₁ of (periodic) CSI-RS resource configuration indexes and/or SS/PBCH block indexes by Candidate BeamRSList (e.g., via higher layer RRC signalling(s)/parameter(s) and/or MAC CE command(s) and/or dynamic DCI based L1 signaling(s)) for monitoring/assessing the radio link and/or beam qualities for the candidate/new beam(s) according to those specified herein in the present disclosure. The candidate/new beam(s) set s̅₁ of (periodic) CSI-RS resource configuration indexes and/or SS/PBCH block indexes could be provided in higher layer parameter(s) CSI-ReportConfig, CSI-ResourceConfig, nzp-CSI-RS-ResourceSet, CSI-SSB-ResourceSet, and/or higher layer parameter(s) UEI-ReportConfig, UEI-ResourceConfig and/or etc. dedicated/configured for the UEI reporting as specified herein in the present disclosure.
(implicit determination): One or more RSs or RS resources or RS resource indexes provided in/by one or more TCI states activated by/in a TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination): One or more first RSs or RS resources or RS resource indexes quasi-co-located (QCL'ed) with, e.g., of QCL-TypeD, one or more second RSs or RS resources or RS resource indexes provided in/by one or more TCI states activated by/in the TCI state(s) activation/deactivation MAC CE command, wherein the one or more TCI states activated by/in the TCI state(s) activation/deactivation MAC CE command could correspond to one or more of the joint/DL TCI states activated by/in the TCI state(s) activation/deactivation MAC CE command each provided by TCI-State; in this case, the one or more first RSs or RS resources or RS resource indexes could be or could serve as the QCL root/source RS(s) for the second RS(s)/RS resource(s)/RS resource index(es) provided in/by one or more of the activated joint/DL TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).
(implicit determination): One or more RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State, and/or the RS(s)/RS resource(s)/RS resource index(es) could be of QCL-TypeD; in this case, the RS(s) could be CSI-RS(s), the RS resource(s) could be CSI-RS resource(s), and/or the RS resource index(es) could be CSI-RS resource configuration index(es); note here that a TRS is also a type of CSI-RS.
(implicit determination): One or more first RSs or RS resources or RS resource indexes quasi-co-located (QCL'ed) with, e.g., of QCL-TypeD, one or more second RSs or RS resources or RS resource indexes provided in/by one or more TCI states provided/configured in a higher layer RRC configured list of TCI state(s), wherein the list of TCI state(s) could correspond to a list of joint/DL TCI state(s) provided by DLorJointTCI-State, and each of the TCI state(s) in the list could be a joint/DL TCI state provided by TCI-State; in this case, the one or more first RSs or RS resources or RS resource indexes could be or could serve as the QCL root/source RS(s) for the second RS(s)/RS resource(s)/RS resource index(es) provided in/by one or more of the joint/DL TCI state(s) in the list of TCI state(s), and the first RS(s)/RS resource(s)/RS resource index(es) could correspond to synchronization signal/physical broadcast channel (SS/PBCH) block(s)—SSB(s) or SSB index(es), and/or the second RS(s)/RS resource(s)/RS resource index(es) could be CSI-RS(s)/CSI-RS resource(s)/CSI-RS resource configuration index(es) including TRS(s).

In the present disclosure, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, which one or more of the implicit determinations and explicit configuration as specified/defined herein in the present disclosure to use or follow or apply for determining or identifying the actual candidate/new beam RS(s) or RS resource(s) or RS resource index(es). For instance, a higher layer parameter candidateBeamRSDetermination could be provided in the higher layer parameter(s) CSI-ReportConfig, CSI-ResourceConfig, UEI-ResourceConfig and/or UEI-ReportConfig that configures or provides information related to or for the UEI beam reporting. When/if the higher layer parameter candidate BeamRSDetermination is set to ‘CSIRS’, the UE could follow those specified or described in the implicit determination to determine or identify the actual candidate/new beam RS(s) or RS resource(s) or RS resource index(es). When/if the higher layer parameter candidate BeamRSDetermination is set to ‘SSB’, the UE could follow those specified or described in the implicit determination to determine or identify the actual candidate/new beam RS(s) or RS resource(s) or RS resource index(es).

Furthermore, the UE could identify or determine a subset of the candidate RS(s) or RS resource(s), or RS resource index(es) configured following those specified/described in the explicit configuration and/or determined following those specified/described in the one or more implicit determinations described herein as the RS(s) or RS resource(s) or RS resource index(es) for the actual measurement for/of one or more candidate/new beams.
In one example, the UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the one or more explicit configuration described herein in the present disclosure), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the one or more explicit configurations described herein in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the one or more explicit configurations described herein in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.
In another example, the UE could determine or identify which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams according to one or more of the followings, based on e.g. (1) fixed rule(s) in system specification(s) or per RRC (re) configuration, (ii) network's configuration(s) or indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination or selection.
   For example, the first (or last) L≥1 candidate RS(s) or RS resource(s) or RS resource index(es) or the L≥1 candidate RS(s) or RS resource(s) with the lowest (or highest) resource index(es)—among the K configured/determined candidate RS(s) or RS resource(s) or RS resource index(es) with L≤K—could be used/applied as the RS(s) or RS resource(s) or RS resource index(es) for the actual measurement for/of the one or more candidate/new beams. Optionally, the first (or last) half of the K configured/determined candidate RS(s) or RS resource(s) or RS resource index(es) or the half of the K configured/determined candidate RS(s) or RS resource(s) with the lowest (or highest) resource index(es) could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the one or more explicit configurations described herein in the present disclosure), the RSs or RS resources corresponding/associated to the RS index #1 and RS index #2 in the set s̅₁ (i.e., the first half) could be used/applied as the RS(s) or RS resource(s) for the actual measurement for/of the one or more candidate/new beams.
   For another example, the even-ordered or even-numbered or even-indexed candidate RS(s) or RS resource(s) or RS resource index(es) or the candidate RS(s) or RS resource(s) with even-valued resource index(es)-among the K configured/determined candidate RS(s) or RS resource(s) or RS resource index(es)-could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the one or more explicit configurations described herein in the present disclosure), the RSs or RS resources corresponding/associated to the RS index #2 and RS index #4 (even-valued RS resource indexes) in the set s̅₁ could be used/applied as the RS(s) or RS resource(s) for the actual measurement for/of the one or more candidate/new beams.
   For another example, the odd-ordered or odd-numbered or odd-indexed candidate RS(s) or RS resource(s) or RS resource index(es) or the candidate RS(s) or RS resource(s) with odd-valued resource index(es)—among the K configured/determined candidate RS(s) or RS resource(s) or RS resource index(es)—could be used/applied as the RS(s) or RS resource(s) or RS resource index(es) for the actual measurement for/of the one or more candidate/new beams. For instance, for a set s̅₁ of K=4 candidate RS resource indexes {RS index #1, RS index #2, RS index #3, RS index #4} configured/provided by the network (following those described/specified in the one or more explicit configurations described herein in the present disclosure), the RSs or RS resources corresponding/associated to the RS index #1 and RS index #3 (odd-valued RS resource indexes) in the set s̅₁ could be used/applied as the RS(s) or RS resource(s) for the actual measurement for/of the one or more candidate/new beams.
In another example, the UE could indicate or transmit or send to the network, e.g., by/in part of a/the UEI beam report, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams.
   For example, the one or more indicators could be or could correspond to a set of RS resource index(es)—e.g., a set of CSI-RS resource configuration index(es) and/or SSB index(es). For this design example, each of the RS resource index(es) in the set could correspond/point to or represent a candidate RS/RS resource/RS resource index or one of the candidate RS(s) or RS resource(s) or RS resource index(es). In this case, the UE could determine/identify and/or indicate to the network that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the one or more explicit configurations described herein), the one or more indicators (or equivalently, the set of RS resource index(es)) could provide or indicate or contain or include or comprise one or more indexes each belonging to {1, . . . , K}. Specifically, when/if the RS resource indexes in the set correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
   For another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). In this case, when/if an entry/bit position of the bitmap is set to ‘1’ (or ‘0’), the UE could determine/identify and/or indicate to the network that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (e.g., the network 130) (following those described/specified in the one or more explicit configurations described herein in the present disclosure), the entries/bit positions in the bitmap associated/corresponding to the RS index #1, RS index #2 and RS index #K are set to ‘1’s while the entry(s)/bit position(s) in the bitmap associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap that are set to ‘1’s could be used/applied as the RS(s) or RS resource(s) for the actual measurement for/of the one or more candidate/new beams.
   For another example, the one or more indicators could be or could correspond to one or more 1-bit indicators each corresponding/associated to a candidate RS/RS resource/RS resource index or one of the candidate RS(s) or RS resource(s) or RS resource index(es). In this case, when/if a 1-bit indicator is set to ‘1’ (or ‘0’), the UE could determine/identify and/or indicate to the network that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the one or more explicit configurations described herein in the present disclosure), the 1-bit indicators associated/corresponding to the RS index #1, RS index #2 and RS index #K are set to ‘1’s while the 1-bit indicators associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators that are set to ‘1’s could be used/applied as the RS(s) or RS resource(s) for the actual measurement for/of the one or more candidate/new beams.

As specified herein in the present disclosure, a UE could be indicated or configured or provided by the network, e.g., via higher layer RRC signaling(s)/parameter(s) and/or MAC CE command(s) and/or dynamic DCI based L1 signaling(s) according to or based on a corresponding UE's capability or capability signaling, one or more indicators to indicate which one or more of the candidate RS(s) or RS resource(s) or RS resource index(es) and/or the subset of the candidate RS(s) or RS resource(s) or RS resource index(es) to use/apply as the RS(s) or RS resource(s) or RS resource index(es) for the actual measurement for/of the one or more candidate/new beams. In particular, the one or more indicators as defined/specified herein in the present disclosure could be provided or indicated or contained or comprised or included or configured in a/the higher layer parameter TCI-State or TCI-UL-State that configures or provides the indicated TCI state.
In one example, the one or more indicators could be or could correspond to a set of RS resource index(es)—e.g., a set of CSI-RS resource configuration index(es) and/or SSB index(es). As discussed/specified herein in the present disclosure, each of the RS resource index(es) in the set could correspond/point to or represent a candidate RS/RS resource/RS resource index or one of the candidate RS(s) or RS resource(s) or RS resource index(es). In this case, the UE could determine or identify that the candidate RS(s) or RS resource(s) or RS resource index(es) associated/corresponding to or pointed/represented by the RS resource index(es) in the set could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the one or more explicit configurations described herein in the present disclosure), the one or more indicators (or equivalently, the set of RS resource index(es)) provided, indicated, contained, comprised, configured or included in a/the higher layer parameter TCI-State or TCI-UL-State that configures or provides the indicated TCI state could provide or indicate or contain or include or comprise one or more indexes each belonging to {1, . . . , K}. Specifically, when/if the RS resource indexes in the set provided, indicated, contained, comprised, configured or included in a/the higher layer parameter TCI-State or TCI-UL-State that configures or provides the indicated TCI state correspond to {1, 2, K}, the RSs or RS resources corresponding/associated to the RS index #1, RS index #2 and RS index #K in the set s̅₁ could be used/applied as the RS(s) or RS resource(s) for the actual measurement for/of the one or more candidate/new beams.
In another example, the one or more indicators could be or could correspond to a bitmap with each entry/bit position of the bitmap corresponding/associated to a candidate RS/RS resource/RS resource index or one of the candidate RS(s) or RS resource(s) or RS resource index(es). As discussed/specified herein in the present disclosure, when/if an entry/bit position of the bitmap is set to ‘1’ (or ‘0’), the UE could determine or identify that the candidate RS(s) or RS resource(s) or RS resource index(es) associated/corresponding to the entry/bit position could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the one or more explicit configurations described herein in the present disclosure), the entries/bit positions in the bitmap provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the entry(s)/bit position(s) in the bitmap provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the entries/bit positions in the bitmap provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.
In another example, the one or more indicators could be or could correspond to one or more 1-bit indicators each corresponding/associated to a candidate RS/RS resource/RS resource index or one of the candidate RS(s) or RS resource(s) or RS resource index(es). As discussed/specified herein in the present disclosure, when/if a 1-bit indicator is set to ‘1’ (or ‘0’), the UE (e.g., the UE 116) could determine or identify that the candidate RS(s) or RS resource(s) or RS resource index(es) associated/corresponding to the 1-bit indicator could be used/applied as the RS(s) or RS resource(s) or RS resource index(es) for the actual measurement for/of one or more candidate/new beams. For instance, for a set s̅₁ of K≥1 candidate RS resource indexes {RS index #1, RS index #2, . . . , RS index #K} configured/provided by the network (following those described/specified in the one or more explicit configurations described herein in the present disclosure), the 1-bit indicators provided, indicated, contained, comprised, configured or indicated in a/the higher layer parameter TCI-State or TCI-UL-State that configures or provides the indicated TCI state associated/corresponding to the RS index #1, RS index #2 and RS index #K are set to ‘1’s while the 1-bit indicators provided, indicated, contained, comprised, configured or indicated in a/the higher layer parameter TCI-State or TCI-UL-State that configures or provides the indicated TCI state associated/corresponding to the RS index(es) other than the RS index #1, RS index #2 and RS index #K are set to ‘0’s. In this case, the RSs or RS resources corresponding/associated to the RS index #1, RS index #2 and RS index #K in the set s̅₁ corresponding/associated to the 1-bit indicators provided, indicated, contained, comprised, configured or indicated in a/the higher layer parameter TCI-State or TCI-UL-State that configures or provides the indicated TCI state that are set to ‘1’s could be used/applied as the RS(s) or RS resource(s) for the actual measurement for/of the one or more candidate/new beams.

For the described/specified design examples herein, when/if the higher layer parameter TCI-State or TCI-UL-State that configures or provides the indicated TCI state does not provide, contain, indicate, include, comprise or configure any of the one or more indicators as specified/defined herein in the present disclosure, and/or the one or more indicators as specified/defined herein in the present disclosure is absent or not present in the higher layer parameter TCI-State or TCI-UL-State that configures or provides the indicated TCI state, the UE could assess or evaluate the radio link/beam quality(s), e.g., by measuring the L1-RSRP(s)/L1-SINR(s), of the candidate RS(s) or RS resource(s) or RS resource index(es) configured following those specified/described in the one or more explicit configurations described herein and/or determined following those specified/described in the one or more implicit determination described herein to obtain the actual corresponding measurement result(s) for/of the one or more candidate/new beams.

Furthermore, the UE could first determine or identify, e.g., based on or according to (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s), one or more first candidate TCI states, wherein the first candidate TCI state(s) could be from a list of TCI state(s) higher layer configured or provided by the network, e.g., a list of joint/DL TCI state(s) provided by DLorJointTCI-State, and/or a set of TCI state(s) activated in/by a TCI state(s) activation/deactivation MAC CE command, and the (QCL source) RS(s) or RS resource(s) or RS resource index(es) provided in each of the first candidate TCI state(s) could correspond to a candidate candidate/new beam RS or RS resource or RS resource index as specified/defined herein in the present disclosure. Additionally, the UE could also determine or identify one or more of or a subset of the first candidate TCI state(s) as one or more second candidate TCI state(s) following or according to those specified or defined herein in the present disclosure for determining or identifying the actual candidate/new beam RS(s)/RS resource(s)/RS resource index(es) from the candidate candidate/new beam RS(s)/RS resource(s)/RS resource index(es)—including the indication(s)/configuration(s)/usage(s)/application(s) of the one or more indicators such as bitmap(s)/1-bit indicator(s)/etc. as specified/defined herein in the present disclosure, wherein the (QCL source) RS(s) or RS resource(s) or RS resource index(es) provided in each of the second candidate TCI state(s) could correspond to an actual candidate/new beam RS or RS resource or RS resource index as defined/specified herein in the present disclosure.

As described or specified herein in the present disclosure, a RS or RS resource or RS resource index of/for a current serving beam-denoted by a current serving beam RS/RS resource/RS resource index-could be corresponding/associated/mapped to one or more of (or a subset of) candidate RSs or RS resources or RS resource indexes-denoted by candidate candidate/new beam RS(s)/RS resource(s)/RS resource index(es)-used/applied as the RS(s) or RS resource(s) or RS resource index(es) for actual measurement(s) of/for one or more candidate/new beams-denoted by actual candidate/new beam RS(s)/RS resource(s)/RS resource index(es), wherein the current serving beam RS/RS resource/RS resource index and/or the candidate or actual candidate/new beam RS(s)/RS resource(s)/RS resource index(es) could be configured and/or determined according to those specified herein in the present disclosure.
In one example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure.
   For example, as described/specified herein in the present disclosure, the current serving beam RS/RS resource/RS resource index (or equivalently, the QCL source RS/RS resource/RS resource index) in the indicated TCI state provided by TCI-State or TCI-UL-State could be corresponding/associated/mapped to the actual candidate/new beam RS(s)/RS resource(s)/RS resource index(es)—i.e., a subset of or one or more of the candidate candidate/new beam RS(s)/RS resource(s)/RS resource index(es) following those specified herein in the present disclosure—provided, indicated, configured, comprised, included or contained in the same higher layer parameter(s) TCI-State or TCI-UL-State that provides or configures the indicated TCI state.
   For another example, a/the higher layer RRC signaling(s)/parameter(s) and/or MAC CE command(s) and/or dynamic DCI based L1 signaling(s) that provides or configures or indicates a current serving beam RS/RS resource/RS resource index could include, contain, provide, indicate, comprise or configure one or more actual candidate/new beam RSs/RS resources/RS resource indexes and/or the one or more indicators as specified/defined herein in the present disclosure that point/correspond to or represent or indicate one or more actual candidate/new beam RSs/RS resources/RS resource indexes—i.e., a subset of or one or more of the candidate candidate/new beam RS(s)/RS resource(s)/RS resource index(es) following those specified herein in the present disclosure. For this design example, the current serving beam RS/RS resource/RS resource index could be associated/mapped/corresponding to the one or more actual candidate/new beam RSs/RS resources/RS resource indexes.
   For another example, a/the higher layer RRC signaling(s)/parameter(s) and/or MAC CE command(s) and/or dynamic DCI based L1 signaling(s) that provides or configures or indicates one or more actual candidate/new beam RSs/RS resources/RS resource indexes and/or the one or more indicators as specified/defined herein in the present disclosure that point/correspond to or represent or indicate one or more actual candidate/new beam RSs/RS resources/RS resource indexes—i.e., a subset of or one or more of the candidate candidate/new beam RS(s)/RS resource(s)/RS resource index(es) following those specified herein in the present disclosure—could include, contain, provide, indicate, comprise or configure a current serving beam RS/RS resource/RS resource index. For this design example, the current serving beam RS/RS resource/RS resource index could be associated/mapped/corresponding to the one or more actual candidate/new beam RSs/RS resources/RS resource indexes.
   For another example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more indicators; as specified/defined herein in the present disclosure, the one or more indicators could point/correspond to or represent or indicate one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure. For this design example, the current serving beam RS/RS resource/RS resource index could be associated/mapped/corresponding to the one or more actual candidate/new beam RSs/RS resources/RS resource indexes-via/by their associations to the one or more indicators as specified/defined herein in the present disclosure.
   For another example, the UE could be first configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a single/same set/list of RSs or RS resources or RS resource indexes that comprise, contain, include, provide, configure or indicate both a current serving beam RS/RS resource/RS resource index (e.g., the first entry in the set/list or the entry with the lowest/highest RS index or RS resource index in the set/list) and one or more actual candidate/new beam RSs/RS resources/RS resource indexes (e.g., the remaining or rest of the entries in the set/list other than the first entry or the entry with the lowest/highest RS index or RS resource index). Optionally, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling—e.g., via one or more bitmaps and/or 1-bit indicators and/or etc. similar to those described/specified herein in the present disclosure, which one of the RSs or RS resources or RS resource indexes in the set/list could correspond to the current serving beam RS or RS resource or RS resource index and/or which one or more of the RSs or RS resources or RS resource indexes in the set/list could correspond to the actual candidate/new beam RS(s) or RS resource(s) or RS resource index(es). Alternatively, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of current serving beam RS(s)/RS resource(s)/RS resource index(es), and/or a second list/set of candidate/actual candidate/new beam RS(s)/RS resource(s)/RS resource index(es); in this case, the UE could then identify or determine, according to or based on the first list/set, the current serving beam RS/RS resource/RS resource index in the set/list, and/or identify or determine, according to or based on the second list/set, the actual candidate/new beam RS(s)/RS resource(s)/RS resource index(es) in the set/list. For this design example, the current serving beam RS/RS resource/RS resource index could be associated/mapped/corresponding to the one or more actual candidate/new beam RSs/RS resources/RS resource indexes as defined/specified herein.
   For another example, the UE could be first configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, an overall set/list of RSs or RS resources or RS resource indexes that comprise, contain, include, provide, configure or indicate both one or more current serving beam RSs/RS resources/RS resource indexes and one or more actual candidate/new beam RSs/RS resources/RS resource indexes. For this design example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling—e.g., via one or more bitmaps and/or 1-bit indicators and/or etc. similar to those described/specified herein in the present disclosure, which one or more of the RSs or RS resources or RS resource indexes in the overall set/list could correspond to the current serving beam RS(s) or RS resource(s) or RS resource index(es) and/or which one or more of the RSs or RS resources or RS resource indexes in the overall set/list could correspond to the actual candidate/new beam RS(s) or RS resource(s) or RS resource index(es). For instance, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of current serving beam RS(s)/RS resource(s)/RS resource index(es), and/or a second list/set of candidate/actual candidate/new beam RS(s)/RS resource(s)/RS resource index(es); in this case, the UE could then identify or determine, according to or based on the first list/set, the current serving beam RS(s)/RS resource(s)/RS resource index(es) in the overall set/list, and/or identify or determine, according to or based on the second list/set, the actual candidate/new beam RS(s)/RS resource(s)/RS resource index(es) in the overall set/list. Additionally, for a current serving beam RS/RS resource/RS resource index in the overall set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between the current serving beam RS/RS resource/RS resource index and one or more indicators; similar to those specified/defined herein in the present disclosure, the one or more indicators could point/correspond to or represent or indicate one or more actual candidate/new beam RSs/RS resources/RS resource indexes (i.e., from/among/out of the actual candidate/new beam RSs/RS resources/RS resource indexes in the overall set/list); in this case, the current serving beam RS/RS resource/RS resource index could be associated/mapped/corresponding to the one or more actual candidate/new beam RSs/RS resources/RS resource indexes-via/by their associations to the one or more indicators as specified/defined herein in the present disclosure.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a second list/set of one or more candidate/actual candidate/new beam RSs or RS resources or RS resource indexes. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of or a subset of the candidate/actual candidate/new beam RS(s) or RS resource(s) or RS resource index(es) in the second set/list could be associated/mapped/corresponding to the current serving beam RS/RS resource/RS resource index.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more second lists/sets of one or more candidate/actual candidate/new beam RSs or RS resources or RS resource indexes each comprising one or more candidate/actual candidate/new beam RSs or RS resources or RS resource indexes. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of the second sets/lists (and therefore, the corresponding candidate/actual candidate/new beam RS(s)/RS resource(s)/RS resource index(es) comprised or provided therein) could be associated/mapped/corresponding to the current serving beam RS/RS resource/RS resource index.
In another example, the UE could be indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more second candidate TCI states (i.e., a subset of or one or more of the first candidate TCI state(s)), and therefore the corresponding actual candidate/new beam RS(s)/RS resource(s)/RS resource index(es) provided therein, determined or configured or identified according to those specified/described herein in the present disclosure.
   For example, as described/specified herein in the present disclosure, the current serving beam RS/RS resource/RS resource index (or equivalently, the QCL source RS/RS resource/RS resource index) in the indicated TCI provided by state TCI-State or TCI-UL-State could be corresponding/associated/mapped to the actual candidate/new beam RS(s)/RS resource(s)/RS resource index(es)—i.e., a subset of or one or more of the candidate candidate/new beam RS(s)/RS resource(s)/RS resource index(es) following those specified herein in the present disclosure—provided, indicated, configured, comprised, included or contained in one or more second candidate TCI states whose ID(s), index(es) or related information—such as the one or more indicators used to determine or identify or indicate the one or more second candidate TCI states from or out of one or more first candidate TCI states—could be provided, indicated, configured, comprised, included or contained in the same higher layer parameter(s) TCI-State or TCI-UL-State that provides or configures the indicated TCI state.
   For another example, a/the higher layer RRC signaling(s)/parameter(s) and/or MAC CE command(s) and/or dynamic DCI based L1 signaling(s) that provides or configures or indicates a current serving beam RS/RS resource/RS resource index could include, contain, provide, indicate, comprise or configure one or more second candidate TCI states (e.g., in form of their IDs, indexes and/or other related information) and/or the one or more indicators as specified/defined herein in the present disclosure that point/correspond to or represent or indicate one or more second candidate TCI states—i.e., a subset of or one or more of the first candidate TCI states following those specified herein in the present disclosure. For this design example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—e.g., as the QCL source RS(s)/RS resource(s)/RS resource index(es).
   For another example, a/the higher layer RRC signaling(s)/parameter(s) and/or MAC CE command(s) and/or dynamic DCI based L1 signaling(s) that provides or configures or indicates one or more second candidate TCI states (e.g., in form of their IDs, indexes and/or other related information) and/or the one or more indicators as specified/defined herein in the present disclosure that point/correspond to or represent or indicate one or more second candidate TCI states—i.e., a subset of or one or more of the first candidate TCI states following those specified herein in the present disclosure—could include, contain, provide, indicate, comprise or configure a current serving beam RS/RS resource/RS resource index. For this design example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—e.g., as the QCL source RS(s)/RS resource(s)/RS resource index(es).
   For another example, the UE could be indicated or configured or provided by the network (e.g., the network 130), e.g., via higher layer RRC signaling(s)/parameter(s) and/or MAC CE command(s) and/or dynamic DCI based L1 signaling(s) based on or according to a corresponding UE's capability or capability signaling, the correspondence(s)/association(s)/mapping(s) between a current serving beam RS/RS resource/RS resource index determined or configured or identified according to those specified/described herein in the present disclosure and one or more indicators; as specified/defined herein in the present disclosure, the one or more indicators could point/correspond to or represent or indicate one or more second candidate TCI states—i.e., a subset of or one or more of the first candidate TCI states following those specified herein in the present disclosure. For this design example, the current serving beam RS/RS resource/RS resource index could be associated/mapped/corresponding to the one or more actual candidate/new beam RSs/RS resources/RS resource indexes that are provided, indicated, contained, comprised or indicated in the one or more second candidate TCI state(s)—via/by their associations to the one or more indicators as specified/defined herein in the present disclosure.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a second list/set of one or more first/second candidate TCI states (e.g., in form of their IDs/indexes/etc.) as specified/defined herein in the present disclosure. For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of or a subset of the first/second candidate TCI states in the second set/list—and therefore the corresponding candidate/actual candidate/new beam RS(s) or RS resource(s) or RS resource index(es) provided/indicated therein (i.e., in the corresponding first/second candidate TCI state(s))—could be associated/mapped/corresponding to the current serving beam RS/RS resource/RS resource index.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a first list/set of one or more current serving beam RSs or RS resources or RS resource indexes. In addition, the UE (e.g., the UE 116) could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more second lists/sets of one or more first/second candidate TCI states (e.g., in form of their IDs/indexes/etc.) as specified/defined herein in the present disclosure each comprising one or more first/second candidate TCI states (e.g., in form of their IDs/indexes/etc.). For a current serving beam RS/RS resource/RS resource index in the first set/list, the UE could be further indicated or configured or provided by the network, e.g., via higher layer RRC signaling(s)/parameter(s) and/or MAC CE command(s) and/or dynamic DCI based L1 signaling(s) based on or according to a corresponding UE's capability or capability signaling—for instance, via/by the one or more indicators including bitmap(s), 1-bit indicator(s) and/or etc. as defined/specified herein in the present disclosure, which one or more of the second sets/lists of first/second TCI state(s)—and therefore the corresponding candidate/actual candidate/new beam RS(s) or RS resource(s) or RS resource index(es) provided/indicated therein (i.e., in the corresponding first/second candidate TCI state(s))-could be associated/mapped/corresponding to the current serving beam RS/RS resource/RS resource index.
In another example, the UE could determine or identify, based on or according to, e.g. fixed rule(s) in system specification(s) and/or per RRC (re) configuration, the correspondence(s)/association(s)/mapping(s) between a current serving beam RS/RS resource/RS resource index determined or configured or identified according to those specified/described herein in the present disclosure and one or more actual candidate/new beam RSs/RS resources/RS resource indexes (i.e., a subset of or one or more of candidate candidate/new beam RSs/RS resources/RS resource indexes) determined or configured or identified according to those specified/described herein in the present disclosure.
   For example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of candidate/actual candidate/new beam RS(s)/RS resource(s)/RS resource index(es) as defined/specified herein in the present disclosure, wherein each set/list could be associated with a set ID/index and could comprise one or more candidate/actual candidate/new beam RSs/RS resources/RS resource indexes as defined/specified herein in the present disclosure. For a current serving beam RS or RS resource, when/if its corresponding RS index or RS resource index or RS resource configuration index has the same value as the set ID/index of a set/list of one or more candidate/actual candidate/new beam RS(s)/RS resource(s)/RS resource index(es), the current serving beam RS/RS resource/RS resource index could be associated/mapped/corresponding to the one or more candidate/actual candidate/new beam RSs/RS resources/RS resource indexes in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the set/list of candidate/actual candidate/new beam RSs/RS resources with the lowest (or highest) set ID/index, the current serving beam RS/RS resource with the second lowest (or second highest) RS index or RS resource index or RS resource configuration index could be associated/mapped/corresponding to the set/list of candidate/actual candidate/new beam RSs/RS resources with the second lowest (or second highest) set ID/index, and so on, and the current serving beam RS/RS resource with the highest (or lowest) RS index or RS resource index or RS resource configuration index could be associated/mapped/corresponding to the set/list of candidate/actual candidate/new beam RSs/RS resources with the highest (or lowest) set ID/index.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of candidate/actual candidate/new beam RS(s)/RS resource(s)/RS resource index(es) as defined/specified herein in the present disclosure, wherein each set/list could be associated with a set ID/index and could comprise one or more candidate/actual candidate/new beam RSs/RS resources/RS resource indexes as defined/specified herein in the present disclosure. For a current serving beam RS or RS resource, when/if its corresponding RS index or RS resource index or RS resource configuration index and the set ID/index of a set/list of one or more candidate/actual candidate/new beam RS(s)/RS resource(s)/RS resource index(es) are correlated or related, the current serving beam RS/RS resource/RS resource index could be associated/mapped/corresponding to the one or more candidate/actual candidate/new beam RSs/RS resources/RS resource indexes in the set/list. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. The set/list of candidate/actual candidate/new beam RSs/RS resources/RS resource indexes as defined/specified herein in the present disclosure could be further divided or separated into one or more groups each comprising one or more (e.g., a fixed number) candidate/actual candidate/new beam RSs/RS resources/RS resource indexes. For a current serving beam RS or RS resource, when/if its corresponding RS index or RS resource index or RS resource configuration index (e.g., the first or #1, second or #2, etc.) has the same value as the ordering/position (e.g., the first, second, etc.) of a group of candidate/actual candidate/new beam RS(s)/RS resource(s)/RS resource index(es) among the groups in the set/list, the current serving beam RS/RS resource/RS resource index could be associated/mapped/corresponding to the one or more candidate/actual candidate/new beam RSs/RS resources/RS resource indexes in the group. Optionally, for one or more current serving beam RSs or RS resources or RS resource indexes, the current serving beam RS/RS resource with the lowest (or highest) RS index or RS resource index or RS resource configuration index could be associated/mapped/corresponding to the group of candidate/actual candidate/new beam RSs/RS resources with the lowest (or highest) ordering/position among the groups in the set/list, the current serving beam RS/RS resource with the second lowest (or second highest) RS index or RS resource index or RS resource configuration index could be associated/mapped/corresponding to the group of candidate/actual candidate/new beam RSs/RS resources with the second lowest (or second highest) ordering/position among the groups in the set/list, and so on, and the current serving beam RS/RS resource with the highest (or lowest) RS index or RS resource index or RS resource configuration index could be associated/mapped/corresponding to the group of candidate/actual candidate/new beam RSs/RS resources with the highest (or lowest) ordering/position among the groups in the set/list.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. The set/list of candidate/actual candidate/new beam RSs/RS resources/RS resource indexes as defined/specified herein in the present disclosure could be further divided or separated into one or more groups each comprising one or more (e.g., a fixed number) candidate/actual candidate/new beam RSs/RS resources/RS resource indexes. For a current serving beam RS or RS resource, when/if its corresponding RS index or RS resource index or RS resource configuration index (e.g., the first or #1, second or #2, etc.) and the ordering/position (e.g., the first, second, etc.) of a group of candidate/actual candidate/new beam RS(s)/RS resource(s)/RS resource index(es) among the groups in the set/list are correlated or related, the current serving beam RS/RS resource/RS resource index could be associated/mapped/corresponding to the one or more candidate/actual candidate/new beam RSs/RS resources/RS resource indexes in the group. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. For a current serving beam RS or RS resource, when/if its corresponding RS index or RS resource index or RS resource configuration index has the same value as the RS index(es) or RS resource index(es) or RS resource configuration index(es) of one or more candidate/actual candidate/new beam RSs or RS resources, the current serving beam RS/RS resource/RS resource index could be associated/mapped/corresponding to the one or more candidate/actual candidate/new beam RSs/RS resources/RS resource indexes in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the candidate/actual candidate/new beam RSs/RS resources with the lowest (or highest) RS index(es) or RS resource index(es) or RS resource configuration index(es), the current serving beam RS/RS resource with the second lowest (or second highest) RS index or RS resource index or RS resource configuration index could be associated/mapped/corresponding to the candidate/actual candidate/new beam RSs/RS resources with the second lowest (or second highest) RS index(es) or RS resource index(es) or RS resource configuration index(es), and so on, and the current serving beam RS/RS resource with the highest (or lowest) RS index or RS resource index or RS resource configuration index could be associated/mapped/corresponding to the candidate/actual candidate/new beam RSs/RS resources with the highest (or lowest) RS index(es) or RS resource index(es) or RS resource configuration index(es).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more candidate/actual candidate/new beam RSs/RS resources/RS resource indexes as defined/specified herein in the present disclosure. For a current serving beam RS or RS resource, when/if its corresponding RS index or RS resource index or RS resource configuration index and the RS index(es) or RS resource index(es) or RS resource configuration index(es) of one or more candidate/actual candidate/new beam RSs or RS resources are correlated or related, the current serving beam RS/RS resource/RS resource index could be associated/mapped/corresponding to the one or more candidate/actual candidate/new beam RSs/RS resources/RS resource indexes in the set/list. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. The UE could first determine or identify the one or more current serving beam RSs/RS resources/RS resource indexes in the set/list, and/or the one or more candidate/actual candidate/new beam RSs/RS resources/RS resource indexes in the set/list according to or following those specified herein in the present disclosure. The UE could then determine or identify the association(s)/mapping(s)/correspondence(s) between the one or more current serving beam RSs/RS resources/RS resource indexes in the set/list and the one or more candidate/actual candidate/new beam RSs/RS resources/RS resource indexes in the set/list according to or following those specified herein in the present disclosure.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. For this design example, the entry(s)/position(s)/ordering(s)—e.g., the first, second, etc.—in the set/list that could carry, convey, contain, include, provide or indicate the one or more current serving beam RSs/RS resources/RS resource indexes could be fixed; alternatively, the RS index(es)/RS resource index(es)/RS resource configuration index(es) in the set/list that could correspond or refer to the one or more current serving beam RSs/RS resources/RS resource indexes could be fixed. In this case, the P≥1 entry(s)/position(s)/ordering(s) in the set/list that follow the entry(s)/position(s)/ordering(s) in the set/list that carries, conveys, contains, includes, provides or indicates the current serving beam RS(s)/RS resource(s)/RS resource index(es) could carry, convey, contain, include, provide or indicate the one or more candidate/actual candidate/new beam RSs/RS resources/RS resource indexes that are corresponding/associated/mapped to the current serving beam RS(s)/RS resource(s)/RS resource index(es). Alternatively, the P≥1 entry(s)/position(s)/ordering(s) in the set/list that follow the RS index(es) or RS resource index(es) or RS resource configuration index(es) in the set/list that corresponds or refers to the current serving beam RS(s)/RS resource(s)/RS resource index(es) could carry, convey, contain, include, provide or indicate the one or more candidate/actual candidate/new beam RSs/RS resources/RS resource indexes that are corresponding/associated/mapped to the current serving beam RS(s)/RS resource(s)/RS resource index(es). The value of P could be determined or identified according to: (i) a fixed value in system specification(s) or per RRC (re) configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more current serving beam RSs/RS resources/RS resource indexes and one or more candidate/actual candidate/new beam RSs/RS resources/RS resource indexes as defined/specified herein in the present disclosure. For this design example, the first Q≥1 entry(s)/position(s)/ordering(s) in the set/list could carry, convey, contain, include, provide or indicate the one or more current serving beam RSs/RS resources/RS resource indexes; alternatively, the Q≥1 lowest/highest RS index(es)/RS resource index(es)/RS resource configuration index(es) in the set/list could correspond or refer to the one or more current serving beam RSs/RS resources. In this case, the rest of or remaining entry(s)/position(s)/ordering(s) in the set/list could carry, convey, contain, include, provide or indicate the one or more candidate/actual candidate/new beam RSs/RS resources/RS resource indexes, and/or the rest of or remaining RS index(es)/RS resource index(es)/RS resource configuration index(es) in the set/list could correspond or refer to the one or more candidate/actual candidate/new beam RSs or RS resources. The value of Q could be determined or identified according to: (i) a fixed value in system specification(s) or per RRC (re) configuration, (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s). Furthermore, the UE could determine or identify the association(s)/mapping(s)/correspondence(s) between the one or more current serving beam RSs/RS resources/RS resource indexes in the set/list and the one or more candidate/actual candidate/new beam RSs/RS resources/RS resource indexes in the set/list according to or following those specified herein in the present disclosure.
In another example, the UE could determine or identify, based on or according to, e.g. fixed rule(s) in system specification(s) and/or per RRC (re) configuration, the correspondence(s)/association(s)/mapping(s) between a current serving beam RS/RS resource/RS resource index determined or configured or identified according to those specified/described herein in the present disclosure and one or more second candidate TCI states (i.e., a subset of or one or more of the first candidate TCI state(s)), and therefore the corresponding actual candidate/new beam RS(s)/RS resource(s)/RS resource index(es) provided therein, determined or configured or identified according to those specified/described herein in the present disclosure.
   For example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of first/second candidate TCI state(s)—e.g., in form of TCI state ID(s)/index(es)/etc.—as defined/specified herein in the present disclosure, wherein each set/list could be associated with a set ID/index and could comprise one or more first/second candidate TCI states as defined/specified herein in the present disclosure. For a current serving beam RS or RS resource, when/if its corresponding RS index or RS resource index or RS resource configuration index has the same value as the set ID/index of a set/list of one or more first/second candidate TCI states, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated therein—with the lowest (or highest) set ID/index, the current serving beam RS/RS resource with the second lowest (or second highest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated—with the second lowest (or second highest) set ID/index, and so on, and the current serving beam RS/RS resource with the highest (or lowest) RS index or RS resource index or RS resource configuration index could be associated/mapped/corresponding to the set/list of first/second candidate TCI state(s)—and therefore the corresponding candidate/actual candidate/new beam RS(s)/RS resource(s)/RS resource index(es) provided or indicated therein—with the highest (or lowest) set ID/index.
   For another example, the UE could be configured, indicated or provided by the network (e.g., the network 130), e.g., via/by higher layer RRC signaling(s)/parameter(s) and/or MAC CE command(s) and/or dynamic DCI based L1 signaling(s) based on or according to a corresponding UE's capability or capability signaling, one or more sets/lists of first/second candidate TCI state(s)—e.g., in form of TCI state ID(s)/index(es)/etc.—as defined/specified herein in the present disclosure, wherein each set/list could be associated with a set ID/index and could comprise one or more first/second candidate TCI states as defined/specified herein in the present disclosure. For a current serving beam RS or RS resource, when/if its corresponding RS index or RS resource index or RS resource configuration index and the set ID/index of a set/list of one or more first/second candidate TCI state(s) are correlated or related, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states—e.g., in form of TCI state ID(s)/index(es)/etc.—as defined/specified herein in the present disclosure. The set/list of first/second candidate TCI state(s) as defined/specified herein in the present disclosure could be further divided or separated into one or more groups each comprising one or more (e.g., a fixed number) first/second candidate TCI states. For a current serving beam RS or RS resource, when/if its corresponding RS index or RS resource index or RS resource configuration index (e.g., the first or #1, second or #2, etc.) has the same value as the ordering/position (e.g., the first, second, etc.) of a group of first/second candidate TCI state(s) among the groups in the set/list, the current serving beam RS/RS resource/RS resource index could be associated/mapped/corresponding to the candidate/actual candidate/new beam RS(s)/RS resource(s)/RS resource index(es) provided or indicated in/by the first/second candidate TCI state(s) in the group. Optionally, for one or more current serving beam RSs or RS resources or RS resource indexes, the current serving beam RS/RS resource with the lowest (or highest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the lowest (or highest) ordering/position among the groups in the set/list, the current serving beam RS/RS resource with the second lowest (or second highest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the second lowest (or second highest) ordering/position among the groups in the set/list, and so on, and the current serving beam RS/RS resource with the highest (or lowest) RS index or RS resource index or RS resource configuration index could be associated/mapped/corresponding to the group of first/second candidate TCI states—and therefore the corresponding candidate/actual candidate/new beam RS(s)/RS resource(s)/RS resource index(es) provided or indicated therein—with the highest (or lowest) ordering/position among the groups in the set/list.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. The set/list of first/second candidate TCI states as defined/specified herein in the present disclosure could be further divided or separated into one or more groups each comprising one or more (e.g., a fixed number) first/second candidate TCI states. For a current serving beam RS or RS resource, when/if its corresponding RS index or RS resource index or RS resource configuration index (e.g., the first or #1, second or #2, etc.) and the ordering/position (e.g., the first, second, etc.) of a group of first/second candidate TCI states among the groups in the set/list are correlated or related, the current serving beam RS/RS resource/RS resource index could be associated/mapped/corresponding to the candidate/actual candidate/new beam RS(s)/RS resource(s)/RS resource index(es) provided or indicated in/by the first/second candidate TCI states in the group. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).
   For another example, the UE (e.g., the UE 116) could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. For a current serving beam RS or RS resource, when/if its corresponding RS index or RS resource index or RS resource configuration index has the same value as the TCI state ID(s)/index(es) of one or more first/second candidate TCI states, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. Optionally, for one or more current serving beam RSs or RS resources or RS resource indexes, the current serving beam RS/RS resource with the lowest (or highest) RS index or RS resource index or RS resource configuration index could be associated/mapped/corresponding to the first/second candidate TCI state(s) with the lowest (or highest) TCI state ID(s)/index(es)—and therefore the corresponding candidate/actual candidate/new beam RS(s)/RS resource(s)/RS resource index(es) provided or indicated therein, the current serving beam RS/RS resource with the second lowest (or second highest) RS index or RS resource index or RS resource configuration index could be associated/mapped/corresponding to the first/second candidate TCI state(s) with the second lowest (or second highest) TCI state ID(s)/index(es)—and therefore the corresponding candidate/actual candidate/new beam RS(s)/RS resource(s)/RS resource index(es) provided or indicated therein, and so on, and the current serving beam RS/RS resource with the highest (or lowest) RS index or RS resource index or RS resource configuration index could be associated/mapped/corresponding to the first/second candidate TCI state(s) with the highest (or lowest) TCI state ID(s)/index(es)—and therefore the corresponding candidate/actual candidate/new beam RS(s)/RS resource(s)/RS resource index(es) provided or indicated therein.
   For another example, the UE could be configured, indicated or provided by the network, e.g., via/by higher layer RRC signaling(s)/parameter(s) and/or MAC CE command(s) and/or dynamic DCI based L1 signaling(s) based on or according to a corresponding UE's capability or capability signaling, a set/list of one or more first/second candidate TCI states as defined/specified herein in the present disclosure. For a current serving beam RS or RS resource, when/if its corresponding RS index or RS resource index or RS resource configuration index and the TCI state ID(s)/index(es) of one or more first/second candidate TCI states are correlated or related, the current serving beam RS/RS resource/RS resource index could be associated/mapped/corresponding to the candidate/actual candidate/new beam RS(s)/RS resource(s)/RS resource index(es) provided or indicated in/by the one or more first/second candidate TCI states in the set/list. The correlation/relation could be determined or identified according to: (i) fixed rule(s) in system specification(s) or per RRC (re) configuration, (ii) network's configuration(s)/indication(s) via higher layer RRC signaling(s)/parameter(s) and/or MAC CE command(s) and/or dynamic DCI based L1 signaling(s) based on or according to a corresponding UE's capability or capability signaling, and/or (iii) UE's autonomous selection or determination, which could be further sent to the network via/in part of various UL channels/signals and/or CSI/beam report(s) and/or UE's capability signaling(s).

For the described or specified design examples herein, or for the design examples described or specified herein in the present disclosure, a UE could first identify or determine a current serving beam RS/RS resource/RS resource index according to or following those specified herein in the present disclosure, and perform the corresponding measurement(s)—e.g., by assessing or evaluating the radio link/beam quality(s) including measuring the L1-RSRP(s)/L1-SINR(s)—of the identified or determined current serving beam RS or RS resource or RS resource configuration. The UE could then identify or determine one or more actual candidate/new beam RSs/RS resources/RS resource indexes that are associated/mapped/corresponding to the determined or identified current serving beam RS/RS resource/RS resource index according to or following those specified herein in the present disclosure, and perform the corresponding measurement(s)—e.g., by assessing or evaluating the radio link/beam quality(s) including measuring the L1-RSRP(s)/L1-SINR(s)—of the identified or determined actual candidate/new beam RS(s) or RS resource(s) or RS resource configuration(s).

Throughout the present disclosure and/or for the described/specified design examples herein in the present disclosure, the current serving beam RS(s)/RS resource(s)/RS resource index(es) and the candidate (or actual) candidate/new beam RS(s)/RS resource(s)/RS resource index(es) as specified/defined herein in the present disclosure could be in a/same set/list of RS(s) or RS resource(s) or RS resource index(es), e.g., provided or indicated or configured by the network via/by higher layer RRC signaling(s)/parameter(s) and/or MAC CE command(s) and/or dynamic DCI based L1 signaling(s) based on or according to a corresponding UE's capability or capability signaling. Optionally, the current serving beam RS(s)/RS resource(s)/RS resource index(es) and the candidate (or actual) candidate/new beam RS(s)/RS resource(s)/RS resource index(es) as specified/defined herein in the present disclosure could be in separate lists/sets of RSs or RS resources or RS resource indexes, e.g., provided or indicated or configured by the network via/by higher layer RRC signaling(s)/parameter(s) and/or MAC CE command(s) and/or dynamic DCI based L1 signaling(s) based on or according to a corresponding UE's capability or capability signaling.

According to or following those specified herein in the present disclosure, when/if a higher layer RRC signaling/parameter denoted by ‘servBeamInclusion’ is provided or configured or set to ‘enabled’, a/the UEI report (e.g., in a reporting instance) could or should comprise report content(s)/quantity(s) including SSBRI(s)/CRI(s) and/or L1-RSRP(s)/L1-SINR(s) specific or corresponding to current serving beam(s) or current serving beam RS(s)/RS resource(s)/RS resource index(es) as specified/defined herein in the present disclosure (Case 0); otherwise, e.g., when/if the higher layer RRC signaling/parameter denoted by ‘servBeamInclusion’ is not provided or configured or present, or is absent or set to ‘disabled’, or when/if a higher layer RRC signaling/parameter ueiReportContent is set to ‘candBeamOnly’ (or ‘noServBeam’), one or more of:
Case 1—the UEI report could or should comprise report content(s)/quantity(s) including SSBRI(s)/CRI(s) and/or L1-RSRP(s)/L1-SINR(s) only specific or corresponding to current serving beam(s) or current serving beam RS(s)/RS resource(s)/RS resource index(es) as specified/defined herein in the present disclosure
Case 2—the UEI report could or should comprise report content(s)/quantity(s) including SSBRI(s)/CRI(s) and/or L1-RSRP(s)/L1-SINR(s) specific or corresponding to both (i) current serving beam(s) or current serving beam RS(s)/RS resource(s)/RS resource index(es) as specified/defined herein in the present disclosure and (ii) candidate/new beam(s) or candidate/new beam RS(s)/RS resource(s)/RS resource index(es) as specified/defined herein in the present disclosure that satisfies the event(s) condition(s)
Case 3—the UEI report could or should comprise report content(s)/quantity(s) including SSBRI(s)/CRI(s) and/or L1-RSRP(s)/L1-SINR(s) specific or corresponding to candidate/new beam(s) or candidate/new beam RS(s)/RS resource(s)/RS resource index(es) as specified/defined herein in the present disclosure that satisfies the event(s) condition(s), and the UEI report may not comprise any report content(s)/quantity(s) including SSBRI(s)/CRI(s) and/or L1-RSRP(s)/L1-SINR(s) specific or corresponding to any current serving beam(s) or current serving beam RS(s)/RS resource(s)/RS resource index(es) as specified/defined herein in the present disclosure

For of the design cases herein, the UE could be indicated or provided or configured by the network, e.g., via higher layer RRC signaling(s)/parameter(s) and/or MAC CE command(s) and/or dynamic DCI based L1 signaling(s) based on or according to a corresponding UE's capability or capability signaling, a number N_config≥1 of beams (e.g., denoted by nrofReportedCandidateRSs)—and therefore the corresponding report content(s)/quantity(s) including SSBRI(s)/CRI(s) and/or L1-RSRP(s)/L1-SINR(s)—that can be reported in a UEI beam report. For Case 0 as specified/described herein in the present disclosure, i.e., when/if the higher layer RRC signaling/parameter denoted by ‘servBeamInclusion’ is provided or configured or set to ‘enabled’, and/or for Case 2 (e.g., when/if the higher layer RRC signaling/parameter denoted by ‘servBeamInclusion’ is not provided or configured or present, or is absent or set to ‘disabled’) as specified/described herein in the present disclosure,
In one example, the number N_config≥1 of beam(s) configured to be reported in a UEI beam report may not include or comprise or contain the Nserv current serving beam(s)—and therefore the corresponding report content(s)/quantity(s) including SSBRI(s)/CRI(s) and/or L1-RSRP(s)/L1-SINR(s)—wherein the value of Nserv could be determined or identified according to or following those specified herein in the present disclosure (e.g., Nserv=1). In this case, a UEI report could comprise or include or contain or provide or indicate a total of (N_config+N_serv) beam(s)−(N_config+1) beam(s) if Nserv=1, or equivalently, a number of report content(s)/quantity(s) as specified/defined herein in the present disclosure corresponding or specific to the (N_config+Nserv) beam(s)−(N_config+1) beam(s) if Nserv=1. Furthermore, the N_config beam(s) configured to be reported in a UEI beam report may include or comprise or contain at least one candidate/new beam—and therefore the corresponding report content(s)/quantity(s)—as specified/defined herein in the present disclosure that satisfies the event(s) condition(s), or report content(s)/quantity(s) corresponding or specific to at least one candidate/new beam RS/RS resource/RS resource index as specified herein in the present disclosure that satisfies the event(s) condition(s). For this design example, the value of N_config could be set to one, or a minimum value of N_config—denoted by N_min—could be provided/configured/indicated/set to one, or candidate value(s) of N_config could be {N_min=1, . . . , N_max}, or a/the minimum candidate value of N_config (N_min) is one.
In another example, the number N_config≥1 of beam(s) configured to be reported in a UEI beam report could also include or comprise or contain the Nserv current serving beam(s)—and therefore the corresponding report content(s)/quantity(s) including SSBRI(s)/CRI(s) and/or L1-RSRP(s)/L1-SINR(s)—wherein the value of Nserv could be determined or identified according to or following those specified herein in the present disclosure (e.g., Nserv=1). In this case, a UEI report could comprise or include or contain or provide or indicate a total of N_config beam(s), or equivalently, a number of report content(s)/quantity(s) as specified/defined herein in the present disclosure corresponding or specific to the N_config beam(s). Furthermore, the N_config beam(s) configured to be reported in a UEI beam report may also include or comprise or contain at least one candidate/new beam—and therefore the corresponding report content(s)/quantity(s)—as specified/defined herein in the present disclosure that satisfies the event(s) condition(s), or report content(s)/quantity(s) corresponding or specific to at least one candidate/new beam RS/RS resource/RS resource index as specified herein in the present disclosure that satisfies the event(s) condition(s). For this design example, the value of N_config could be set to two, or a minimum value of N_config-denoted by N_min—could be provided/configured/indicated/set to two, or candidate value(s) of N_config could be {N_min=2, . . . , N_max}, or a/the minimum candidate value of N_config (N_min) is two.

For Case 3 (e.g., when/if the higher layer RRC signaling/parameter denoted by ‘servBeamInclusion’ is not provided or configured or present, or is absent or set to ‘disabled’, or when/if a higher layer RRC signaling/parameter ueiReportContent is set to ‘candBeamOnly’ (or ‘noServBeam’) as specified/described herein in the present disclosure, a UEI report could comprise or include or contain or provide or indicate a total of N_config beam(s), or equivalently, a number of report content(s)/quantity(s) as specified/defined herein in the present disclosure corresponding or specific to the N_config beam(s). Furthermore, the N_config beam(s) configured to be reported in a UEI beam report may include or comprise or contain at least one candidate/new beam—and therefore the corresponding report content(s)/quantity(s)—as specified/defined herein in the present disclosure that satisfies the event(s) condition(s), or report content(s)/quantity(s) corresponding or specific to at least one candidate/new beam RS/RS resource/RS resource index as specified herein in the present disclosure that satisfies the event(s) condition(s). For this design example, the N_config reported beam(s) may not include or comprise or contain any current serving beam(s)—and therefore any report content(s)/quantity(s) including SSBRI(s)/CRI(s) and/or L1-RSRP(s)/L1-SINR(s) specific or corresponding to any current serving beam(s) or current serving beam RS(s)/RS resource(s)/RS resource index(es) as specified/defined herein in the present disclosure; the value of N_config could be set to two, or a minimum value of N_config-denoted by N_min—could be provided/configured/indicated/set to two, or candidate value(s) of N_config could be {N_min=2, . . . , N_max}, or a/the minimum candidate value of N_config (N_min) is two.

In the described or specified design examples/cases herein, the value(s) of N_min and/or N_max could be determined according to/based on (i) fixed value(s) in system specification(s), (ii) network's configuration(s)/indication(s), e.g., via higher layer RRC signaling(s)/parameter(s) and/or MAC CE command(s) and/or dynamic DCI based L1 signaling(s) based on or according to a corresponding UE's capability or capability signaling, and/or (iii) UE's autonomous determination/selection, which could be further sent to the network via various UL channels/signals including PUCCH(s), PUSCH(s), PRACH(s), and/or etc., e.g., in part of a CSI/beam report and/or UE's capability signaling(s).

In one embodiment (embodiment-I), the UEI report(s) could contain, provide, include or comprise at least a pre-notification (PN) message/trigger—e.g., of (report-) type (A) or (report-) type (C) as specified herein in the present disclosure, and/or the (corresponding) UEI report content(s) or report quantity(s)—e.g., of (report-) type (B) or (report-) type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a transmission of the UEI report content(s)/quantity(s) associated/specific to the PN message/trigger, and/or request UL resource allocation and/or indication for a second UL channel that could carry or convey the UEI report content(s)/quantity(s).
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including configured grant (CG) PUSCH of Type1 and/or Type2, dynamically granted/scheduled by the network for sending the UEI report content(s)/quantity(s) including dynamic grant (DG) PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a physical resource block (PRB), a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network (e.g., the network 130), e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE (e.g., the UE 116) could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap-within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this design example, the UE could transmit or send to the network-via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network (e.g., the network 130) for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission does not indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the (downlink/uplink) DCI in response to the PN message/trigger is received p1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q1 (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network-via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE (e.g., the UE 116) could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, regardless of how/when the periodic/semi-persistent PUCCH resource(s) and/or the PUSCH resource(s) such as CG PUSCH of Type l and/or Type2 is (pre-) configured by the network for transmitting or sending the UEI report content(s)/quantity(s) as defined or specified herein in the present disclosure, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network-via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a cell-radio network temporary identifier (C-RNTI), a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

In one embodiment (embodiment-II), the UEI report(s) could contain, provide, include or comprise at least a pre-notification (PN) message/trigger—e.g., of (report-) type (A) or (report-) type (C) as specified herein in the present disclosure, and/or the (corresponding) UEI report content(s) or report quantity(s)—e.g., of (report-) type (B) or (report-) type (C) as specified herein in the present disclosure. For this case/setting,
Step-1: the UE could send a first PN message/trigger, e.g., via a first UL channel comprising one or more PUCCH resources, wherein the one or more PUCCH resources could be periodic and/or semi-persistent (e.g., pre-configured by the network (e.g., the network 130) for transmitting PN message/trigger), and each of the one or more PUCCH resources (e.g., of format 0/1/2/3/4) could be from one or more PUCCH resource sets, e.g., configured/provided for the UEI reporting(s) or more specifically for transmitting/sending PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending PN message/trigger. Here, the first PN message/trigger could indicate a transmission of the UEI report content(s)/quantity(s) associated/specific to the first PN message/trigger, and/or request UL resource allocation and/or indication for a second UL channel that could carry or convey the UEI report content(s)/quantity(s).
Step-2: after the UE has transmitted the first PN message/trigger, the UE could expect to receive from the network a first (downlink/uplink) DCI in response to the first PN message/trigger, within a time window starting from the first or last symbol/slot/etc. of the transmission of the first PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the first (downlink/uplink) DCI in response to the first PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the first (downlink/uplink) DCI in response to the first PN message/trigger. The first (downlink/uplink) DCI in response to the first PN message/trigger could comprise one or more of the components specified herein in the present disclosure (e.g., Component-1-Component-7):
   For example, the first (downlink/uplink) DCI in response to the first PN message/trigger could comprise or provide or indicate at least the component(s) that comprises or provides or indicates resource(s) allocation and/or indication for the second UL channel. For instance, the first (downlink/uplink) DCI could comprise or provide or indicate Component-5 and/or Component-6 as defined or specified herein in the present disclosure.
For another example, the first (downlink/uplink) DCI in response to the first PN message/trigger could comprise or provide or indicate at least the components that comprise or provide or indicate ACK/NACK for the first PN message/trigger and resource(s) allocation and/or indication for the second UL channel. For instance, the first (downlink/uplink) DCI could comprise or provide or indicate Component-1 (comprising or providing or indicating ACK/NACK for the first PN message/trigger) and Component-5 and/or Component-6 (comprising or providing or indicating resource(s) allocation and/or indication for the second UL channel) as defined or specified herein in the present disclosure.
   For another example, the first (downlink/uplink) DCI in response to the first PN message/trigger may not comprise or provide or indicate resource(s) allocation and/or indication for the second UL channel, and/or could comprise or provide or indicate at least the component(s) that comprises or provides or indicates ACK/NACK for the first PN message/trigger. For instance, the first (downlink/uplink) DCI could only comprise or provide or indicate Component-1 as defined or specified herein in the present disclosure.

When/if the first (downlink/uplink) DCI in response to the first PN message/trigger comprises or provides or indicates at least the component(s) that comprises or provides or indicates resource(s) allocation and/or indication for the second UL channel (e.g., Component-5 and/or Component-6 as defined/specified herein in the present disclosure), and/or at least the components that comprise or provide or indicate ACK/NACK for the first PN message/trigger (e.g., Component-1 as defined/specified herein in the present disclosure) and resource(s) allocation and/or indication for the second UL channel (e.g., Component-5 and/or Component-6 as defined/specified herein in the present disclosure), the UE could follow those specified in Step-3 as described herein in the present disclosure to determine or identify resource(s) for transmitting the UEI report content(s)/quantity(s) associated/specific to the first PN message/trigger via/in the second UL channel, and transmit or send the UEI report content(s)/quantity(s) on/over the corresponding determined or identified resource(s). When/if the first (downlink/uplink) DCI in response to the first PN message/trigger does not comprise or provide or indicate any of the component(s) that comprises or provides or indicates resource(s) allocation and/or indication for the second UL channel (e.g., Component-5 and/or Component-6 as defined/specified herein in the present disclosure), and provides, comprises or indicates at least the components that comprise or provide or indicate ACK/NACK for the first PN message/trigger (e.g., Component-1 as defined/specified herein in the present disclosure), and/or when/if the UE does not receive any response—e.g., the first (downlink/uplink) DCI—to the first PN message/trigger transmission, the UE could re-send or re-transmit the first PN message/trigger up to max_PN times or instances before the timer expires, and stop re-sending or re-transmitting the first PN message/trigger if the UE has received or detected the first DCI format in response to the re-sent or re-transmitted first PN message/trigger comprising or providing or indicating at least the components that provide or indicate or comprise resource(s) allocation and/or indication for the second UL channel (e.g., Component-5 and/or Component-6 as defined/specified herein in the present disclosure). Otherwise,
In one example, the UE could terminate or stop transmission of the UEI report content(s)/quantity(s) associated or specific to the first PN message/trigger.
In another example (Step-1a), the UE could send a second PN message/trigger, e.g., via a third UL channel comprising one or more PUCCH resources, wherein the one or more PUCCH resources could be periodic and/or semi-persistent (e.g., pre-configured by the network for transmitting PN message/trigger), and each of the one or more PUCCH resources (e.g., of format 0/1/2/3/4) could be from one or more PUCCH resource sets, e.g., configured/provided for the UEI reporting(s) or more specifically for transmitting/sending PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending PN message/trigger. Here, the second PN message/trigger could request UL resource allocation and/or indication for a fourth UL channel that could carry or convey the UEI report content(s)/quantity(s).
Step-2a: after the UE has transmitted the second PN message/trigger, the UE could expect to receive from the network a second (downlink/uplink) DCI in response to the second PN message/trigger, within a time window starting from the first or last symbol/slot/etc. of the transmission of the second PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the second (downlink/uplink) DCI in response to the second PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the second (downlink/uplink) DCI in response to the second PN message/trigger. The second (downlink/uplink) DCI in response to the PN message/trigger could at least provide or indicate or comprise one or more of the components that provide or indicate or comprise resource(s) allocation and/or indication for the fourth UL channel (e.g., Component-5 and/or Component-6 as defined/specified herein in the present disclosure for the fourth UL channel). For example, the second (downlink/uplink) DCI in response to the transmission of the second PN message/trigger is to trigger aperiodic (AP) CSI-RS measurement and reporting, and/or activate semi-persistent (SP) CSI-RS measurement and reporting, within a time window starting from the first or last symbol/slot/etc. of the transmission of the second PN message/trigger; The UE could be provided/indicated/configured by the network, e.g., via higher layer RRC signaling(s)/parameter(s) and/or MAC CE command(s) and/or dynamic DCI based L1 signaling(s)—e.g., based on a corresponding UE's capability or capability signaling, the value(s) of the time window. For instance, if the second (downlink/uplink) DCI is to trigger the AP CSI-RS measurement and reporting, the second DCI could be of DCI format 0_1 with the CSI request field indicated/provided therein set to valid value(s)/index(es), e.g., pointing to the index(es) of the entries in CSI-AperiodicTriggerStateList or the index(es) of the codepoint(s) in the aperiodic CSI trigger state subselection MAC CE. Furthermore, the reception of the DCI trigger or activation for the AP or SP CSI-RS measurement and reporting could be an ACK for the transmission of the PN message/trigger. In this case, the UE could identify or determine the resource allocation and/or indication for the fourth UL channel according to the CSI resource setting(s) and/or CSI reporting setting(s) associated or specific or corresponding to CSI-AssociatedReportConfigInfo associated or specific or corresponding to the aperiodic CSI trigger state. When/if the second (downlink/uplink) DCI in response to the second PN message/trigger does not comprise or provide or indicate any of the component(s) that comprises or provides or indicates resource(s) allocation and/or indication for the fourth UL channel (e.g., Component-5 and/or Component-6 as defined/specified herein in the present disclosure for the fourth), and/or when/if the UE does not receive any response—e.g., the second (downlink/uplink) DCI—to the second PN message/trigger transmission, the UE could re-send or re-transmit the second PN message/trigger up to max_PN times or instances before the timer expires, and stop re-sending or re-transmitting the second PN message/trigger if the UE has received or detected the second DCI format in response to the re-sent or re-transmitted second PN message/trigger comprising or providing or indicating at least the components that provide or indicate or comprise resource(s) allocation and/or indication for the fourth UL channel (e.g., Component-5 and/or Component-6 as defined/specified herein in the present disclosure for the fourth UL channel). Otherwise, the UE could terminate or stop transmission of the UEI report content(s)/quantity(s) associated or specific to the first (second) PN message/trigger.
Step-3a: when/if the UE has determined or identified the resource(s) to use for transmitting or sending the UEI report content(s)/quantity(s) associated/specific to the first (or second) PN message/trigger—e.g., based on or according to the resource allocation and/or indication provided or indicated by the second (downlink/uplink) DCI format in response to the transmission of the second PN message/trigger, the UE could send or transmit to the network, via/in the fourth UL channel on/over the determined or identified resource(s), the UEI report content(s)/quantity(s) associated/specific to the first (second) PN message/trigger transmitted or sent via/in the first (or third) UL channel as defined/specified herein in the present disclosure.

The first PN message/trigger and the second PN message/trigger as specified/defined herein in the present disclosure
Could be of different (or same) types of PN messages/triggers or UCIs or UCI parameters.
Could correspond to different (or same) configurations of PN message/trigger
Could be set to different (or same) values or levels: e.g., the first PN message/trigger could be set to ‘1’ (or ‘0’), while the second PN message/trigger could be set to ‘0’ (or ‘1’)
Could provide, comprise or indicate different (or same) indicators setting to different (or same) values

In one embodiment (embodiment-III), the UEI report(s) could contain, provide, include or comprise at least a pre-notification (PN) message/trigger—e.g., of (report-) type (A) or (report-) type (C) as specified herein in the present disclosure, and/or the (corresponding) UEI report content(s) or report quantity(s)—e.g., of (report-) type (B) or (report-) type (C) as specified herein in the present disclosure. For this case/setting,
When/if the UE has been provided or configured by the network, e.g., via higher layer RRC signaling(s)/parameter(s) with necessary dynamic update(s) via MAC CE command(s) and/or DCI based L1 signaling(s) according to or based on a corresponding UE's capability or capability signaling, one or more periodic/semi-persistent PUCCH resources (e.g., pre-configured by the network) and/or one or more PUSCH resources (e.g., pre-configured by the network including CG PUSCH of Type1 and/or Type2) for sending the UEI report content(s)/quantity(s), the UE could follow those specified in Step-1, Step-2 and Step-3 to transmit the PN message/trigger and the corresponding UEI report content(s)/quantity(s) with pre-configured UL resource(s).
Otherwise, i.e., when/if the UE is not provided or configured by the network, e.g., via higher layer RRC signaling(s)/parameter(s) with necessary dynamic update(s) via MAC CE command(s) and/or DCI based L1 signaling(s) according to or based on a corresponding UE's capability or capability signaling, any (pre-configured) periodic/semi-persistent PUCCH resources and/or any (pre-configured) PUSCH resources (e.g., CG PUSCH of Type1 and/or Type2) for sending the UEI report content(s)/quantity(s), the UE could follow those specified in Step-1a, Step-2a and Step-3a to transmit the PN message/trigger and the corresponding UEI report content(s)/quantity(s) with dynamically granted/scheduled UL resource(s).

In one embodiment (embodiment-IV), the UEI report(s) could contain, provide, include or comprise at least a pre-notification (PN) message/trigger—e.g., of (report-) type (A) or (report-) type (C) as specified herein in the present disclosure, and/or the (corresponding) UEI report content(s) or report quantity(s)—e.g., of (report-) type (B) or (report-) type (C) as specified herein in the present disclosure. For this case/setting,
Step-1: the UE (e.g., the UE 116) could send a first PN message/trigger, e.g., via a first UL channel comprising one or more PUCCH resources, wherein the one or more PUCCH resources could be periodic and/or semi-persistent (e.g., pre-configured by the network for transmitting PN message/trigger), and each of the one or more PUCCH resources (e.g., of format 0/1/2/3/4) could be from one or more PUCCH resource sets, e.g., configured/provided for the UEI reporting(s) or more specifically for transmitting/sending PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the first PN message/trigger. Here, the first PN message/trigger could indicate a transmission of the UEI report content(s)/quantity(s) associated/specific to the first PN message/trigger, request candidate UL resource(s) for transmitting or sending the corresponding UEI report content(s)/quantity(s), and/or request UL resource allocation and/or indication for a second UL channel that could carry or convey the UEI report content(s)/quantity(s). In this case, before the transmission of the first PN message/trigger in Step-1, the UE may not be provided or configured by the network, e.g., via higher layer RRC signaling(s)/parameter(s) with necessary dynamic update(s) via MAC CE command(s) and/or DCI based L1 signaling(s) according to or based on a corresponding UE's capability or capability signaling, any (pre-configured) periodic/semi-persistent PUCCH resources and/or any (pre-configured) PUSCH resources (e.g., CG PUSCH of Type1 and/or Type2) for sending or transmitting UEI report content(s)/quantity(s).
Step-2a: after the UE has transmitted the first PN message/trigger, the UE could expect to receive from the network a first (downlink/uplink) DCI in response to the first PN message/trigger, within a time window starting from the first or last symbol/slot/etc. of the transmission of the first PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the first (downlink/uplink) DCI in response to the first PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the first (downlink/uplink) DCI in response to the first PN message/trigger. The first (downlink/uplink) DCI in response to the first PN message/trigger could comprise one or more of following components which provide or indicate a set of candidate UL resource(s) associated or specific to the first PN message/trigger, wherein the set of candidate UL resource(s) could comprise periodic/semi-persistent PUCCH resources and/or PUSCH resources (e.g., CG PUSCH of Type1 and/or Type2) for transmitting or sending UEI report content(s)/quantity(s):
   Component-A: a one-bit indicator with ‘1’ (or ‘0’) indicating acknowledgement (ACK) for the first PN message/trigger and ‘0’ (or ‘1’) indicating non-ACK (NACK) for the first PN message/trigger
   Component-B: a time gap/duration (e.g., in number of symbols/slots/etc.)
   Component-C: a priority order or value for the first PN message/trigger and/or the UEI report content(s)/quantity(s) associated/specific to the first PN message/trigger as defined/specified herein in the present disclosure
   Component-D: a time offset (e.g., in number of symbols/slots/etc.)
   Component-E: a set of candidate UL resource(s) comprising, e.g., one or more (periodic/semi-persistent) PUCCH resources and/or PUSCH resources (e.g., CG PUSCH of Type1 and/or Type2), wherein information related to the set of candidate UL resource(s) could comprise:
      Component-E1: one or more resource IDs/indexes for the set of candidate UL resource(s), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could comprise (1) (odd/even indexed) resources configured, indicated or provided for transmitting or sending UEI report content(s)/quantity(s), (2) the (first/latest or odd/even indexed) resource(s) configured, indicated or provided for transmitting or sending UEI report content(s)/quantity(s) k0 slots/symbols/etc. after the first or last symbol/slot/etc. of the transmission of the first PN message/trigger, (3) the (first/latest or odd/even indexed) resource(s) configured, indicated or provided for transmitting or sending UEI report content(s)/quantity(s) k1 slots/symbols/etc. after the first or last symbol/slot/etc. of the reception of the first (downlink/uplink) DCI, and/or (4) the (first/latest or odd/even indexed) resource(s) configured, indicated or provided for transmitting or sending UEI report content(s)/quantity(s) k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-E2: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could comprise (1) (odd/even indexed) resources configured, indicated or provided for transmitting or sending UEI report content(s)/quantity(s), (2) the (first/latest or odd/even indexed) resource(s) configured, indicated or provided for transmitting or sending UEI report content(s)/quantity(s) k0 slots/symbols/etc. after the first or last symbol/slot/etc. of the transmission of the first PN message/trigger, (3) the (first/latest or odd/even indexed) resource(s) configured, indicated or provided for transmitting or sending UEI report content(s)/quantity(s) k1 slots/symbols/etc. after the first or last symbol/slot/etc. of the reception of the first (downlink/uplink) DCI, and/or (4) the (first/latest or odd/even indexed) resource(s) configured, indicated or provided for transmitting or sending UEI report content(s)/quantity(s) k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be determined as a resource in the set of candidate UL resource(s) associated/specific to the first PN message/trigger.
      Component-E3: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could comprise (1) (odd/even indexed) resources configured, indicated or provided for transmitting or sending UEI report content(s)/quantity(s), (2) the (first/latest or odd/even indexed) resource(s) configured, indicated or provided for transmitting or sending UEI report content(s)/quantity(s) k0 slots/symbols/etc. after the first or last symbol/slot/etc. of the transmission of the first PN message/trigger, (3) the (first/latest or odd/even indexed) resource(s) configured, indicated or provided for transmitting or sending UEI report content(s)/quantity(s) k1 slots/symbols/etc. after the first or last symbol/slot/etc. of the reception of the first (downlink/uplink) DCI, and/or (4) the (first/latest or odd/even indexed) resource(s) configured, indicated or provided for transmitting or sending UEI report content(s)/quantity(s) k2 after a slot/symbol/etc. t0, wherein the value(s) of k0, k1, k2 and/or to as specified/defined herein in the present disclosure could be provided/indicated/configured by the network (e.g., the network 130), e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be determined as a resource in the set of candidate UL resource(s) associated/specific to the first PN message/trigger.
      Component-E4: one or more resource configuration/setting IDs/indexes—for the set of candidate UL resource(s), wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-E5: one or more resource set IDs/indexes with each of the corresponding resource sets comprising one or more resources for a set of candidate UL resource(s), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-E6: one or more CSI reporting configuration/setting IDs/indexes—for the set of candidate UL resource(s), wherein a CSI reporting setting/configuration is provided by CSI-ReportConfig.
      Component-E7: a starting symbol/slot/etc. for the set of candidate UL resource(s)
      Component-E8: an ending symbol/slot/etc. for the set of candidate UL resource(s)
      Component-E9: a time duration/length (e.g., in form/terms/number of symbols/slot/etc.) for the set of candidate UL resource(s)
      Component-E10: a number of resources for the set of candidate UL resource(s)
      Component-E11: a periodicity and a corresponding timing offset for the set of candidate UL resource(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-F: indication of resource(s) not used/available/applicable for the set of candidate UL resource(s) associated/specific to the first PN message/trigger as defined/specified herein in the present disclosure, wherein e.g., the set of candidate UL resource(s) could comprise one or more (periodic/semi-persistent) PUCCH resources and/or PUSCH resources (e.g., CG PUSCH of Type1 and/or Type2); the resource(s) not used/available/applicable for the set of candidate UL resource(s) associated/specific to the first PN message/trigger could be in form of one or more of the following:
   Component-F1: one or more resource IDs/indexes not used/applicable/available for the set of candidate UL resource(s), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could comprise (1) (odd/even indexed) resources configured, indicated or provided for transmitting or sending UEI report content(s)/quantity(s), (2) the (first/latest or odd/even indexed) resource(s) configured, indicated or provided for transmitting or sending UEI report content(s)/quantity(s) k0 slots/symbols/etc. after the first or last symbol/slot/etc. of the transmission of the first PN message/trigger, (3) the (first/latest or odd/even indexed) resource(s) configured, indicated or provided for transmitting or sending UEI report content(s)/quantity(s) k1 slots/symbols/etc. after the first or last symbol/slot/etc. of the reception of the first (downlink/uplink) DCI, and/or (4) the (first/latest or odd/even indexed) resource(s) configured, indicated or provided for transmitting or sending UEI report content(s)/quantity(s) k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-F2: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could comprise (1) (odd/even indexed) resources configured, indicated or provided for transmitting or sending UEI report content(s)/quantity(s), (2) the (first/latest or odd/even indexed) resource(s) configured, indicated or provided for transmitting or sending UEI report content(s)/quantity(s) k0 slots/symbols/etc. after the first or last symbol/slot/etc. of the transmission of the first PN message/trigger, (3) the (first/latest or odd/even indexed) resource(s) configured, indicated or provided for transmitting or sending UEI report content(s)/quantity(s) k1 slots/symbols/etc. after the first or last symbol/slot/etc. of the reception of the first (downlink/uplink) DCI, and/or (4) the (first/latest or odd/even indexed) resource(s) configured, indicated or provided for transmitting or sending UEI report content(s)/quantity(s) k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available as a resource in the set of candidate UL resource(s) associated/specific to the first PN message/trigger.
   Component-F3: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could comprise (1) (odd/even indexed) resources configured, indicated or provided for transmitting or sending UEI report content(s)/quantity(s), (2) the (first/latest or odd/even indexed) resource(s) configured, indicated or provided for transmitting or sending UEI report content(s)/quantity(s) k0 slots/symbols/etc. after the first or last symbol/slot/etc. of the transmission of the first PN message/trigger, (3) the (first/latest or odd/even indexed) resource(s) configured, indicated or provided for transmitting or sending UEI report content(s)/quantity(s) k1 slots/symbols/etc. after the first or last symbol/slot/etc. of the reception of the first (downlink/uplink) DCI, and/or (4) the (first/latest or odd/even indexed) resource(s) configured, indicated or provided for transmitting or sending UEI report content(s)/quantity(s) k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available as a resource in the set of candidate UL resource(s) associated/specific to the first PN message/trigger.
   Component-F4: one or more resource configuration/setting IDs/indexes—for resource(s) not used/applicable/available for the set of candidate UL resource(s), wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-F5: one or more resource set IDs/indexes with each of the corresponding resource sets comprising one or more resources not used/available/applicable for the set of candidate UL resource(s), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-F6: one or more CSI reporting configuration/setting IDs/indexes—for resource(s) not used/available/applicable for the set of candidate UL resource(s), wherein a CSI reporting setting/configuration is provided by CSI-ReportConfig.
   Component-F7: a starting symbol/slot/etc. for the resource(s) not used/applicable/available for the set of candidate UL resource(s)
   Component-6i: an ending symbol/slot/etc. for resource(s) not used/applicable/available for the set of candidate UL resource(s)
   Component-6j: a time duration/length (e.g., in form/terms/number of symbols/slot/etc.), within which the resources may not be used/applicable/available for the set of candidate UL resource(s)
   Component-6k: a number of resources not used/available/applicable for the set of candidate UL resource(s)
   Component-6l: a periodicity and a corresponding timing offset for resource(s) not used/available/applicable for the set of candidate UL resource(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the set of candidate UL resource(s) in the same resource set could be determined as resource(s) in the set of candidate UL resource(s) associated/specific to the first PN message/trigger.
Component-G: information related to modulation and/or coding (e.g., channel coding rate) scheme(s) for the set of candidate UL resource(s) comprising one or more of: a modulation and coding scheme (MCS) and/or a MCS index among a set of candidate MCS schemes for the set of candidate UL resource(s) configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the set of candidate UL resource(s) configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the set of candidate UL resource(s) configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-A-Component-G as defined/specified herein in the present disclosure could correspond to or could be realized, specified or implemented as/by one or more new DCI fields in the corresponding first (downlink/uplink) DCI format; optionally, one or more of the components including Component-A-Component-G as defined/specified herein in the present disclosure could correspond to or could be repurposed by one or more bits of one or more existing DCI fields in the corresponding first (downlink/uplink) DCI format. Furthermore, the UE could indicate to the network, e.g., in form of a UE's capability via a UE's capability signaling, which one or more of the components including Component-A-Component-G as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, which one or more of the components including Component-A-Component-G as defined/specified herein in the present disclosure the UE could support or expect.
Step-2b: the UE could determine or identify the set of candidate UL resource(s) according to one or more of:
   In one example, when/if the UE does not report to the network the capability signaling that they could support Step-2a as specified/described herein in the present disclosure, and/or when/if the UE reports to the network that they could not support Step-2a as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2a as specified/described herein in the present disclosure could be enabled and/or the UE could expect to receive from the network the first (downlink/uplink) DCI format in response to the transmission of the first PN message/trigger in Step-1, the UE could identify the set of candidate UL resource(s) as the resource(s) configured or provided or indicated by the network for transmitting or sending UEI report content(s)/quantity(s) a time period/window/duration (e.g., denoted by t1 in terms/form/number of symbols/slots/etc.) after the first or last symbol/slot/etc. of the transmission of the first PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For (iii), i.e., for the UE to autonomously determine or select the value(s) of the time period/window/duration t1 (e.g., in form/terms/number of slots/symbols/etc.): for example, the value(s) of t1 could be or could correspond to a random value within a value range, wherein the value range could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.
   In another example, the UE (e.g., the UE 116) could expect to receive the first (downlink/uplink) DCI in response to the transmission of the first PN message/trigger comprising one or more of the components including Component-A-Component-G as defined/specified herein in the present disclosure according to network's configuration(s) and/or indication(s) based on the corresponding UE's capability or capability signaling following those specified/described herein in the present disclosure. For example, the UE could expect to receive the first (downlink/uplink) DCI in response to the transmission of the first PN message/trigger comprising one or more of the components including Component-E and/or Component-F according to network's configuration(s) and/or indication(s) based on the corresponding UE's capability or capability signaling following those specified/described herein in the present disclosure. For this design example, the UE could determine or identify the set of candidate UL resource(s) according to the resource allocation and/or indication provided/indicated in/by Component-E and/or Component-F as specified herein in the present disclosure.

The first (downlink/uplink) DCI (in Step-2a) in response to the transmission of the first PN message/trigger in Step-1 could be in various DCI formats including (uplink) DCI format 0_0, 0_1 and/or 0_2, (downlink) DCI format 1_0, 1_1 and/or 1_2, group common DCI format 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the first PN message/trigger transmission in Step-1 via/in the first UL channel:
The group common DCI format could comprise or indicate or provide one or more sets of components (e.g., one or more of Component-A-Component-G as defined/specified herein in the present disclosure) with each set of components dedicated or specific or associated or corresponding to a first PN message/trigger or a transmission of a first PN message/trigger or a configuration of first PN message/trigger or an order/index of a (transmission of) first PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a first PN message/trigger in Step-1; upon detection or reception of the group common DCI in Step-2a, the UE could identify or determine the set of components (e.g., one or more of Component-A-Component-G as defined or specified herein in the present disclosure) provided/indicated in the group common DCI format that are associated or specific or dedicated to the first PN message/trigger in Step-1 and/or any other identification information related to the UE. The UE could then identify or determine the resource(s) based on the identified or determined set of components following those specified herein in the present disclosure as in the set of candidate UL resource(s) associated/specific to the first PN message/trigger.
Step-2b: the first (downlink/uplink) DCI in response to the first PN message/trigger could also comprise one or more of the components (including Component-1-Component-7) as defined/specified herein in the present disclosure (e.g., the embodiment-I), wherein in this case, the set of resource(s) or the resource set in Component-1-Component-7 could be referred to or could be replaced by the set of candidate UL resource(s) associated/specific to the first PN message/trigger determined or identified in Step-2a.
Step-3: the UE could send or transmit to the network, via/in the second UL channel, the UEI report content(s)/quantity(s) associated/specific to the first PN message/trigger transmitted or sent via/in the first UL channel as defined/specified herein in the present disclosure, wherein the second UL channel could comprise one or more periodic/semi-persistent PUCCH resources and/or one or more PUSCH resources (e.g., CG PUSCH of Type1 and/or Type2, dynamically granted/scheduled by the network for sending the UEI report content(s)/quantity(s) including DG PUSCH); the UE could determine or identify the resource(s) for the second UL channel from the set of candidate UL resource(s) associated/specific to the first PN message/trigger determined or identified in Step-2a according to those described or specified in Step-1 in the embodiment-I discussed in the present disclosure.
Step-4: the UE could send a second PN message/trigger, e.g., via a third UL channel comprising one or more PUCCH resources, wherein the one or more PUCCH resources could be periodic and/or semi-persistent (e.g., pre-configured by the network for transmitting PN message/trigger), and each of the one or more PUCCH resources (e.g., of format 0/1/2/3/4) could be from one or more PUCCH resource sets, e.g., configured/provided for the UEI reporting(s) or more specifically for transmitting/sending PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the second PN message/trigger. Here, the second PN message/trigger could indicate a transmission of the UEI report content(s)/quantity(s) associated/specific to the second PN message/trigger, and/or request UL resource allocation and/or indication for a fourth UL channel that could carry or convey the UEI report content(s)/quantity(s). In this case, before the transmission of the second PN message/trigger in Step-4, the UE could have identified or determined the set of candidate UL resource(s) associated or specific to the first PN message/trigger in Step-1, and the actual resource(s) for the fourth UL channel used to carry or convey the actual UEI report content(s)/quantity(s) associated/specific to the second PN message/trigger could be determined, identified or selected from the set of candidate UL resource(s).
Step-5: after the UE has transmitted the second PN message/trigger, the UE could expect to receive from the network a second (downlink/uplink) DCI in response to the second PN message/trigger, within a time window starting from the first or last symbol/slot/etc. of the transmission of the second PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the second (downlink/uplink) DCI in response to the second PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the second (downlink/uplink) DCI in response to the second PN message/trigger. The second (downlink/uplink) DCI in response to the second PN message/trigger could comprise one or more of the components (including Component-1-Component-7) as defined/specified herein in the present disclosure (e.g., the embodiment-I), wherein in this case, the set of resource(s) or the resource set in Component-1-Component-7 could be referred to or could be replaced by the set of candidate UL resource(s) associated/specific to the first PN message/trigger determined or identified in Step-2a.
Step-6: the UE could send or transmit to the network, via/in the fourth UL channel, the UEI report content(s)/quantity(s) associated/specific to the second PN message/trigger transmitted or sent via/in the third UL channel as defined/specified herein in the present disclosure, wherein the fourth UL channel could comprise one or more periodic/semi-persistent PUCCH resources and/or one or more PUSCH resources (e.g., CG PUSCH of Type1 and/or Type2, dynamically granted/scheduled by the network for sending the UEI report content(s)/quantity(s) including DG PUSCH); the UE could determine or identify the resource(s) for the fourth UL channel from the set of candidate UL resource(s) associated/specific to the first PN message/trigger determined or identified in Step-2a according to those described or specified in Step-1 in the embodiment-I discussed in the present disclosure.

The design examples and procedures specified herein in the present disclosure could be conducted/performed under the condition that the UE-initiated reporting or the UE-initiated beam management is enabled—e.g., via network's configuration(s)/indication(s) through higher layer RRC signaling(s)/parameter(s) and/or MAC CE command(s) and/or dynamic DCI based L1 signaling(s) based on or according to a corresponding UE's capability or capability signaling(s). Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s).

Throughout the present disclosure, when/if the UE has been provided or configured by the network (e.g., the network 130), e.g., via higher layer RRC signaling(s)/parameter(s) with necessary dynamic update(s) via MAC CE command(s) and/or DCI based L1 signaling(s) according to or based on a corresponding UE's capability or capability signaling, one or more UL resources including periodic/semi-persistent PUCCH resources (e.g., pre-configured by the network) and/or one or more PUSCH resources (e.g., pre-configured by the network including CG PUSCH of Type1 and/or Type2) for sending or transmitting the UEI report(s) including the PN message/trigger and/or the corresponding UEI report content(s)/quantity(s), the periodicity of the pre-configured UL resource(s) and/or the time(-domain) gap(s)/offset(s)—e.g., in number of slots/symbols/etc.—between two adjacent UL resources in time and/or the frequency(-domain) gap(s)/offset(s)—e.g., in number of PRBs/etc.—between two adjacent UL resources in frequency could be first higher layer RRC configured or provided by the network, and updated and/or indicated by/via MAC CE command(s) and/or dynamic DCI based L1 signaling(s) based on or according to a corresponding UE's capability or capability signaling. In addition, when/if the periodicity of the pre-configured UL resource(s) and/or the time(-domain) gap(s)/offset(s)—e.g., in number of slots/symbols/etc.—between two adjacent UL resources in time and/or the frequency(-domain) gap(s)/offset(s)—e.g., in number of PRBs/etc.—between two adjacent UL resources in frequency is less than or equal to a threshold, the UE could expect to receive the (downlink/uplink) DCI in response to the transmission of the PN message/trigger comprising one or more of the components as specified/defined herein in the present disclosure according to network's configuration(s) and/or indication(s) based on the corresponding UE's capability or capability signaling following those specified/described herein in the present disclosure; otherwise, the UE may not expect to receive any (downlink/uplink) DCI as specified or defined herein in the present disclosure in response to the transmission of the PN message/trigger. The UE could determine or identify the value(s) of the threshold according to: (1) fixed value(s) in system specification(s) and/or per RRC configuration, (2) network's configuration(s) and/or indication(s), e.g., via higher layer RRC signaling(s)/parameter(s) and/or MAC CE command(s) and/or dynamic DCI based L1 signaling(s), based on or according to a corresponding UE's capability or capability signaling, and/or (3) UE's autonomous determination or selection, which could be further sent to the network via various UL channels/signals including beam/CSI report(s) and/or UE's capability signaling(s).

Optionally, when/if the UE has been provided or configured by the network, e.g., via higher layer RRC signaling(s)/parameter(s) with necessary dynamic update(s) via MAC CE command(s) and/or DCI based L1 signaling(s) according to or based on a corresponding UE's capability or capability signaling, one or more UL resources including periodic/semi-persistent PUCCH resources (e.g., pre-configured by the network) and/or one or more PUSCH resources (e.g., pre-configured by the network including CG PUSCH of Type1 and/or Type2) for sending or transmitting the UEI report(s) including the PN message/trigger and/or the corresponding UEI report content(s)/quantity(s), the UE may not expect to receive any (downlink/uplink) DCI format(s) in response to the transmission of the PN message/trigger according to those specified herein in the present disclosure. Or, when/if the UE has been provided or configured by the network, e.g., via higher layer RRC signaling(s)/parameter(s) with necessary dynamic update(s) via MAC CE command(s) and/or DCI based L1 signaling(s) according to or based on a corresponding UE's capability or capability signaling, one or more UL resources including periodic/semi-persistent PUCCH resources (e.g., pre-configured by the network) and/or one or more PUSCH resources (e.g., pre-configured by the network including CG PUSCH of Type1 and/or Type2) for sending or transmitting the UEI report(s) including the PN message/trigger and/or the corresponding UEI report content(s)/quantity(s), the UE may not expect to receive any (downlink/uplink) DCI format(s) in response to the transmission of the PN message/trigger that provides or indicates or comprises component(s)—e.g., Component-5 and/or Component-6 as defined or specified herein in the present disclosure—that provides or indicates or comprises resource allocation and/or indication for the UL channel(s) that would/could carry or convey the UEI report content(s)/quantity(s) associated/specific to the PN message/trigger according to those specified herein in the present disclosure.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity-including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-) type (A), (report-) type (B) and/or (report-) type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network, e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

The present disclosure provides various aspects and detailed design examples on the UE-initiated beam management framework including UE-initiated/triggered beam/CSI reporting and/or UE-initiated/triggered beam switching and/or UE-initiated/triggered beam activation/deactivation/sub-selection. To better support/enable the UE-initiated and the event-based beam operations, this disclosure presents example embodiments on means and/or procedures of transmitting the UE-initiated report(s) along with its indicator(s) via various uplink channels. In addition, the present disclosure also provides various methods along with the corresponding signaling designs/alternatives to enable switch between different UE-initiated beam reporting modes, options or schemes.

For a first event, wherein the radio link or beam quality(s) of one or more current serving beams is below or less than or equal to a threshold-A (an instance for the first event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s). In this case, a/the UEI report, e.g., for the first event, could comprise one or more of the following components for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure:
Component-1a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-1b: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-1c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1a for the one or more first current serving beams; differential RSRP/SINR reporting could be applied to Component-1c according to those specified herein in the present disclosure.
Component-1d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-1b for the one or more second current serving beams; differential RSRP/SINR reporting could be applied to Component-1d according to those specified herein in the present disclosure.
Component-1e: indicator(s) or bitmap(s) indicating the one or more first current serving beams—e.g., out of the current serving beams
Component-1f: indicator(s) or bitmap(s) indicating the one or more second current serving beams—e.g., out of the current serving beams or out of the first current serving beam(s)
Component-1g: a number of the one or more first current serving beams in the UEI report(s)
Component-1h: a number of the one or more second current serving beams in the UEI report(s)
Component-1i: indicator(s) indicating occurrence of the first event and/or an event index/ID associated/specific/corresponding to the first event
Component-1j: difference(s) between the beam metric(s) such as L1-RSRP(s)/L1-SINR(s) for the one or more first current serving beams and the threshold-A; For instance, if a (differential) L1-RSRP/L1-SINR value computed with respect to or regarding or for a first current serving beam is x dBm, and the threshold-A is y dBm, a difference delta_diff_A=|x−y| dBm could be reported in the UEI report as a report content/quantity, and a corresponding one-bit sign indicator indicating either positive or negative of the difference could also be reported in the same UEI report. Or the difference delta_diff_A=(x−y) and/or (y−x) dBm could be reported in the UEI report as a report content/quantity. Optionally, the value of delta_diff_A could be quantized to a u-bit value with a v dB step size with respect to the threshold-A.
Component-1k: difference(s) between the beam metric(s) such as L1-RSRP(s)/L1-SINR(s) for the one or more second current serving beams and the threshold-A; For instance, if a (differential) L1-RSRP/L1-SINR value computed with respect to or regarding or for a second current serving beam is x′ dBm, and the threshold-A is y dBm, a difference delta_diff_A′=|x′−y| dBm could be reported in the UEI report as a report content/quantity, and a corresponding one-bit sign indicator indicating either positive or negative of the difference could also be reported in the same UEI report. Or the difference delta_diff_A′=(x′−y) and/or (y−x′) dBm could be reported in the UEI report as a report content/quantity.
Component-1l: indicator(s) indicating presence or absent of Component-1a in the UEI report(s); e.g., the indicator(s) could be a one-bit indicator with ‘1’ (or ‘0’) indicating presence and ‘0’ (or ‘1’) indicating absence of Component-1a in the UEI report(s). Optionally, the value of delta_diff_A′ could be quantized to a u-bit value with a v dB step size with respect to the threshold-A.
Component-1m: indicator(s) indicating presence or absent of Component-1b in the UEI report(s); e.g., the indicator(s) could be a one-bit indicator with ‘1’ (or ‘0’) indicating presence and ‘0’ (or ‘1’) indicating absence of Component-1b in the UEI report(s).
Component-1n: indicator(s) indicating presence or absent of Component-1c in the UEI report(s); e.g., the indicator(s) could be a one-bit indicator with ‘1’ (or ‘0’) indicating presence and ‘0’ (or ‘1’) indicating absence of Component-1c in the UEI report(s).
Component-1o: indicator(s) indicating presence or absent of Component-1d in the UEI report(s); e.g., the indicator(s) could be a one-bit indicator with ‘1’ (or ‘0’) indicating presence and ‘0’ (or ‘1’) indicating absence of Component-1d in the UEI report(s).
Component-1p: indicator(s) indicating presence or absence of Component-1j in the UEI report(s); e.g., the indicator(s) could be a one-bit indicator with ‘1’ (or ‘0’) indicating presence and ‘0’ (or ‘1’) indicating absence of Component-1j in the UEI report(s).
Component-1q: indicator(s) indicating presence or absence of Component-1k in the UEI report(s); e.g., the indicator(s) could be a one-bit indicator with ‘1’ (or ‘0’) indicating presence and ‘0’ (or ‘1’) indicating absence of Component-1k in the UEI report(s).

The value(s) of threshold-A, threshold-A′, Ns, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Ns>1. In another example, Ns≥1.

For a second event, wherein the radio link or beam quality(s) of one or more candidate beams is beyond or greater than or equal to a threshold-B (an instance for the second event), a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s)-throughout the present disclosure, a candidate beam is equivalent to a candidate new beam or a new beam. In this case, a/the UEI report, e.g., for the second event, could comprise one or more of the following components for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure:
Component-2a: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-2b: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE (e.g., the UE 116) uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-2c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2a for the one or more first candidate beams; differential RSRP/SINR reporting could be applied to Component-2c according to those specified herein in the present disclosure.
Component-2d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-2b for the one or more second candidate beams; differential RSRP/SINR reporting could be applied to Component-2d according to those specified herein in the present disclosure.
Component-2e: indicator(s) or bitmap(s) indicating the one or more first candidate beams—e.g., out of the candidate beams
Component-2f: indicator(s) or bitmap(s) indicating the one or more second candidate beams—e.g., out of the candidate beams or out of the first candidate beam(s)
Component-2g: a number of the one or more first candidate beams in the UEI report(s)
Component-2h: a number of the one or more second candidate beams in the UEI report(s)
Component-2i: indicator(s) indicating occurrence of the second event and/or an event index/ID associated/specific/corresponding to the second event
Component-2j: difference(s) between the beam metric(s) such as L1-RSRP(s)/L1-SINR(s) for the one or more first candidate beams and the threshold-B; For instance, if a (differential) L1-RSRP/L1-SINR value computed with respect to or regarding or for a first candidate beam is x dBm, and the threshold-B is y dBm, a difference delta_diff_B=|x−y| dBm could be reported in the UEI report as a report content/quantity, and a corresponding one-bit sign indicator indicating either positive or negative of the difference could also be reported in the same UEI report. Or the difference delta_diff_B=(x−y) and/or (y−x) dBm could be reported in the UEI report as a report content/quantity. Optionally, the value of delta_diff_B could be quantized to a u-bit value with a v dB step size with respect to the threshold-B.
Component-2k: difference(s) between the beam metric(s) such as L1-RSRP(s)/L1-SINR(s) for the one or more second candidate beams and the threshold-B; For instance, if a (differential) L1-RSRP/L1-SINR value computed with respect to or regarding or for a second candidate beam is x′ dBm, and the threshold-B is y dBm, a difference delta_diff_B′=|x′−y| dBm could be reported in the UEI report as a report content/quantity, and a corresponding one-bit sign indicator indicating either positive or negative of the difference could also be reported in the same UEI report. Or the difference delta_diff_B′=(x′−y) and/or (y−x′) dBm could be reported in the UEI report as a report content/quantity. Optionally, the value of delta_diff_B′ could be quantized to a u-bit value with a v dB step size with respect to the threshold-B.
Component-2l: indicator(s) indicating presence or absent of Component-2a in the UEI report(s); e.g., the indicator(s) could be a one-bit indicator with ‘1’ (or ‘0’) indicating presence and ‘0’ (or ‘1’) indicating absence of Component-2a in the UEI report(s).
Component-2m: indicator(s) indicating presence or absent of Component-2b in the UEI report(s); e.g., the indicator(s) could be a one-bit indicator with ‘1’ (or ‘0’) indicating presence and ‘0’ (or ‘1’) indicating absence of Component-2b in the UEI report(s).
Component-2n: indicator(s) indicating presence or absent of Component-2c in the UEI report(s); e.g., the indicator(s) could be a one-bit indicator with ‘1’ (or ‘0’) indicating presence and ‘0’ (or ‘1’) indicating absence of Component-2c in the UEI report(s).
Component-2o: indicator(s) indicating presence or absent of Component-2d in the UEI report(s); e.g., the indicator(s) could be a one-bit indicator with ‘1’ (or ‘0’) indicating presence and ‘0’ (or ‘1’) indicating absence of Component-2d in the UEI report(s).
Component-2p: indicator(s) indicating presence or absence of Component-2j in the UEI report(s); e.g., the indicator(s) could be a one-bit indicator with ‘1’ (or ‘0’) indicating presence and ‘0’ (or ‘1’) indicating absence of Component-2j in the UEI report(s).
Component-2q: indicator(s) indicating presence or absence of Component-2k in the UEI report(s); e.g., the indicator(s) could be a one-bit indicator with ‘1’ (or ‘0’) indicating presence and ‘0’ (or ‘1’) indicating absence of Component-2k in the UEI report(s).

The value(s) of threshold-B, threshold-B′, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. In one example, Nc>1. In another example, Nc≥1.

For a third event, wherein the radio link or beam quality(s) of one or more current serving beams is below or less than or equal to a threshold-A (an instance for the third event), and the radio link or beam quality(s) of one or more candidate beams is beyond or greater than or equal to a threshold-B, a/the UEI report could comprise report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-A for the current serving beam(s), and/or information related to presence or absence of one or more of the report contents/quantities as described/specified herein in the present disclosure for the current serving beam(s), and/or report content(s)/quantity(s) including resource indicator(s) such as SSBRI(s)/CRI(s) and/or beam metric(s) such as L1-RSRP(s)/L1-SINR(s) and/or quality metric(s) such as difference(s) between the beam metric(s) such as L1-RSRP(s)/L1-SINR(s) and the threshold-B for the candidate beam(s), and/or information related to presence or absence of one or more of the report contents/quantities as described/specified herein in the present disclosure for the candidate beam(s). In this case, a/the UEI report, e.g., for the third event, could comprise one or more of the Component-1a to Component-1q as specified/defined herein in the present disclosure for one or more first current serving beams with their associated/corresponding radio link/beam quality(s) less than or below or equal to the threshold-A according to those specified/defined herein in the present disclosure, wherein the one or more first current serving beams could comprise one or more (e.g., Ns) second current serving beams with their associated/corresponding radio link/beam quality(s) greater than or equal to or beyond a threshold-A′ or with their associated/corresponding radio link/beam quality(s) corresponding to the highest (or lowest) Ns radio link/beam quality(s) among the one or more first current serving beams as defined/specified herein in the present disclosure, and one or more of the Component-2a to Component-2q for one or more first candidate beams with their associated/corresponding radio link/beam quality(s) greater than or beyond or equal to the threshold-B according to those specified/defined herein in the present disclosure, wherein the one or more first candidate beams could comprise one or more (e.g., Nc) second candidate beams with their associated/corresponding radio link/beam quality(s) greater than or equal to or beyond a threshold-B′ or with their associated/corresponding radio link/beam quality(s) corresponding to the highest (or lowest) Nc radio link/beam quality(s) among the one or more first candidate beams as defined/specified herein in the present disclosure, and/or Component-3: indicator(s) indicating occurrence of the third event and/or an event index/ID associated/specific/corresponding to the third event.

For a fourth event, wherein the radio link or beam quality(s) of one or more (or at least one) candidate beams is beyond or greater than the radio link or beam quality(s) of one or more current serving beams by a threshold-C (an instance for the fourth event), a/the UEI report could comprise report content(s)/quantity(s) including resource indicator(s) such as SSBRI(s)/CRI(s) and/or beam metric(s) such as L1-RSRP(s)/L1-SINR(s) for the current serving beam(s), and/or report content(s)/quantity(s) including resource indicator(s) such as SSBRI(s)/CRI(s) and/or beam metric(s) such as L1-RSRP(s)/L1-SINR(s) for the candidate beam(s), and/or information related to presence or absence of one or more of the report contents/quantities as described/specified herein in the present disclosure for the current serving beam(s), and/or information related to presence or absence of one or more of the report contents/quantities as described/specified herein in the present disclosure for the candidate beam(s), and/or quality metric(s) such as first difference(s) between the beam metric(s) such as L1-RSRP(s)/L1-SINR(s) for the current serving beam(s) and the beam metric(s) such as L1-RSRP(s)/L1-SINR(s) for the candidate beam(s), second difference(s) between the first difference(s) and the threshold-C. In this case, a/the UEI report, e.g., for the fourth event, could comprise one or more of the following components for one or more first current serving beams, wherein the one or more first current serving beams could comprise one or more (e.g., Ns) second current serving beams with their associated/corresponding radio link/beam quality(s) greater than or equal to or beyond a threshold-C′ or with their associated/corresponding radio link/beam quality(s) corresponding to the highest (or lowest) Ns radio link/beam quality(s) among the one or more first current serving beams as defined/specified herein in the present disclosure, and/or for one or more first candidate beams, wherein the one or more first candidate beams could comprise one or more (e.g., Nc) second candidate beams with their associated/corresponding radio link/beam quality(s) greater than or equal to or beyond a threshold-C″ or with their associated/corresponding radio link/beam quality(s) corresponding to the highest (or lowest) Nc radio link/beam quality(s) among the one or more first candidate beams as defined/specified herein in the present disclosure; in this case, as specified/described herein in the present disclosure, the radio link or beam quality(s) of the first candidate beam(s) is beyond or greater than the radio link or beam quality(s) of the first current serving beam(s) by the threshold-C.
Component-4a: resource indicator(s) such as SSBRI(s)/CRI(s) for the one or more first current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more first current serving beams.
Component-4b: resource indicator(s) such as SSBRI(s)/CRI(s) for the one or more first candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more first candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more first candidate beams.
Component-4c: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4a for the one or more first current serving beams; differential RSRP/SINR reporting could be applied to Component-4c according to those specified herein in the present disclosure.
Component-4d: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4b for the one or more first candidate beams; differential RSRP/SINR reporting could be applied to Component-4c according to those specified herein in the present disclosure.
Component-4e: first difference(s) between the beam metric(s) such as L1-RSRP(s)/L1-SINR(s) for the one or more first current serving beams and the beam metric(s) such as L1-RSRP(s)/L1-SINR(s) for the one or more first candidate beams; For instance, if a (differential) L1-RSRP/L1-SINR value computed with respect to or regarding or for a first current serving beam is x1 dBm, and a (differential) L1-RSRP/L1-SINR value computed with respect to or regarding or for a first candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4f: second difference(s) between the first difference(s) in Component-4e and the threshold-C; For instance, for a first difference delta_diff_C (or |delta_diff_C|) specified/defined or obtained in Component-4e and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4g: indicator(s) or bitmap(s) indicating the one or more first current serving beams—e.g., out of the current serving beams
Component-4h: indicator(s) or bitmap(s) indicating the one or more first candidate beams—e.g., out of the candidate beams.
Component-4i: a number of the one or more first current serving beams in the UEI report(s)
Component-4j: a number of the one or more first candidate beams in the UEI report(s)
Component-4k: resource indicator(s) such as SSBRI(s)/CRI(s) for the one or more second current serving beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second current serving beams and/or TCI state ID(s)/index(es) of the one or more indicated joint/DL/UL TCI states that provide the (QCL source) RS(s) the UE uses/applies for assessing or monitoring the radio link/beam quality(s) of the one or more second current serving beams.
Component-4l: resource indicator(s) such as SSBRI(s)/CRI(s) for the one or more second candidate beams; resource ID(s)/index(es) and/or RS ID(s)/index(es) of the (QCL source) RS(s) provided in one or more indicated joint/DL/UL TCI states that the UE uses/applies for assessing or monitoring the radio link/beam quality(s) of the one or more second candidate beams and/or TCI state ID(s)/index(es) of the one or more indicated joint/DL/UL TCI states that provide the (QCL source) RS(s) the UE uses/applies for assessing or monitoring the radio link/beam quality(s) of the one or more second candidate beams.
Component-4m: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4k for the one or more second current serving beams; differential RSRP/SINR reporting could be applied to Component-4m according to those specified herein in the present disclosure.
Component-4n: beam metric(s) such as L1-RSRP(s)/L1-SINR(s) associated/corresponding to the resource indicator(s), resource ID(s)/index(es), RS ID(s)/index(es) and/or TCI state ID(s)/index(es) in Component-4l for the one or more second candidate beams; differential RSRP/SINR reporting could be applied to Component-4n according to those specified herein in the present disclosure.
Component-4o: first difference(s) between the beam metric(s) such as L1-RSRP(s)/L1-SINR(s) for the one or more second current serving beams and the beam metric(s) such as L1-RSRP(s)/L1-SINR(s) for the one or more second candidate beams; For instance, if a (differential) L1-RSRP/L1-SINR value computed with respect to or regarding or for a second current serving beam is x1 dBm, and a (differential) L1-RSRP/L1-SINR value computed with respect to or regarding or for a second candidate beam is x2 dBm, a first difference delta_diff_C=|x2−x1| dBm could be reported in the UEI report as a report content/quantity, and a corresponding one-bit sign indicator indicating either positive or negative of the first difference could also be reported in the same UEI report. Or the first difference delta_diff_C=(x1−x2) and/or (x2−x1) dBm could be reported in the UEI report as a report content/quantity. Optionally, the value of delta_diff_C could be quantized to a u-bit value with a v dB step size with respect to the threshold-C.
Component-4p: second difference(s) between the first difference(s) in Component-4o and the threshold-C; For instance, for a first difference delta_diff_C (or |delta_diff_C|) specified/defined or obtained in Component-4o and if the threshold-C is z dBm, a second difference delta_diff_C′=|delta_diff_C−z| dBm could be reported in the UEI report as a report content/quantity, and a corresponding one-bit sign indicator indicating either positive or negative of the second difference could also be reported in the same UEI report. Or the second difference delta_diff_C′=(delta_diff_C−z) and/or (z−delta_diff_C) dBm could be reported in the UEI report as a report content/quantity. Optionally, the value of delta_diff_C′ could be quantized to a u-bit value with a v dB step size with respect to the threshold-C and/or the first difference delta_diff_C in this design example.
Component-4q: indicator(s) or bitmap(s) indicating the one or more second current serving beams—e.g., out of the current serving beams or out of the first current serving beam(s)
Component-4r: indicator(s) or bitmap(s) indicating the one or more second candidate beams—e.g., out of the candidate beams or out of the first candidate beam(s).
Component-4s: a number of the one or more second current serving beams in the UEI report(s)
Component-4t: a number of the one or more second candidate beams in the UEI report(s)
Component-4u: indicator(s) indicating occurrence of the fourth event and/or an event index/ID associated/specific/corresponding to the fourth event
Component-5a: indicator(s) indicating presence or absent of Component-4a in the UEI report(s); e.g., the indicator(s) could be a one-bit indicator with ‘1’ (or ‘0’) indicating presence and ‘0’ (or ‘1’) indicating absence of Component-4a in the UEI report(s).
Component-5b: indicator(s) indicating presence or absent of Component-4b in the UEI report(s); e.g., the indicator(s) could be a one-bit indicator with ‘1’ (or ‘0’) indicating presence and ‘0’ (or ‘1’) indicating absence of Component-4b in the UEI report(s).
Component-5c: indicator(s) indicating presence or absent of Component-4c in the UEI report(s); e.g., the indicator(s) could be a one-bit indicator with ‘1’ (or ‘0’) indicating presence and ‘0’ (or ‘1’) indicating absence of Component-4c in the UEI report(s).
Component-5d: indicator(s) indicating presence or absent of Component-4d in the UEI report(s); e.g., the indicator(s) could be a one-bit indicator with ‘1’ (or ‘0’) indicating presence and ‘0’ (or ‘1’) indicating absence of Component-4d in the UEI report(s).
Component-5e: indicator(s) indicating presence or absence of Component-4e in the UEI report(s); e.g., the indicator(s) could be a one-bit indicator with ‘1’ (or ‘0’) indicating presence and ‘0’ (or ‘1’) indicating absence of Component-4e in the UEI report(s).
Component-5f: indicator(s) indicating presence or absence of Component-4f in the UEI report(s); e.g., the indicator(s) could be a one-bit indicator with ‘1’ (or ‘0’) indicating presence and ‘0’ (or ‘1’) indicating absence of Component-4f in the UEI report(s).
Component-5g: indicator(s) indicating presence or absent of Component-4k in the UEI report(s); e.g., the indicator(s) could be a one-bit indicator with ‘1’ (or ‘0’) indicating presence and ‘0’ (or ‘1’) indicating absence of Component-4k in the UEI report(s).
Component-5h: indicator(s) indicating presence or absent of Component-4l in the UEI report(s); e.g., the indicator(s) could be a one-bit indicator with ‘1’ (or ‘0’) indicating presence and ‘0’ (or ‘1’) indicating absence of Component-4l in the UEI report(s).
Component-5i: indicator(s) indicating presence or absent of Component-4m in the UEI report(s); e.g., the indicator(s) could be a one-bit indicator with ‘1’ (or ‘0’) indicating presence and ‘0’ (or ‘1’) indicating absence of Component-4m in the UEI report(s).
Component-5j: indicator(s) indicating presence or absent of Component-4n in the UEI report(s); e.g., the indicator(s) could be a one-bit indicator with ‘1’ (or ‘0’) indicating presence and ‘0’ (or ‘1’) indicating absence of Component-4n in the UEI report(s).
Component-5k: indicator(s) indicating presence or absence of Component-4o in the UEI report(s); e.g., the indicator(s) could be a one-bit indicator with ‘1’ (or ‘0’) indicating presence and ‘0’ (or ‘1’) indicating absence of Component-4o in the UEI report(s).
Component-5l: indicator(s) indicating presence or absence of Component-4p in the UEI report(s); e.g., the indicator(s) could be a one-bit indicator with ‘1’ (or ‘0’) indicating presence and ‘0’ (or ‘1’) indicating absence of Component-4p in the UEI report(s).

The value(s) of threshold-C, threshold-C′, threshold-C″, Ns, Nc, u and/or v could be determined according to: (i) a fixed value in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. In one example, Nc>1 and/or Ns>1. In another example, Nc≥1 and/or Ns≥1.

For each (or one or more) of the first, second, third and fourth events, and/or for a UE to declare each (or one or more) of the first, second, third and fourth events, and/or for a UE to formulate, construct, transmit and/or send the UEI report(s) with the report content(s)/quantity(s) corresponding to each (or one or more) of the first, second, third and fourth events according to or following those specified herein in the present disclosure, and/or for a UE to use/apply each (or one or more) of the first, second, third and fourth events for triggering or initiating the UEI reporting according to or following those specified herein in the present disclosure, the corresponding MAC entity could or shall for each Serving Cell configured for UEI reporting according to those specified herein in the present disclosure:
1> to initiate or trigger a UEI reporting based on or according to detection or declaration of one or each of the first, second, third and fourth events, individually:
   2> if an indication for an instance for an event (e.g., the first, second, third or fourth event) has been received from lower layers:
      3> start or restart the firstEventInstanceDetectionTimer, secondEventInstance DetectionTimer, thirdEventInstanceDetectionTimer or fourthEventInstance DetectionTimer (higher layer configured respectively for the first, second, third or fourth event-when/if applicable)
      3> increment firstEvent_COUNTER, secondEvent_COUNTER, thirdEvent_COUNTER or fourthEvent_COUNTER (higher layer configured respectively for the first, second, third or fourth event-when/if applicable) by 1;
      3> if firstEvent_COUNTER>=firstEventInstanceMaxCount, secondEvent_COUNTER>=secondEventInstanceMaxCount, thirdEvent_COUNTER>=thirdEventInstanceMaxCount or fourthEvent_COUNTER>=fourthEventInstanceMaxCount (respectively for the first, second, third or fourth event—when/if applicable), wherein the firstEventInstanceMaxCount, secondEventInstanceMaxCount, thirdEventInstanceMaxCount or fourthEventInstanceMaxCount is higher layer configured respectively for the first, second, third or fourth event—when/if applicable:
         4> trigger a UEI (beam) reporting specific to the first, second, third or fourth event-when/if applicable—for this Serving Cell, wherein the report content(s)/quantity(s) in the UEI report(s) is specific to the first, second, third or fourth event—when/if applicable—according to or following those specified herein in the present disclosure.
   2> if the firstEventInstance DetectionTimer, secondEventInstanceDetectionTimer, thirdEventInstance DetectionTimer or fourthEventInstance DetectionTimer (respectively for the first, second, third or fourth event—when/if applicable) expires; or
   2> if the firstEventInstance DetectionTimer, secondEventInstanceDetectionTimer, thirdEventInstance DetectionTimer or fourthEventInstance DetectionTimer (respectively for the first, second, third or fourth event—when/if applicable), firstEvent_COUNTER, secondEvent_COUNTER, thirdEvent_COUNTER or fourthEvent_COUNTER (respectively for the first, second, third or fourth event—when/if applicable), or any of the reference signals used for UEI reporting—e.g., including that/those specific to/for the current serving beam(s) and/or the candidate beam(s) as specified or defined herein in the present disclosure specific to/for the first, second, third or fourth event—is reconfigured by upper layers associated with this Serving Cell; or
   2> if the reference signal(s) associated with this Serving Cell used for detection/declaration/indication for the first, second, third or fourth event as specified/defined herein in the present disclosure is changed and/or reconfigured by upper layers associated with this Serving Cell:
      3> set firstEvent_COUNTER, secondEvent_COUNTER, thirdEvent_COUNTER or fourthEvent_COUNTER (respectively for the first, second, third or fourth event—when/if applicable) to 0; and/or
      3> stop the ueiReportingTimer, if configured; and/or
      3> expect the UE-initiated (UEI) reporting procedure triggered or initiated with respect to the first, second, third or fourth event successfully completed, and/or cancel the UEI report(s) triggered or initiated with respect to the first, second, third or fourth event for this Serving Cell.

The described or specified MAC entity and the corresponding operation(s)/procedure(s) herein are for triggering or initiating one or more UEI report(s) according to or based on detection or declaration of one of the first, second, third and fourth events according to or following those specified herein in the present disclosure. To trigger or initiate a UEI reporting based on or according to detection or declaration of more than one or multiple events—e.g., the third and fourth events—jointly or simultaneously, the corresponding MAC entity—e.g., for the third and fourth events—could or shall for each Serving Cell configured for UEI reporting according to those specified herein in the present disclosure:
1> to initiate or trigger a UEI reporting based on or according to detection or declaration of the third and fourth events, jointly or simultaneously:
   2> if an indication for an instance for the third event has been received from lower layers, and/or if an indication for an instance for the fourth event has been received from lower layers:
      3> start or restart the thirdEventInstanceDetectionTimer and/or fourthEventInstanceDetectionTimer (higher layer configured for the third and/or fourth event(s)—when/if applicable)
      3> increment thirdEvent_COUNTER and/or fourthEvent_COUNTER (higher layer configured for the third and/or fourth event(s)—when/if applicable) by 1;
      3> if both thirdEvent_COUNTER>=thirdEventInstanceMaxCount and fourthEvent_COUNTER>=fourthEventInstanceMaxCount (for the third and fourth events-when/if applicable), wherein the thirdEventInstanceMaxCount and fourthEventInstanceMaxCount are higher layer configured respectively for the third and fourth events-when/if applicable:
         4> trigger a UEI (beam) reporting specific to the third and fourth events for this Serving Cell, wherein the report content(s)/quantity(s) in the UEI report(s) is specific to the third and fourth events-when/if applicable—according to or following those specified herein in the present disclosure.
   2> if the thirdEventInstanceDetectionTimer and/or fourthEventInstanceDetectionTimer (respectively for the third and/or fourth event(s)—when/if applicable) expires; or
   2> if the thirdEventInstanceDetectionTimer and/or fourthEventInstanceDetectionTimer (respectively for the third and/or fourth event(s)—when/if applicable), thirdEvent_COUNTER and/or fourthEvent_COUNTER (respectively for the third and/or fourth event(s)—when/if applicable), or any of the reference signals used for UEI reporting—e.g., including that/those specific to/for the current serving beam(s) and/or the candidate beam(s) as specified or defined herein in the present disclosure for the third and/or fourth event(s)—is reconfigured by upper layers associated with this Serving Cell; or
   2> if the reference signal(s) associated with this Serving Cell used for detection/declaration/indication for the third and/or fourth event(s) as specified/defined herein in the present disclosure is changed and/or reconfigured by upper layers associated with this Serving Cell:
      3> set thirdEvent_COUNTER and/or fourthEvent_COUNTER (respectively for the third and/or fourth event(s)—when/if applicable) to 0; and/or
      3> stop the ueiReportingTimer, if configured; and/or
      3> expect the UE-initiated (UEI) reporting procedure triggered or initiated with respect to both the third and fourth events successfully completed, and/or cancel the UEI report(s) triggered or initiated with respect to the third and fourth events for this Serving Cell.

The described/specified MAC entity(s) and the corresponding operation(s)/procedure(s) herein could be applied or extended to when/if more than two events could be configured and/or enabled by the network and/or applied or used by the UE (e.g., the UE 116) for initiating or triggering the UEI reporting.

In one operation mode (Mode A), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-) type (A) or (report-) type (C) as specified herein in the present disclosure, and/or the (corresponding) UEI report content(s) or report quantity(s)—e.g., of (report-) type (B) or (report-) type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL bandwidth part (BWP) and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window (in symbol, slot, ms, etc.). In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes (e.g., PUCCH resource IDs/indexes, PUCCH resource set IDs/indexes, etc.), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes (e.g., PUCCH resource IDs/indexes, PUCCH resource set IDs/indexes, etc.)—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network (e.g., the network 130), e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or to as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE (e.g., the UE 116) could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH). In this step, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure. For example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. In this case, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type l and/or Type2) for sending the UEI report content(s)/quantity(s) via/in the second UL channel.

The (downlink/uplink) DCI (in Step-2) in response to the transmission of the PN message/trigger in Step-1 could be in various DCI formats including (uplink) DCI format(s) including DCI format(s) 0_0, 0_1, 0_2 and/or 0_3, (downlink) DCI format(s) including DCI format(s) 1_0, 1_1, 1_2 and/or 1_3, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

Throughout the present disclosure, as specified/defined herein in the present disclosure, a PN message/trigger could be or could correspond to or could be in form of a scheduling request (SR) e.g. provided by a SR configuration (SchedulingRequestConfig) associated with a schedulingRequestConfigId or an uplink control information (UCI) parameter/type, and could be used to
request UL resource(s)—e.g., DG based PUSCH resource(s)—of a second UL channel to transmit a beam report which could comprise at least one resource indicator such as SSBRI or CRI and/or a corresponding beam metric such as L1-RSRP or L1-SINR—as in Mode A; and/or
to notify a transmission of a beam report-comprising at least one resource indicator such as SSBRI or CRI and/or a corresponding beam metric such as L1-RSRP or L1-SINR—on one or more (pre-) configured UL resources of a second UL channel—e.g., Type1 CG PUSCH resource(s)—associated to the SR and/or the PUCCH resource of the first UL channel—as in Mode B.

For Mode A (or when the Mode A mentioned herein is enabled, e.g., via higher layer RRC signaling(s)/parameter(s)), according to or following those specified herein in the present disclosure, a UE could be configured or provided or indicated by the network, e.g., via higher layer RRC signaling(s)/parameter(s) and/or MAC CE command(s) and/or dynamic DCI based L1 signaling(s) based on or according to a corresponding UE's capability or capability signaling, one or more of:
A first prohibit timer provided by pn-ProhibitTimer1
A second prohibit timer provided by pn-ProhibitTimer2
A third prohibit timer provided by pn-ProhibitTimer3
A fourth prohibit timer provided by pn-ProhibitTimer4
pn-TransMax
PN-COUNTER

When a PN trigger/message is transmitted, sent or triggered, it could be regarded as pending until it is cancelled. If a PN message/trigger is transmitted, sent or trigger and there are no other PN trigger(s)/message(s) pending corresponding to the same configuration of the PN message/trigger, the MAC entity could set the PN-COUNTER of the corresponding configuration of the PN message/trigger to 0. Furthermore, according to those specified/defined herein in the present disclosure, a UE could send, transmit or trigger a transmission of a first PN message/trigger (of a SR or a UCI as specified/defined herein in the present disclosure, e.g., a 1-bit indicator) on PUCCH resource(s) of the first UL channel as in Step-1, based on or according to detection, declaration or determination of an event (or one or more events if configured/provided/enabled simultaneously or at the same time) based on or according to first evaluation or assessment result(s) of the event (or the one or more events). In addition, the UE could send, transmit or trigger a transmission of a second PN message/trigger (of a SR or a UCI as specified/defined herein in the present disclosure, e.g., a 1-bit indicator) on PUCCH resource(s) of the first UL channel as in Step-1, based on or according to detection, declaration or determination of the (same) event (or the (same) one or more events if configured/provided/enabled simultaneously or at the same time) based on or according to second evaluation or assessment result(s) of the (same) event (or the (same) one or more events). In this case, when/if the first evaluation or assessment result(s) and the second evaluation or assessment result(s) are different according to or based on one or more of (e.g., for the fourth event or Event-4 as specified/defined herein in the present disclosure):
the first evaluation or assessment result(s) for detecting, declaring or determining the event (or the one or more events) and the second evaluation or assessment result(s) for detecting, declaring or determining the (same) event (or the (same) one or more events) could comprise at least one different candidate/new beam (and therefore, the corresponding candidate/new beam RS/RS resource) that satisfies or achieves the event(s) condition(s) according to or following those specified herein in the present disclosure;
the candidate/new beam(s)—and therefore, the corresponding candidate/new beam RS(s)/RS resource(s)—comprised, identified or determined in/by the first evaluation or assessment result(s) for detecting, declaring or determining the event (or the one or more events) and the candidate/new beam(s)—and therefore, the corresponding candidate/new beam RS(s)/RS resource(s)—comprised, identified or determined in/by the second evaluation or assessment result(s) for detecting, declaring or determining the (same) event (or the (same) one or more events) could be different or could be different;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing different or separate (sets of) candidate/new beam RSs or RS resource(s) according to or following those specified herein in the present disclosure;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing different or separate current serving beam RSs/RS resources (e.g., determined or identified according to or based on different indicated TCI states) according to or following those specified herein in the present disclosure;
at least one of the condition(s) to detect, declare or determine the event (or the one or more events) that triggers the transmission of the first PN message/trigger could be different from that/those used/applied to detect, declare or determine the event (or the one or more events) that triggers the transmission of the second PN message/trigger;
The condition(s) to detect, declare or determine the event (or the one or more events) that triggers the transmission of the first PN message/trigger could be different from that/those used/applied to detect, declare or determine the event (or the one or more events) that triggers the transmission of the second PN message/trigger;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by comparing measurement result(s) e.g. L1-RSRP(s) of the current serving beam RS(s)/RS resources (e.g., determined or identified according to or based on the indicated TCI state(s)) and the measurement result(s) e.g. L1-RSRP(s) of the candidate/new beam RS(s) or RS resource(s) with different thresholds according to or following those specified herein in the present disclosure,
   the first PN message/trigger and the second PN message/trigger could be referred to as different versions of a PN message/trigger, or the first (or second) PN message/trigger could be a PN message/trigger of a different version from the second (or first) PN message/trigger. Otherwise, i.e., when/if the first evaluation or assessment result(s) and the second evaluation or assessment result(s) are different according to or based on one or more of (e.g., for the fourth event or Event-4 as specified/defined herein in the present disclosure):
the first evaluation or assessment result(s) for detecting, declaring or determining the event (or the one or more events) and the second evaluation or assessment result(s) for detecting, declaring or determining the (same) event (or the (same) one or more events) could comprise at least one same or identical candidate/new beam (and therefore, the corresponding candidate/new beam RS/RS resource) that satisfies or achieves the event(s) condition(s) according to or following those specified herein in the present disclosure;
the candidate/new beam(s)—and therefore, the corresponding candidate/new beam RS(s)/RS resource(s)—comprised, identified or determined in/by the first evaluation or assessment result(s) for detecting, declaring or determining the event (or the one or more events) and the candidate/new beam(s)—and therefore, the corresponding candidate/new beam RS(s)/RS resource(s)—comprised, identified or determined in/by the second evaluation or assessment result(s) for detecting, declaring or determining the (same) event (or the (same) one or more events) could be the same or identical or could be the same or identical;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing the same/identical (set of) candidate/new beam RSs or RS resource(s) according to or following those specified herein in the present disclosure;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing a same/identical current serving beam RS/RS resource (e.g., determined or identified according to or based on a same/identical indicated TCI state) according to or following those specified herein in the present disclosure;
at least one of the condition(s) to detect, declare or determine the event (or the one or more events) that triggers the transmission of the first PN message/trigger could be the same as or identical to that/those used/applied to detect, declare or determine the event (or the one or more events) that triggers the transmission of the second PN message/trigger;
The condition(s) to detect, declare or determine the event (or the one or more events) that triggers the transmission of the first PN message/trigger could be the same as or identical to that/those used/applied to detect, declare or determine the event (or the one or more events) that triggers the transmission of the second PN message/trigger;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by comparing measurement result(s) e.g. L1-RSRP(s) of the current serving beam RS(s)/RS resources (e.g., determined or identified according to or based on the indicated TCI state(s)) and the measurement result(s) e.g. L1-RSRP(s) of the candidate/new beam RS(s) or RS resource(s) with a same/identical threshold according to or following those specified herein in the present disclosure,
   the first PN message/trigger and the second PN message/trigger could be referred to as a/the same or identical version of a PN message/trigger, or the first (or second) PN message/trigger could be a PN message/trigger of a/the same or identical version as/to the second (or first) PN message/trigger. That is, the first (or second) PN message/trigger could be a re-transmission of the second (or first) PN message/trigger, when/if the first (or second) PN message/trigger is the initial transmission of the PN message/trigger in time or could correspond to a/the initial PN message/trigger.

In particular, after the UE has sent or transmitted to the network, an initial PN message/trigger (of a SR or a UCI as specified/defined herein in the present disclosure, e.g., a 1-bit indicator) on PUCCH resource(s) of the first UL channel as in Step-1, the UE could start the first prohibit timer pn-ProhibitTimer1 from or X1 symbol(s)/slot(s)/etc. after the first (or last) symbol/slot/etc. of the transmission of the initial PN message/trigger, wherein the UE could determine or identity the value of X1 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. The following UE's behaviors and/or operations could be based on or according to at least: (i) when/if (e.g., higher layer(s) of) the UE has determined, detected or declared at least one event (or has been determining, detecting or declaring the at least one event) according to or following those specified/defined herein in the present disclosure—or the event(s) triggering condition(s) has been met or achieved or satisfied, and/or (2) the at least one event that is (being) detected, declared or determined could be associated to the CSI reporting setting provided by CSI-ReportConfig/UEI-ReportConfig that provides or configures necessary information and/or setting(s)—e.g., enabling the at least one event and/or providing/configuring type(s) of the at least one event—for the UE-initiated beam reporting according to or following those specified herein in the present disclosure.
When the first prohibit timer pn-ProhibitTimer1 is running, the UE is not allowed to send, transmit or trigger any PN message(s)/trigger(s)—e.g., of the same/identical version as/to the initial PN message/trigger as specified/defined herein in the present disclosure—on PUCCH resource(s) of the first UL channel as in Step-1 according to or following those specified herein in the present disclosure; in this case, the UE may still be able or allowed to send, transmit or trigger PN message(s)/trigger(s)—e.g., of different version(s) from the initial PN message/trigger as specified/defined herein in the present disclosure-on PUCCH resource(s) of the first UL channel as in Step-1 according to or following those specified herein in the present disclosure. That is, when the first prohibit timer pn-ProhibitTimer1 is not running, the UE is able or allowed to send, transmit or trigger any PN message(s)/trigger(s)—e.g., of the same/identical version as/to and/or different version(s) from the initial PN message/trigger as specified/defined herein in the present disclosure-on PUCCH resource(s) of the first UL channel as in Step-1 according to or following those specified herein in the present disclosure.
(Higher layer(s) of) the UE could stop or not run the first prohibit timer pn-ProhibitTimer1 (pending PN message(s)/trigger(s) could be cancelled) only when/if the first prohibit timer pn-ProhibitTimer1 expires or has expired.
(Higher layer(s) of) the UE could stop or not run the first prohibit timer pn-ProhibitTimer1 (pending PN message(s)/trigger(s) could be cancelled) according to or based on one or more of, and/or (higher layer(s) of) the UE could still run the first prohibit timer pn-ProhibitTimer1 (i.e., not stopped or expired), but the UE may still be able or allowed to send, transmit or trigger PN message(s)/trigger(s)—e.g., of the same/identical version as/to and/or different version(s) from the initial PN message/trigger as specified/defined herein in the present disclosure-on PUCCH resource(s) of the first UL channel as in Step-1 according to or following those specified herein in the present disclosure according to or based on one or more of:
   When/if or after the first prohibit timer pn-ProhibitTimer1 expires or has expired;
   When/if or after the UE has received the (downlink/uplink) DCI in response to the (initial) PN message/trigger transmitted/sent in Step-1 that provides an UL grant for transmitting the beam report(s); e.g., (higher layer(s) of) the UE could stop the first prohibit timer pn-ProhibitTimer1, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y1 symbol(s)/slot(s)/etc. after the first (or last) symbol/slot/etc. of the reception of the PDCCH candidate(s) that carries or conveys the (downlink/uplink) DCI, wherein the UE could determine or identity the value of Y1 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after the UE has received the (downlink/uplink) DCI in response to the (initial) PN message/trigger transmitted/sent in Step-1 that provides an UL grant for transmitting the beam report(s), and the UL grant can accommodate pending UEI beam report(s)—including corresponding report quantity(s)—and/or data available for transmission; e.g., (higher layer(s) of) the UE could stop the first prohibit timer pn-ProhibitTimer1, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure-on PUCCH resource(s) of the first UL channel as in Step-1 according to or following those specified herein, starting from or Y1 symbol(s)/slot(s)/etc. after the first (or last) symbol/slot/etc. of the reception of the PDCCH candidate(s) that carries or conveys the (downlink/uplink) DCI, wherein the UE could determine or identity the value of Y1 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after the UE has transmitted or sent, on the (dynamically) granted, scheduled, assigned or allocated PUSCH resource(s) of the second UL channel as in Step-3, the UEI beam report including the corresponding report content(s)/quantity(s) as specified/defined herein in the present disclosure associated/specific to the (initial) PN message/trigger transmitted or sent via/in the first UL channel in Step-1 as defined/specified herein in the present disclosure; e.g., (higher layer(s) of) the UE could stop the first prohibit timer pn-ProhibitTimer1, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure-on PUCCH resource(s) of the first UL channel as in Step-1 according to or following those specified herein, starting from or Y2 symbol(s)/slot(s)/etc. after the first (or last) symbol/slot/etc. of the transmission of the PUSCH resource(s) of the second UL channel that carries or conveys the UEI beam report, wherein the UE could determine or identity the value of Y2 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after the UE (e.g., the UE 116) has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-3; e.g., (higher layer(s) of) the UE could stop the first prohibit timer pn-ProhibitTimer1, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure-on PUCCH resource(s) of the first UL channel as in Step-1 according to or following those specified herein, starting from or Y3 symbol(s)/slot(s)/etc. after the first (or last) symbol/slot/etc. of the reception of the PDCCH candidate(s) that carries or conveys the beam indication DCI, and/or the reception of PDSCH that carries or conveys the (unified) TCI state(s) activation/deactivation MAC CE, wherein the UE could determine or identity the value of Y3 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-3, and the one or more TCI states/TCI state updates/activated TCI states/TCI codepoints have become applicable; e.g., (higher layer(s) of) the UE could stop the first prohibit timer pn-ProhibitTimer1, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y4 symbol(s)/slot(s)/etc. after the first (or last) symbol/slot/etc. of when the received, indicated, provided or activated one or more TCI states/TCI state updates/activated TCI states/TCI codepoints have become applicable, wherein the UE could determine or identity the value of Y4 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE has reset the event(s) evaluation, assessment, detection, declaration and/or determination process (e.g., by resetting the counting(s) of the instance(s) of the event(s) and/or the time window/time gap/time offset/timer for counting of the instance(s) of the event(s)); e.g., (higher layer(s) of) the UE could stop the first prohibit timer pn-ProhibitTimer1, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y5 symbol(s)/slot(s)/etc. after resetting or the first (or last) symbol/slot/etc. of resetting the event(s) evaluation, assessment, detection, declaration and/or determination process as specified/defined herein in the present disclosure, wherein the UE could determine or identity the value of Y5 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE could have determined or identified or triggered a transmission of a PN message/trigger of a different version from the initial PN message/trigger according to or following those specified herein in the present disclosure; e.g., (higher layer(s) of) the UE could stop the first prohibit timer pn-ProhibitTimer1, and/or still run the first prohibit timer pn-ProhibitTimer1 but send, transmit or trigger the transmission of the PN message/trigger that is of a different version from the initial PN message/trigger and/or PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y6 symbol(s)/slot(s)/etc. after determining, identifying or triggering a transmission of, or the first (or last) symbol/slot/etc. of determining, identifying or triggering a transmission of the PN message/trigger that is of a different version from the initial PN message/trigger as specified/defined herein in the present disclosure, wherein the UE could determine or identity the value of Y6 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

After the UE has received the (downlink/uplink) DCI in response to the (initial) PN message/trigger transmitted/sent in Step-1 that provides an UL grant for transmitting the beam report(s), and/or after the UE has received the (downlink/uplink) DCI in response to the (initial) PN message/trigger transmitted/sent in Step-1 that provides an UL grant for transmitting the beam report(s) and the UL grant can accommodate pending UEI beam report(s)—including corresponding report quantity(s)—and/or data available for transmission, the UE could start the second prohibit timer pn-ProhibitTimer2 from or X2 symbol(s)/slot(s)/etc. after the first (or last) symbol/slot/etc. of the reception of the PDCCH candidate(s) that carries or conveys the (downlink/uplink) DCI, wherein the UE could determine or identity the value of X2 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The following UE's behaviors and/or operations could be based on or according to at least: (i) when/if (e.g., higher layer(s) of) the UE has determined, detected or declared at least one event (or has been determining, detecting or declaring the at least one event) according to or following those specified/defined herein in the present disclosure—or the event(s) triggering condition(s) has been met or achieved or satisfied, and/or (2) the at least one event that is (being) detected, declared or determined could be associated to the CSI reporting setting provided by CSI-ReportConfig/UEI-ReportConfig that provides or configures necessary information and/or setting(s)—e.g., enabling the at least one event and/or providing/configuring type(s) of the at least one event—for the UE-initiated beam reporting according to or following those specified herein in the present disclosure.
When the second prohibit timer pn-ProhibitTimer2 is running, the UE is not allowed to send, transmit or trigger any PN message(s)/trigger(s)—e.g., of the same/identical version as/to the initial PN message/trigger as specified/defined herein in the present disclosure—on PUCCH resource(s) of the first UL channel as in Step-1 according to or following those specified herein in the present disclosure; in this case, the UE may still be able or allowed to send, transmit or trigger PN message(s)/trigger(s)—e.g., of different version(s) from the initial PN message/trigger as specified/defined herein in the present disclosure—on PUCCH resource(s) of the first UL channel as in Step-1 according to or following those specified herein in the present disclosure. That is, when the second prohibit timer pn-ProhibitTimer2 is not running, the UE is able or allowed to send, transmit or trigger any PN message(s)/trigger(s)—e.g., of the same/identical version as/to and/or different version(s) from the initial PN message/trigger as specified/defined herein in the present disclosure-on PUCCH resource(s) of the first UL channel as in Step-1 according to or following those specified herein in the present disclosure.
(Higher layer(s) of) the UE could stop or not run the second prohibit timer pn-ProhibitTimer2 (pending PN message(s)/trigger(s) could be cancelled) only when/if the second prohibit timer pn-ProhibitTimer2 expires or has expired.
(Higher layer(s) of) the UE could stop or not run the second prohibit timer pn-ProhibitTimer2 (pending PN message(s)/trigger(s) could be cancelled) according to or based on one or more of, and/or (higher layer(s) of) the UE could still run the second prohibit timer pn-ProhibitTimer2 (i.e., not stopped or expired), but the UE may still be able or allowed to send, transmit or trigger PN message(s)/trigger(s)—e.g., of the same/identical version as/to and/or different version(s) from the initial PN message/trigger as specified/defined herein in the present disclosure-on PUCCH resource(s) of the first UL channel as in Step-1 according to or following those specified herein in the present disclosure according to or based on one or more of:
   When/if or after the second prohibit timer pn-ProhibitTimer2 expires or has expired;
   When/if or after the UE has transmitted or sent, on the (dynamically) granted, scheduled, assigned or allocated PUSCH resource(s) of the second UL channel as in Step-3, the UEI beam report including the corresponding report content(s)/quantity(s) as specified/defined herein in the present disclosure associated/specific to the (initial) PN message/trigger transmitted or sent via/in the first UL channel in Step-1 as defined/specified herein in the present disclosure; e.g., (higher layer(s) of) the UE could stop the second prohibit timer pn-ProhibitTimer2, and/or still run the second prohibit timer pn-ProhibitTimer2 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y2 symbol(s)/slot(s)/etc. after the first (or last) symbol/slot/etc. of the transmission of the PUSCH resource(s) of the second UL channel that carries or conveys the UEI beam report, wherein the UE could determine or identity the value of Y2 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-3; e.g., (higher layer(s) of) the UE could stop the second prohibit timer pn-ProhibitTimer2, and/or still run the second prohibit timer pn-ProhibitTimer2 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y3 symbol(s)/slot(s)/etc. after the first (or last) symbol/slot/etc. of the reception of the PDCCH candidate(s) that carries or conveys the beam indication DCI, and/or the reception of PDSCH that carries or conveys the (unified) TCI state(s) activation/deactivation MAC CE, wherein the UE could determine or identity the value of Y3 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-3, and the one or more TCI states/TCI state updates/activated TCI states/TCI codepoints have become applicable; e.g., (higher layer(s) of) the UE could stop the second prohibit timer pn-ProhibitTimer2, and/or still run the second prohibit timer pn-ProhibitTimer2 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y4 symbol(s)/slot(s)/etc. after the first (or last) symbol/slot/etc. of when the received, indicated, provided or activated one or more TCI states/TCI state updates/activated TCI states/TCI codepoints have become applicable, wherein the UE could determine or identity the value of Y4 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE has reset the event(s) evaluation, assessment, detection, declaration and/or determination process (e.g., by resetting the counting(s) of the instance(s) of the event(s) and/or the time window/time gap/time offset/timer for counting of the instance(s) of the event(s)); e.g., (higher layer(s) of) the UE could stop the second prohibit timer pn-ProhibitTimer2, and/or still run the second prohibit timer pn-ProhibitTimer2 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y5 symbol(s)/slot(s)/etc. after resetting or the first (or last) symbol/slot/etc. of resetting the event(s) evaluation, assessment, detection, declaration and/or determination process as specified/defined herein in the present disclosure, wherein the UE could determine or identity the value of Y5 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE could have determined or identified or triggered a transmission of a PN message/trigger of a different version from the initial PN message/trigger according to or following those specified herein in the present disclosure; e.g., (higher layer(s) of) the UE could stop the second prohibit timer pn-ProhibitTimer2, and/or still run the second prohibit timer pn-ProhibitTimer2 but send, transmit or trigger the transmission of the PN message/trigger that is of a different version from the initial PN message/trigger and/or PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y6 symbol(s)/slot(s)/etc. after determining, identifying or triggering a transmission of, or after the first (or last) symbol/slot/etc. of determining, identifying or triggering a transmission of the PN message/trigger that is of a different version from the initial PN message/trigger as specified/defined herein in the present disclosure, wherein the UE could determine or identity the value of Y6 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

After the UE has transmitted or sent, on the (dynamically) granted, scheduled, assigned or allocated PUSCH resource(s) of the second UL channel as in Step-3, the UEI beam report including the corresponding report content(s)/quantity(s) as specified/defined herein in the present disclosure associated/specific to the (initial) PN message/trigger transmitted or sent via/in the first UL channel in Step-1 as defined/specified herein in the present disclosure, the UE could start the third prohibit timer pn-ProhibitTimer3 from or X3 symbol(s)/slot(s)/etc. after the first (or last) symbol/slot/etc. of the transmission of the PUSCH resource(s) of the second UL channel that carries or conveys the UEI beam report, wherein the UE could determine or identity the value of X3 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network (e.g., the network 130) via various UL channels/signals and/or in part of a CSI/beam report and/or UE's capability signaling. The following UE's behaviors and/or operations could be based on or according to at least: (i) when/if (e.g., higher layer(s) of) the UE has determined, detected or declared at least one event (or has been determining, detecting or declaring the at least one event) according to or following those specified/defined herein in the present disclosure, and/or (2) the at least one event that is (being) detected, declared or determined could be associated to the CSI reporting setting provided by CSI-ReportConfig/UEI-ReportConfig that provides or configures necessary information and/or setting(s)—e.g., enabling the at least one event and/or providing/configuring type(s) of the at least one event—for the UE-initiated beam reporting according to or following those specified herein in the present disclosure.
When the third prohibit timer pn-ProhibitTimer3 is running, the UE is not allowed to send, transmit or trigger any PN message(s)/trigger(s)—e.g., of the same/identical version as/to the initial PN message/trigger as specified/defined herein in the present disclosure—on PUCCH resource(s) of the first UL channel as in Step-1 according to or following those specified herein in the present disclosure; in this case, the UE may still be able or allowed to send, transmit or trigger PN message(s)/trigger(s)—e.g., of different version(s) from the initial PN message/trigger as specified/defined herein in the present disclosure—on PUCCH resource(s) of the first UL channel as in Step-1 according to or following those specified herein in the present disclosure. That is, when the third prohibit timer pn-ProhibitTimer3 is not running, the UE is able or allowed to send, transmit or trigger any PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure.
(Higher layer(s) of) the UE could stop or not run the third prohibit timer pn-ProhibitTimer3 (pending PN message(s)/trigger(s) could be cancelled) only when/if the third prohibit timer pn-ProhibitTimer3 expires or has expired.
(Higher layer(s) of) the UE could stop or not run the third prohibit timer pn-ProhibitTimer3 (pending PN message(s)/trigger(s) could be cancelled) according to or based on one or more of, and/or (higher layer(s) of) the UE could still run the third prohibit timer pn-ProhibitTimer3 (i.e., not stopped or expired), but the UE may still be able or allowed to send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure according to or based on one or more of:
   When/if or after the third prohibit timer pn-ProhibitTimer3 expires or has expired;
   When/if or after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-3; e.g., (higher layer(s) of) the UE could stop the third prohibit timer pn-ProhibitTimer3, and/or still run the third prohibit timer pn-ProhibitTimer3 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y4 symbol(s)/slot(s)/etc. after the first (or last) symbol/slot/etc. of the reception of the PDCCH candidate(s) that carries or conveys the beam indication DCI, and/or the reception of PDSCH that carries or conveys the (unified) TCI state(s) activation/deactivation MAC CE, wherein the UE could determine or identity the value of Y4 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-3, and the one or more TCI states/TCI state updates/activated TCI states/TCI codepoints have become applicable; e.g., (higher layer(s) of) the UE could stop the third prohibit timer pn-ProhibitTimer3, and/or still run the third prohibit timer pn-ProhibitTimer3 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y4 symbol(s)/slot(s)/etc. after the first (or last) symbol/slot/etc. of when the received, indicated, provided or activated one or more TCI states/TCI state updates/activated TCI states/TCI codepoints have become applicable, wherein the UE could determine or identity the value of Y4 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE has reset the event(s) evaluation, assessment, detection, declaration and/or determination process (e.g., by resetting the counting(s) of the instance(s) of the event(s) and/or the time window/time gap/time offset/timer for counting of the instance(s) of the event(s)); e.g., (higher layer(s) of) the UE could stop the third prohibit timer pn-ProhibitTimer3, and/or still run the third prohibit timer pn-ProhibitTimer3 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y5 symbol(s)/slot(s)/etc. after resetting or the first (or last) symbol/slot/etc. of resetting the event(s) evaluation, assessment, detection, declaration and/or determination process as specified/defined herein in the present disclosure, wherein the UE could determine or identity the value of Y5 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE (e.g., the UE 116) could have determined or identified or triggered a transmission of a PN message/trigger of a different version from the initial PN message/trigger according to or following those specified herein in the present disclosure; e.g., (higher layer(s) of) the UE could stop the third prohibit timer pn-ProhibitTimer3, and/or still run the third prohibit timer pn-ProhibitTimer3 but send, transmit or trigger the transmission of the PN message/trigger that is of a different version from the initial PN message/trigger and/or PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y6 symbol(s)/slot(s)/etc. after determining, identifying or triggering a transmission of, or the first (or last) symbol/slot/etc. of determining, identifying or triggering a transmission of the PN message/trigger that is of a different version from the initial PN message/trigger as specified/defined herein in the present disclosure, wherein the UE could determine or identity the value of Y6 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Optionally, after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-3, and/or after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-3 and the one or more TCI states/TCI state updates/activated TCI states/TCI codepoints have become applicable, the UE could start the fourth prohibit timer pn-ProhibitTimer4 from or X4 symbol(s)/slot(s)/etc. after the first (or last) symbol/slot/etc. of the reception of the PDCCH candidate(s) that carries or conveys the beam indication DCI, and/or after the reception of PDSCH that carries or conveys the (unified) TCI state(s) activation/deactivation MAC CE, and/or after the first (or last) symbol/slot/etc. of when the received, indicated, provided or activated one or more TCI states/TCI state updates/activated TCI states/TCI codepoints have become applicable, wherein the UE could determine or identity the value of X4 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The following UE's behaviors and/or operations could be based on or according to at least: (i) when/if (e.g., higher layer(s) of) the UE has determined, detected or declared at least one event (or has been determining, detecting or declaring the at least one event) according to or following those specified/defined herein in the present disclosure, and/or (2) the at least one event that is (being) detected, declared or determined could be associated to the CSI reporting setting provided by CSI-ReportConfig/UEI-ReportConfig that provides or configures necessary information and/or setting(s)—e.g., enabling the at least one event and/or providing/configuring type(s) of the at least one event—for the UE-initiated beam reporting according to or following those specified herein in the present disclosure.
When the fourth prohibit timer pn-ProhibitTimer4 is running, the UE is not allowed to send, transmit or trigger any PN message(s)/trigger(s)—e.g., of the same/identical version as/to the initial PN message/trigger as specified/defined herein in the present disclosure—on PUCCH resource(s) of the first UL channel as in Step-1 according to or following those specified herein in the present disclosure; in this case, the UE may still be able or allowed to send, transmit or trigger PN message(s)/trigger(s)—e.g., of different version(s) from the initial PN message/trigger as specified/defined herein in the present disclosure—on PUCCH resource(s) of the first UL channel as in Step-1 according to or following those specified herein in the present disclosure. That is, when the fourth prohibit timer pn-ProhibitTimer4 is not running, the UE is able or allowed to send, transmit or trigger any PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure.
(Higher layer(s) of) the UE could stop or not run the fourth prohibit timer pn-ProhibitTimer4 (pending PN message(s)/trigger(s) could be cancelled) only when/if the fourth prohibit timer pn-ProhibitTimer4 expires or has expired.
(Higher layer(s) of) the UE could stop or not run the fourth prohibit timer pn-ProhibitTimer4 (pending PN message(s)/trigger(s) could be cancelled) according to or based on one or more of, and/or (higher layer(s) of) the UE could still run the fourth prohibit timer pn-ProhibitTimer4 (i.e., not stopped or expired), but the UE may still be able or allowed to send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure according to or based on one or more of:
   When/if or after the fourth prohibit timer pn-ProhibitTimer4 expires or has expired;
   When/if or after (higher layer(s) of) the UE has reset the event(s) evaluation, assessment, detection, declaration and/or determination process (e.g., by resetting the counting(s) of the instance(s) of the event(s) and/or the time window/time gap/time offset/timer for counting of the instance(s) of the event(s)); e.g., (higher layer(s) of) the UE could stop the fourth prohibit timer pn-ProhibitTimer4, and/or still run the fourth prohibit timer pn-ProhibitTimer4 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y5 symbol(s)/slot(s)/etc. after resetting or the first (or last) symbol/slot/etc. of resetting the event(s) evaluation, assessment, detection, declaration and/or determination process as specified/defined herein in the present disclosure, wherein the UE could determine or identity the value of Y5 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE could have determined or identified or triggered a transmission of a PN message/trigger of a different version from the initial PN message/trigger according to or following those specified herein in the present disclosure; e.g., (higher layer(s) of) the UE could stop the fourth prohibit timer pn-ProhibitTimer4, and/or still run the fourth prohibit timer pn-ProhibitTimer4 but send, transmit or trigger the transmission of the PN message/trigger that is of a different version from the initial PN message/trigger and/or PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y6 symbol(s)/slot(s)/etc. after determining, identifying or triggering a transmission of, or the first (or last) symbol/slot/etc. of determining, identifying or triggering a transmission of the PN message/trigger that is of a different version from the initial PN message/trigger as specified/defined herein in the present disclosure, wherein the UE could determine or identity the value of Y6 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified herein in the present disclosure, (higher layer(s) of) the UE could simultaneously (or at the same time) run one or more of the first prohibit timer pn-ProhibitTimer1, the second prohibit timer pn-ProhibitTimer2, the third prohibit timer pn-ProhibitTimer3 and the fourth prohibit timer pn-ProhibitTimer4, if configured, in parallel. Furthermore, the UE could be provided or configured by the network, in a/the (same) configuration e.g. via/in RRC signaling(s)/parameter(s), one or more of the first prohibit timer pn-ProhibitTimer1, the second prohibit timer pn-ProhibitTimer2, the third prohibit timer pn-ProhibitTimer3 and the fourth prohibit timer pn-ProhibitTimer4. The value(s)/parameter(s) of the first prohibit timer pn-ProhibitTimer1, and/or the second prohibit timer pn-ProhibitTimer2, and/or the third prohibit timer pn-ProhibitTimer3, and/or the fourth prohibit timer pn-ProhibitTimer4 could be the same or different/separate. In additional, the value(s) of the first prohibit timer pn-ProhibitTimer1 (e.g., higher layer configured), and/or the second prohibit timer pn-ProhibitTimer2 (e.g., higher layer configured), and/or the third prohibit timer pn-ProhibitTimer3 (e.g., higher layer configured), and/or the fourth prohibit timer pn-ProhibitTimer4 (e.g., higher layer configured) could be zero(s), which could be equivalent to that the corresponding prohibit timer(s) is not running, or is stopped, or is expired. Alternatively, (the value(s) of) the first prohibit timer pn-ProhibitTimer1, and/or the second prohibit timer pn-ProhibitTimer2, and/or the third prohibit timer pn-ProhibitTimer3, and/or the fourth prohibit timer pn-ProhibitTimer4 may not be provided or configured by the network, e.g., absent or not present/provided/configured in/by the corresponding higher layer RRC signaling(s)/parameter(s) e.g. CSI-ReportConfig(s)/UEI-ReportConfig(s) that provides or configures the CSI reporting setting(s) that provides, configures or comprises necessary information and/or setting(s) for the UEI beam reporting; in this case, the UE could expect the value(s) of the first prohibit timer pn-ProhibitTimer1, and/or the second prohibit timer pn-ProhibitTimer2, and/or the third prohibit timer pn-ProhibitTimer3, and/or the fourth prohibit timer pn-ProhibitTimer4 as zero(s), which could be equivalent to that the corresponding prohibit timer(s) is not running, or is stopped, or is expired.

In one operation mode (Mode B), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-) type (A) or (report-) type (C) as specified herein in the present disclosure, and/or the (corresponding) UEI report content(s) or report quantity(s)—e.g., of (report-) type (B) or (report-) type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value ms1 corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2); the UE could determine or identify the resource(s) for the second UL channel according to one or more of:
   In one example, the UE could transmit or send to the network-via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network (e.g., the network 130) for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

For Mode B (or when the Mode B mentioned herein is enabled, e.g., via higher layer RRC signaling(s)/parameter(s)), according to or following those specified herein in the present disclosure, a UE could be configured or provided or indicated by the network, e.g., via higher layer RRC signaling(s)/parameter(s) and/or MAC CE command(s) and/or dynamic DCI based L1 signaling(s) based on or according to a corresponding UE's capability or capability signaling, one or more of:
A first prohibit timer provided by pn-ProhibitTimer1
A second prohibit timer provided by pn-ProhibitTimer2
A third prohibit timer provided by pn-ProhibitTimer3
pn-TransMax
PN-COUNTER

When a PN trigger/message is transmitted, sent or triggered, it could be regarded as pending until it is cancelled. If a PN message/trigger is transmitted, sent or trigger and there are no other PN trigger(s)/message(s) pending corresponding to the same configuration of the PN message/trigger, the MAC entity could set the PN-COUNTER of the corresponding configuration of the PN message/trigger to 0. Furthermore, according to those specified/defined herein in the present disclosure, a UE could send, transmit or trigger a transmission of a first PN message/trigger (of a SR or a UCI as specified/defined herein in the present disclosure, e.g., a 1-bit indicator) on PUCCH resource(s) of the first UL channel as in Step-1, based on or according to detection, declaration or determination of an event (or one or more events if configured/provided/enabled simultaneously or at the same time) based on or according to first evaluation or assessment result(s) of the event (or the one or more events). In addition, the UE could send, transmit or trigger a transmission of a second PN message/trigger (of a SR or a UCI as specified/defined herein in the present disclosure, e.g., a 1-bit indicator) on PUCCH resource(s) of the first UL channel as in Step-1, based on or according to detection, declaration or determination of the (same) event (or the (same) one or more events if configured/provided/enabled simultaneously or at the same time) based on or according to second evaluation or assessment result(s) of the (same) event (or the (same) one or more events). In this case, when/if the first evaluation or assessment result(s) and the second evaluation or assessment result(s) are different according to or based on one or more of (e.g., for the fourth event or Event-4 as specified/defined herein in the present disclosure):
the first evaluation or assessment result(s) for detecting, declaring or determining the event (or the one or more events) and the second evaluation or assessment result(s) for detecting, declaring or determining the (same) event (or the (same) one or more events) could comprise at least one different candidate/new beam (and therefore, the corresponding candidate/new beam RS/RS resource) that satisfies or achieves the event(s) condition(s) according to or following those specified herein in the present disclosure;
the candidate/new beam(s)—and therefore, the corresponding candidate/new beam RS(s)/RS resource(s)—comprised, identified or determined in/by the first evaluation or assessment result(s) for detecting, declaring or determining the event (or the one or more events) and the candidate/new beam(s)—and therefore, the corresponding candidate/new beam RS(s)/RS resource(s)—comprised, identified or determined in/by the second evaluation or assessment result(s) for detecting, declaring or determining the (same) event (or the (same) one or more events) could be different or could be different;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing different or separate (sets of) candidate/new beam RSs or RS resource(s) according to or following those specified herein in the present disclosure;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing different or separate current serving beam RSs/RS resources (e.g., determined or identified according to or based on different indicated TCI states) according to or following those specified herein in the present disclosure;
at least one of the condition(s) to detect, declare or determine the event (or the one or more events) that triggers the transmission of the first PN message/trigger could be different from that/those used/applied to detect, declare or determine the event (or the one or more events) that triggers the transmission of the second PN message/trigger;
The condition(s) to detect, declare or determine the event (or the one or more events) that triggers the transmission of the first PN message/trigger could be different from that/those used/applied to detect, declare or determine the event (or the one or more events) that triggers the transmission of the second PN message/trigger;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by comparing measurement result(s) e.g. L1-RSRP(s) of the current serving beam RS(s)/RS resources (e.g., determined or identified according to or based on the indicated TCI state(s)) and the measurement result(s) e.g. L1-RSRP(s) of the candidate/new beam RS(s) or RS resource(s) with different thresholds according to or following those specified herein in the present disclosure,
   the first PN message/trigger and the second PN message/trigger could be referred to as different versions of a PN message/trigger, or the first (or second) PN message/trigger could be a PN message/trigger of a different version from the second (or first) PN message/trigger. Otherwise, i.e., when/if the first evaluation or assessment result(s) and the second evaluation or assessment result(s) are different according to or based on one or more of (e.g., for the fourth event or Event-4 as specified/defined herein in the present disclosure):
the first evaluation or assessment result(s) for detecting, declaring or determining the event (or the one or more events) and the second evaluation or assessment result(s) for detecting, declaring or determining the (same) event (or the (same) one or more events) could comprise at least one same or identical candidate/new beam (and therefore, the corresponding candidate/new beam RS/RS resource) that satisfies or achieves the event(s) condition(s) according to or following those specified herein in the present disclosure;
the candidate/new beam(s)—and therefore, the corresponding candidate/new beam RS(s)/RS resource(s)—comprised, identified or determined in/by the first evaluation or assessment result(s) for detecting, declaring or determining the event (or the one or more events) and the candidate/new beam(s)—and therefore, the corresponding candidate/new beam RS(s)/RS resource(s)—comprised, identified or determined in/by the second evaluation or assessment result(s) for detecting, declaring or determining the (same) event (or the (same) one or more events) could be the same or identical or could be the same or identical;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing the same/identical (set of) candidate/new beam RSs or RS resource(s) according to or following those specified herein in the present disclosure;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by evaluating, measuring or assessing a same/identical current serving beam RS/RS resource (e.g., determined or identified according to or based on a same/identical indicated TCI state) according to or following those specified herein in the present disclosure;
at least one of the condition(s) to detect, declare or determine the event (or the one or more events) that triggers the transmission of the first PN message/trigger could be the same as or identical to that/those used/applied to detect, declare or determine the event (or the one or more events) that triggers the transmission of the second PN message/trigger;
The condition(s) to detect, declare or determine the event (or the one or more events) that triggers the transmission of the first PN message/trigger could be the same as or identical to that/those used/applied to detect, declare or determine the event (or the one or more events) that triggers the transmission of the second PN message/trigger;
the first evaluation or assessment result(s) for detecting, declaring or determining the event (or the one or more events) and the second evaluation or assessment result(s) for detecting, declaring or determining the (same) event (or the (same) one or more events) could be based on or according to or obtained by comparing measurement result(s) e.g. L1-RSRP(s) of the current serving beam RS(s)/RS resources (e.g., determined or identified according to or based on the indicated TCI state(s)) and the measurement result(s) e.g. L1-RSRP(s) of the candidate/new beam RS(s) or RS resource(s) with a same/identical threshold according to or following those specified herein in the present disclosure,
   the first PN message/trigger and the second PN message/trigger could be referred to as a/the same or identical version of a PN message/trigger, or the first (or second) PN message/trigger could be a PN message/trigger of a/the same or identical version as/to the second (or first) PN message/trigger. That is, the first (or second) PN message/trigger could be a re-transmission of the second (or first) PN message/trigger, when/if the first (or second) PN message/trigger is the initial transmission of the PN message/trigger in time or could correspond to a/the initial PN message/trigger.

In particular, after the UE (e.g., the UE 116) has sent or transmitted to the network, an initial PN message/trigger (of a SR or a UCI as specified/defined herein in the present disclosure, e.g., a 1-bit indicator) on PUCCH resource(s) of the first UL channel as in Step-1, the UE could start the first prohibit timer pn-ProhibitTimer1 from or X1 symbol(s)/slot(s)/etc. after the first (or last) symbol/slot/etc. of the transmission of the (initial) PN message/trigger, wherein the UE could determine or identity the value of X1 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The following UE's behaviors and/or operations could be based on or according to at least: (i) when/if (e.g., higher layer(s) of) the UE has determined, detected or declared at least one event (or has been determining, detecting or declaring the at least one event) according to or following those specified/defined herein in the present disclosure—or the event(s) triggering condition(s) has been met or achieved or satisfied, and/or (2) the at least one event that is (being) detected, declared or determined could be associated to the CSI reporting setting provided by CSI-ReportConfig/UEI-ReportConfig that provides or configures necessary information and/or setting(s)—e.g., enabling the at least one event and/or providing/configuring type(s) of the at least one event—for the UE-initiated beam reporting according to or following those specified herein in the present disclosure.
When the first prohibit timer pn-ProhibitTimer1 is running, the UE is not allowed to send, transmit or trigger any PN message(s)/trigger(s)—e.g., of the same/identical version as/to the initial PN message/trigger as specified/defined herein in the present disclosure—on PUCCH resource(s) of the first UL channel as in Step-1 according to or following those specified herein in the present disclosure; in this case, the UE may still be able or allowed to send, transmit or trigger PN message(s)/trigger(s)—e.g., of different version(s) from the initial PN message/trigger as specified/defined herein in the present disclosure—on PUCCH resource(s) of the first UL channel as in Step-1 according to or following those specified herein in the present disclosure. That is, when the first prohibit timer pn-ProhibitTimer1 is not running, the UE is able or allowed to send, transmit or trigger any PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure.
(Higher layer(s) of) the UE could stop or not run the first prohibit timer pn-ProhibitTimer1 (pending PN message(s)/trigger(s) could be cancelled) only when/if the first prohibit timer pn-ProhibitTimer1 expires or has expired.
(Higher layer(s) of) the UE could stop or not run the first prohibit timer pn-ProhibitTimer1 (pending PN message(s)/trigger(s) could be cancelled) according to or based on one or more of, and/or (higher layer(s) of) the UE could still run the first prohibit timer pn-ProhibitTimer1 (i.e., not stopped or expired), but the UE may still be able or allowed to send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure according to or based on one or more of:
   When/if or after the first prohibit timer pn-ProhibitTimer1 expires or has expired;
   When/if or after the UE has transmitted or sent, on the (semi-statically) (pre-) configured PUSCH resource(s)—e.g., Type1 CG—of the second UL channel as in Step-2 associated/specific to the PUCCH resource(s) of the first UL channel as in Step-1 that carries or conveys the (initial) PN message/trigger according to or following those defined/specified herein in the present disclosure, the UEI beam report including the corresponding report content(s)/quantity(s) as specified/defined herein in the present disclosure; e.g., (higher layer(s) of) the UE could stop the first prohibit timer pn-ProhibitTimer1, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y2 symbol(s)/slot(s)/etc. after the first (or last) symbol/slot/etc. of the transmission of the PUSCH resource(s) of the second UL channel that carries or conveys the UEI beam report, wherein the UE could determine or identity the value of Y2 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-2; e.g., (higher layer(s) of) the UE could stop the first prohibit timer pn-ProhibitTimer1, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y3 symbol(s)/slot(s)/etc. after the first (or last) symbol/slot/etc. of the reception of the PDCCH candidate(s) that carries or conveys the beam indication DCI, and/or the reception of PDSCH that carries or conveys the (unified) TCI state(s) activation/deactivation MAC CE, wherein the UE could determine or identity the value of Y3 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-2, and the one or more TCI states/TCI state updates/activated TCI states/TCI codepoints have become applicable; e.g., (higher layer(s) of) the UE could stop the first prohibit timer pn-ProhibitTimer1, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y4 symbol(s)/slot(s)/etc. after the first (or last) symbol/slot/etc. of when the received, indicated, provided or activated one or more TCI states/TCI state updates/activated TCI states/TCI codepoints have become applicable, wherein the UE could determine or identity the value of Y4 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE has reset the event(s) evaluation, assessment, detection, declaration and/or determination process (e.g., by resetting the counting(s) of the instance(s) of the event(s) and/or the time window/time gap/time offset/timer for counting of the instance(s) of the event(s)); e.g., (higher layer(s) of) the UE could stop the first prohibit timer pn-ProhibitTimer2, and/or still run the first prohibit timer pn-ProhibitTimer1 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y5 symbol(s)/slot(s)/etc. after resetting or the first (or last) symbol/slot/etc. of resetting the event(s) evaluation, assessment, detection, declaration and/or determination process as specified/defined herein in the present disclosure, wherein the UE could determine or identity the value of Y5 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE could have determined or identified or triggered a transmission of a PN message/trigger of a different version from the initial PN message/trigger according to or following those specified herein in the present disclosure; e.g., (higher layer(s) of) the UE could stop the first prohibit timer pn-ProhibitTimer1, and/or still run the first prohibit timer pn-ProhibitTimer1 but send, transmit or trigger the transmission of the PN message/trigger that is of a different version from the initial PN message/trigger and/or PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y6 symbol(s)/slot(s)/etc. after determining, identifying or triggering a transmission of, or the first (or last) symbol/slot/etc. of determining, identifying or triggering a transmission of the PN message/trigger that is of a different version from the initial PN message/trigger as specified/defined herein in the present disclosure, wherein the UE could determine or identity the value of Y6 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

After the UE has transmitted or sent, on (semi-statically) (pre-) configured PUSCH resource(s)—e.g., Type1 CG—of the second UL channel as in Step-2 associated/specific to the PUCCH resource(s) of the first UL channel as in Step-1 that carries or conveys the (initial) PN message/trigger according to or following those defined/specified herein in the present disclosure, the UEI beam report including the corresponding report content(s)/quantity(s) as specified/defined herein in the present disclosure, the UE could start the second prohibit timer pn-ProhibitTimer2 from or X2 symbol(s)/slot(s)/etc. after the first (or last) symbol/slot/etc. of the transmission of the PUSCH resource(s) of the second UL channel that carries or conveys the UEI beam report, wherein the UE could determine or identity the value of X2 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The following UE's behaviors and/or operations could be based on or according to at least: (i) when/if (e.g., higher layer(s) of) the UE has determined, detected or declared at least one event (or has been determining, detecting or declaring the at least one event) according to or following those specified/defined herein in the present disclosure, and/or (2) the at least one event that is (being) detected, declared or determined could be associated to the CSI reporting setting provided by CSI-ReportConfig/UEI-ReportConfig that provides or configures necessary information and/or setting(s)—e.g., enabling the at least one event and/or providing/configuring type(s) of the at least one event—for the UE-initiated beam reporting according to or following those specified herein in the present disclosure.
When the second prohibit timer pn-ProhibitTimer2 is running, the UE is not allowed to send, transmit or trigger any PN message(s)/trigger(s)—e.g., of the same/identical version as/to the initial PN message/trigger as specified/defined herein in the present disclosure—on PUCCH resource(s) of the first UL channel as in Step-1 according to or following those specified herein in the present disclosure; in this case, the UE may still be able or allowed to send, transmit or trigger PN message(s)/trigger(s)—e.g., of different version(s) from the initial PN message/trigger as specified/defined herein in the present disclosure—on PUCCH resource(s) of the first UL channel as in Step-1 according to or following those specified herein in the present disclosure. That is, when the second prohibit timer pn-ProhibitTimer2 is not running, the UE is able or allowed to send, transmit or trigger any PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure.
(Higher layer(s) of) the UE could stop or not run the second prohibit timer pn-ProhibitTimer2 (pending PN message(s)/trigger(s) could be cancelled) only when/if the second prohibit timer pn-ProhibitTimer2 expires or has expired.
(Higher layer(s) of) the UE could stop or not run the second prohibit timer pn-ProhibitTimer2 (pending PN message(s)/trigger(s) could be cancelled) according to or based on one or more of, and/or (higher layer(s) of) the UE could still run the second prohibit timer pn-ProhibitTimer2 (i.e., not stopped or expired), but the UE may still be able or allowed to send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure according to or based on one or more of:
   When/if or after the second prohibit timer pn-ProhibitTimer2 expires or has expired;
   When/if or after the UE has received from or indicated or provided or activated by the network (e.g., the network 130), in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-2; e.g., (higher layer(s) of) the UE could stop the second prohibit timer pn-ProhibitTimer2, and/or still run the second prohibit timer pn-ProhibitTimer2 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y4 symbol(s)/slot(s)/etc. after the first (or last) symbol/slot/etc. of the reception of the PDCCH candidate(s) that carries or conveys the beam indication DCI, and/or the reception of PDSCH that carries or conveys the (unified) TCI state(s) activation/deactivation MAC CE, wherein the UE could determine or identity the value of Y4 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-2, and the one or more TCI states/TCI state updates/activated TCI states/TCI codepoints have become applicable; e.g., (higher layer(s) of) the UE could stop the second prohibit timer pn-ProhibitTimer2, and/or still run the second prohibit timer pn-ProhibitTimer2 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y4 symbol(s)/slot(s)/etc. after the first (or last) symbol/slot/etc. of when the received, indicated, provided or activated one or more TCI states/TCI state updates/activated TCI states/TCI codepoints have become applicable, wherein the UE could determine or identity the value of Y4 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE has reset the event(s) evaluation, assessment, detection, declaration and/or determination process (e.g., by resetting the counting(s) of the instance(s) of the event(s) and/or the time window/time gap/time offset/timer for counting of the instance(s) of the event(s)); e.g., (higher layer(s) of) the UE could stop the second prohibit timer pn-ProhibitTimer2, and/or still run the second prohibit timer pn-ProhibitTimer2 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y5 symbol(s)/slot(s)/etc. after resetting or the first (or last) symbol/slot/etc. of resetting the event(s) evaluation, assessment, detection, declaration and/or determination process as specified/defined herein in the present disclosure, wherein the UE could determine or identity the value of Y5 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE could have determined or identified or triggered a transmission of a PN message/trigger of a different version from the initial PN message/trigger according to or following those specified herein in the present disclosure; e.g., (higher layer(s) of) the UE could stop the second prohibit timer pn-ProhibitTimer2, and/or still run the second prohibit timer pn-ProhibitTimer2 but send, transmit or trigger the transmission of the PN message/trigger that is of a different version from the initial PN message/trigger and/or PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y6 symbol(s)/slot(s)/etc. after determining, identifying or triggering a transmission of, or the first (or last) symbol/slot/etc. of determining, identifying or triggering a transmission of the PN message/trigger that is of a different version from the initial PN message/trigger as specified/defined herein in the present disclosure, wherein the UE could determine or identity the value of Y6 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

Optionally, after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-2, and/or after the UE has received from or indicated or provided or activated by the network, in a beam indication DCI (e.g., via/by TCI codepoint(s) of TCI field(s) in DCI format 1_1/1_2 with or without DL assignment) and/or (unified) TCI state(s) activation/deactivation MAC CE, one or more TCI states/TCI state updates/activated TCI states/TCI codepoints, e.g., in response to the UEI beam report transmitted/sent in Step-2 and the one or more TCI states/TCI state updates/activated TCI states/TCI codepoints have become applicable, the UE could start the third prohibit timer pn-ProhibitTimer3 from or X4 symbol(s)/slot(s)/etc. after the first (or last) symbol/slot/etc. of the reception of the PDCCH candidate(s) that carries or conveys the beam indication DCI, and/or after the reception of PDSCH that carries or conveys the (unified) TCI state(s) activation/deactivation MAC CE, and/or after the first (or last) symbol/slot/etc. of when the received, indicated, provided or activated one or more TCI states/TCI state updates/activated TCI states/TCI codepoints have become applicable, wherein the UE could determine or identity the value of X4 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. The following UE's behaviors and/or operations could be based on or according to at least: (i) when/if (e.g., higher layer(s) of) the UE has determined, detected or declared at least one event (or has been determining, detecting or declaring the at least one event) according to or following those specified/defined herein in the present disclosure, and/or (2) the at least one event that is (being) detected, declared or determined could be associated to the CSI reporting setting provided by CSI-ReportConfig/UEI-ReportConfig that provides or configures necessary information and/or setting(s)—e.g., enabling the at least one event and/or providing/configuring type(s) of the at least one event—for the UE-initiated beam reporting according to or following those specified herein in the present disclosure.
When the third prohibit timer pn-ProhibitTimer3 is running, the UE (e.g., the UE 116) is not allowed to send, transmit or trigger any PN message(s)/trigger(s)—e.g., of the same/identical version as/to the initial PN message/trigger as specified/defined herein in the present disclosure—on PUCCH resource(s) of the first UL channel as in Step-1 according to or following those specified herein in the present disclosure; in this case, the UE may still be able or allowed to send, transmit or trigger PN message(s)/trigger(s)—e.g., of different version(s) from the initial PN message/trigger as specified/defined herein in the present disclosure—on PUCCH resource(s) of the first UL channel as in Step-1 according to or following those specified herein in the present disclosure. That is, when the third prohibit timer pn-ProhibitTimer3 is not running, the UE is able or allowed to send, transmit or trigger any PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure.
(Higher layer(s) of) the UE could stop or not run the third prohibit timer pn-ProhibitTimer3 (pending PN message(s)/trigger(s) could be cancelled) only when/if the third prohibit timer pn-ProhibitTimer3 expires or has expired.
(Higher layer(s) of) the UE could stop or not run the third prohibit timer pn-ProhibitTimer3 (pending PN message(s)/trigger(s) could be cancelled) according to or based on one or more of, and/or (higher layer(s) of) the UE could still run the third prohibit timer pn-ProhibitTimer3 (i.e., not stopped or expired), but the UE may still be able or allowed to send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein in the present disclosure according to or based one or more of:
   When/if or after the third prohibit timer pn-ProhibitTimer3 expires or has expired;
   When/if or after (higher layer(s) of) the UE has reset the event(s) evaluation, assessment, detection, declaration and/or determination process (e.g., by resetting the counting(s) of the instance(s) of the event(s) and/or the time window/time gap/time offset/timer for counting of the instance(s) of the event(s)); e.g., (higher layer(s) of) the UE could stop the third prohibit timer pn-ProhibitTimer3, and/or still run the third prohibit timer pn-ProhibitTimer3 but send, transmit or trigger PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y5 symbol(s)/slot(s)/etc. after resetting or the first (or last) symbol/slot/etc. of resetting the event(s) evaluation, assessment, detection, declaration and/or determination process as specified/defined herein in the present disclosure, wherein the UE could determine or identity the value of Y6 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.
   When/if or after (higher layer(s) of) the UE could have determined or identified or triggered a transmission of a PN message/trigger of a different version from the initial PN message/trigger according to or following those specified herein in the present disclosure; e.g., (higher layer(s) of) the UE could stop the third prohibit timer pn-ProhibitTimer3, and/or still run the third prohibit timer pn-ProhibitTimer3 but send, transmit or trigger the transmission of the PN message/trigger that is of a different version from the initial PN message/trigger and/or PN message(s)/trigger(s)—e.g., of the same/identical version as/to and/or different version(s) from the initial PN message/trigger as specified/defined herein in the present disclosure—on PUCCH resource(s) of the first UL channel as in Step-1 according to or following those specified herein, starting from or Y7 symbol(s)/slot(s)/etc. after determining, identifying or triggering a transmission of, or the first (or last) symbol/slot/etc. of determining, identifying or triggering a transmission of the PN message/trigger that is of a different version from the initial PN message/trigger as specified/defined herein in the present disclosure, wherein the UE could determine or identity the value of Y7 according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified herein in the present disclosure, (higher layer(s) of) the UE could simultaneously (or at the same time) run one or more of the first prohibit timer pn-ProhibitTimer1, the second prohibit timer pn-ProhibitTimer2, and the third prohibit timer pn-ProhibitTimer3, if configured, in parallel. Furthermore, the UE could be provided or configured by the network, in a/the (same) configuration e.g. via/in RRC signaling(s)/parameter(s), one or more of the first prohibit timer pn-ProhibitTimer1, the second prohibit timer pn-ProhibitTimer2, and the third prohibit timer pn-ProhibitTimer3. The value(s)/parameter(s) of the first prohibit timer pn-ProhibitTimer1, and/or the second prohibit timer pn-ProhibitTimer2, and/or the third prohibit timer pn-ProhibitTimer3 could be the same or different/separate. In additional, the value(s) of the first prohibit timer pn-ProhibitTimer1 (e.g., higher layer configured), and/or the second prohibit timer pn-ProhibitTimer2 (e.g., higher layer configured), and/or the third prohibit timer pn-ProhibitTimer3 (e.g., higher layer configured) could be zero(s), which could be equivalent to that the corresponding prohibit timer(s) is not running, or is stopped, or is expired. Alternatively, (the value(s) of) the first prohibit timer pn-ProhibitTimer1, and/or the second prohibit timer pn-ProhibitTimer2, and/or the third prohibit timer pn-ProhibitTimer3 may not be provided or configured by the network, e.g., absent or not present/provided/configured in/by the corresponding higher layer RRC signaling(s)/parameter(s) e.g. CSI-ReportConfig(s)/UEI-ReportConfig(s) that provides or configures the CSI reporting setting(s) that provides, configures or comprises necessary information and/or setting(s) for the UEI beam reporting; in this case, the UE could expect the value(s) of the first prohibit timer pn-ProhibitTimer1, and/or the second prohibit timer pn-ProhibitTimer2, and/or the third prohibit timer pn-ProhibitTimer3 as zero(s), which could be equivalent to that the corresponding prohibit timer(s) is not running, or is stopped, or is expired.

In one operation mode (Mode C), upon detection and/or declaration of one or more of the events (e.g., the fourth event) as specified or defined herein in the present disclosure, a/the UE could transmit or send to the network a UEI (beam) report, wherein the UEI report(s) could contain, provide, include or comprise at least a pre-notification (PN) message/trigger—e.g., of (report-) type (A) or (report-) type (C) as specified herein in the present disclosure, and/or the (corresponding) UEI report content(s) or report quantity(s)—e.g., of (report-) type (B) or (report-) type (C) as specified herein in the present disclosure. For this case/setting,
Step-1: the UE could send the PN message/trigger, e.g., via a first UL channel comprising one or more PUCCH resources, wherein the one or more PUCCH resources could be periodic and/or semi-persistent (e.g., pre-configured by the network for transmitting the PN message/trigger), and each of the one or more PUCCH resources (e.g., of format 0/1/2/3/4) could be from one or more PUCCH resource sets, e.g., configured/provided for the UEI reporting(s) or more specifically for transmitting/sending the PN message/trigger—in one example, the UE could be provided or configured with one or more indicators for the one or more PUCCH resource sets (for instance, the one or more indicators could be provided in PUCCH-Config, PUCCH-ResourceSet and/or etc. that configures the one or more PUCCH resource sets) indicating that the one or more PUCCH resource sets are for the UEI reporting or more specifically, are for transmitting or sending the PN message/trigger. Here, the PN message/trigger could indicate a transmission of the UEI report content(s)/quantity(s) associated/specific to the PN message/trigger, and/or request UL resource allocation and/or indication for a second UL channel that could carry or convey the UEI report content(s)/quantity(s). Furthermore, the UE could be provided or configured or indicated by the network, e.g., via higher layer RRC signaling(s)/parameter(s) and/or MAC CE command(s) and/or dynamic DCI based L1 signaling(s) based on or according to a corresponding UE's capability or capability signaling, information/configuration(s)/setting(s) of or related to the first PUCCH channel/resource(s) that carries or conveys the PN message/trigger. For instance, the information/configuration(s)/setting(s) could be provided or configured or indicated or comprised or contained or included in a higher layer RRC parameter/configuration denoted by PN-Config comprising one or more of:
   preNotificationId: used to modify a PN (or SR) configuration and to indicate, in LogicalChannelConfig, the PN (or SR) configuration to which a logical channel is mapped and to indicate the PN (or SR) configuration for which a PN (or SR) resource (i.e., the first PUCCH resource) is used
   pn-ProhibitTimer: a timer for PN (or SR) transmission on PUCCH. Value is in symbol, slot, ms and etc. For instance, Value 1sym corresponds to 1 symbol, Value 2sym corresponds to 2 symbols, and so on; Value 1sl corresponds to 1 slot, Value 2sl corresponds to 2 slots, and so on; Value msl corresponds to 1 ms, value ms2 corresponds to 2 ms, and so on. If pn-ProhibitTimer is absent, the UE could apply the value 0.
   pn-TransMax: a maximum number of PN (or SR) transmissions. Value n4 corresponds to 4, value n8 corresponds to 8, and so on.
   periodicityAndOffset: PN (or SR) periodicity and offset in number of symbols or slots. The periodicity(s) could be configured or provided depending on the chose subcarrier spacing.
   Phy-PriorityIndex: indicate whether this PN (or SR) resource (i.e., the first PUCCH resource) is high or low priority in PHY prioritization/multiplexing handling. Value p0 indicates low priority and value p1 indicates high priority.
   resourceId: ID of the (first) PUCCH resource for the first UL/PUCCH channel in which the UE could send the PN (or SR). The actual PUCCH-Resource is configured in PUCCH-Config of the same UL BWP and serving cell as this PreNotificationResourceConfig. The network could configure a PUCCH-Resource of PUCCH-format0 or PUCCH-format1 or PUCCH-format3 or PUCCH-format4.
Step-2: after the UE has transmitted the PN message/trigger, the UE could expect to receive from the network a (downlink/uplink) DCI in response to the PN message/trigger, within a time window starting from the first or last symbol/slot/etc. of the transmission of the PN message/trigger. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the (downlink/uplink) DCI in response to the PN message/trigger. The (downlink/uplink) DCI in response to the PN message/trigger could comprise one or more of the following components:
   Component-1: a one-bit indicator with ‘1’ (or ‘0’) indicating acknowledgement (ACK) for the PN message/trigger and ‘0’ (or ‘1’) indicating non-ACK (NACK) for the PN message/trigger
   Component-2: a time gap/duration (e.g., in number of symbols/slots/etc.)
   Component-3: a priority order or value for the PN message/trigger and/or the UEI report content(s)/quantity(s) associated/specific to the PN message/trigger as defined/specified herein in the present disclosure
   Component-4: a time offset (e.g., in number of symbols/slots/etc.)
   Component-5: resource allocation and/or indication for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource allocation and/or indication for the second UL channel could comprise or correspond/refer to one or more of the following components, and/or could be determined according to one or more of the following components:
      Component-5a: one or more resource IDs/indexes, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      Component-5b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position could be used/applied for transmitting or sending the UEI report content(s)/quantity(s) in/via the second UL channel.
      Component-5c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network (e.g., the network 130), e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator could be used/applied for transmitting or sending the UEI report content(s)/quantity(s) in/via the second UL channel.
      Component-5d: one or more resource configuration/setting IDs/indexes, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
      Component-5e: one or more resource set IDs/indexes with each of the corresponding resource sets comprising one or more resources, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
      Component-5f: one or more CSI reporting configuration/setting IDs/indexes, wherein a CSI reporting setting/configuration is provided by CSI-ReportConfig.
      Component-5g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource allocation and/or indication for the second UL channel could correspond to the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
      Component-5h: a starting symbol/slot/etc. for the second UL channel
      Component-5i: an ending symbol/slot/etc. for the second UL channel
      Component-5j: a time duration/length (e.g., in form/terms/number of symbols/slot/etc.), within which the resources could be allocated/indicated for the second UL channel
      Component-5k: a number of resources allocated/indicated for the second UL channel
      Component-5l: an uplink (scheduling) grant, e.g., for PUSCH(s)

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc.
Component-6: indication of resource(s) not used/available/applicable for the second UL channel for transmitting or sending the UEI report content(s)/quantity(s) associated/specific to the PN message/trigger as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the resource(s) not used/available/applicable for the second UL channel could be in form of one or more of the following components, and/or the resource(s) not used/available/applicable for the second UL channel could be determined according to one or more of the components:
   Component-6a: one or more resource IDs/indexes—for one or more resources not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc., wherein bitwidth k of a resource ID/index could be determined or calculated or computed with respect to a number of resources (denoted by K) in a resource set such that k=└log₂K┘ or k=┌log₂K┐. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
   Component-6b: a bitmap of length K with each entry/bit position of the bitmap corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an entry/bit position of the bitmap is set to ‘1’ (or ‘0’), the corresponding resource associated/specific to the entry/bit position may not be used or applicable or available for transmitting or sending the UEI report content(s)/quantity(s) in/via the second UL channel.
   Component-6c: one or more (e.g., K) indicators each corresponding or associated or specific to a resource in a resource set (e.g., comprising a number K of resources), wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. Here, the resource set could be associated/specific to the PN message/trigger sent/transmitted in/via the first UL channel, and could comprise (1) (odd/even indexed) resources configured, indicated or provided for the second UL channel, (2) the (first/latest or odd/even indexed) resource(s) configured, indicated or provided for the second UL channel k0 slots/symbols/etc. after the first or last symbol/slot/etc. of the transmission of the PN message/trigger, (3) the (first/latest or odd/even indexed) resource(s) configured, indicated or provided for the second UL channel k1 slots/symbols/etc. after the first or last symbol/slot/etc. of the reception of the (downlink/uplink) DCI, and/or (4) the (first/latest or odd/even indexed) resource(s) configured, indicated or provided for the second UL channel k2 after a slot/symbol/etc. t0, wherein the value(s) of k0, k1, k2 and/or t0 as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling. When/if an indicator is set to ‘1’ (or ‘0’), the corresponding resource associated/specific to the indicator may not be used or applicable or available for transmitting or sending the UEI report content(s)/quantity(s) in/via the second UL channel.
   Component-6d: one or more resource configuration/setting IDs/indexes—for the resource(s) not used/applicable/available for the second UL channel, wherein a resource configuration/setting could correspond to a CSI resource setting/configuration provided by CSI-ResourceConfig, a PUCCH resource configuration/setting provided by PUCCH-Config, a configured grant PUSCH configuration/setting provided by ConfiguredGrantConfig, and/or etc.
   Component-6e: one or more resource set IDs/indexes with each of the corresponding resource sets comprising one or more resources—for the resource(s) not used/applicable/available for the second UL channel, wherein a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. A resource set could correspond to a CSI resource set provided by NZP-CSI-RS-ResourceSet or CSI-SSB-ResourceSet, a PUCCH resource set provided by PUCCH-ResourceSet, and/or etc.
   Component-6f: one or more CSI reporting configuration/setting IDs/indexes—for the resource(s) not used/applicable/available for the second UL channel, wherein a CSI reporting setting/configuration is provided by CSI-ReportConfig.
   Component-6g: the CSI request field indicated/provided in the (downlink/uplink) DCI, e.g., DCI format 0_1, set to valid value(s)/index(es), e.g., pointing to the index(es) of the entries in CSI-AperiodicTriggerStateList or the index(es) of the codepoint(s) in the aperiodic CSI trigger state subselection MAC CE. In this case, the resource(s) not used/applicable/available for the second UL channel could correspond to that/those associated to or provided in/by the CSI resource setting(s) and/or CSI reporting setting(s) associated or specific or corresponding to CSI-AssociatedReportConfigInfo associated or specific or corresponding to the aperiodic CSI trigger state indicated by the (value(s) of) CSI request field.
   Component-6h: a starting symbol/slot/etc. for the resource(s) not used/applicable/available for the second UL channel
   Component-6i: an ending symbol/slot/etc. for resource(s) not used/applicable/available for the second UL channel
   Component-6j: a time duration/length (e.g., in form/terms/number of symbols/slot/etc.), within which the resources may not be used/applicable/available for the second UL channel
   Component-6k: a number of resources not used/available/applicable for the second UL channel
   Component-6l: an uplink (scheduling) grant, e.g., for PUSCH(s), such that the scheduled/granted resource(s) may not be used/available/applicable for the second UL channel

Throughout the present disclosure, a resource could correspond to a time-domain resource and/or a frequency-domain resource comprising or corresponding to one or more of: a transmission occasion (TO), a slot, a symbol, a PRB, a PUCCH resource, a PUSCH resource, a PRACH preamble and/or etc. In this case, resource(s) in the resource set specified/described herein in the present disclosure other than the resource(s) not used/available/applicable for the second UL channel in the same resource set could be used or applied for transmitting the UEI report content(s)/quantity(s) via/in the second UL channel.
Component-7: information related to modulation and/or coding (e.g., channel coding rate) scheme(s) for the second UL channel comprising one or more of: a modulation and coding scheme (MCS) and/or a MCS index among a set of candidate MCS schemes for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, a modulation order and/or a modulation order index among a set of candidate modulation orders for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, and/or a (channel) coding rate and/or a (channel) coding rate index among a set of candidate (channel) coding rates for the second UL channel configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling.

One or more of the components including Component-1-Component-7 as defined/specified herein in the present disclosure could correspond to or could be realized, specified or implemented as/by one or more new DCI fields in the corresponding (downlink/uplink) DCI format; optionally, one or more of the components including Component-1-Component-7 as defined/specified herein in the present disclosure could correspond to or could be repurposed by one or more bits of one or more existing DCI fields in the corresponding (downlink/uplink) DCI format. Furthermore, the UE (e.g., the UE 116) could indicate to the network, e.g., in form of a UE's capability via a UE's capability signaling, which one or more of the components including Component-1-Component-7 as defined/specified herein in the present disclosure the UE could support or expect, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, which one or more of the components including Component-1-Component-7 as defined/specified herein in the present disclosure the UE could support or expect.
Step-3: the UE could send or transmit to the network, via/in the second UL channel, the UEI report content(s)/quantity(s) associated/specific to the PN message/trigger transmitted or sent via/in the first UL channel as defined/specified herein in the present disclosure, wherein the second UL channel could comprise one or more periodic/semi-persistent PUCCH resources (e.g., pre-configured by the network for sending the UEI report content(s)/quantity(s)) and/or one or more PUSCH resources (e.g., pre-configured by the network for sending the UEI report content(s)/quantity(s) including CG PUSCH of Type1 and/or Type2, dynamically granted/scheduled by the network for sending the UEI report content(s)/quantity(s) including DG PUSCH); the UE could determine or identify the resource(s) for the second UL channel according to one or more of:
   In one example, when/if the UE does not report to the network the capability signaling that they could support Step-2 as specified/described herein in the present disclosure, and/or when/if the UE reports to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure may not be enabled and/or the UE may not expect to receive from the network the (downlink/uplink) DCI format in response to the transmission of the PN message/trigger in Step-1, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, when/if the UE reports to the network the capability signaling that they could support Step-2 as specified/described herein in the present disclosure, and/or when/if the UE does not report to the network that they could not support Step-2 as specified/described herein in the present disclosure, and/or when/if the UE is configured or provided or indicated by the network, e.g., via higher layer RRC signaling(s)/parameter(s) and/or MAC CE command(s) and/or dynamic DCI based L1 signaling(s) based on or according to the corresponding UE's capability or capability signaling, that Step-2 as specified/described herein in the present disclosure could be enabled and/or the UE could expect to receive from the network the (downlink/uplink) DCI format in response to the transmission of the PN message/trigger in Step-1, and/or when/if after the UE has transmitted or sent the PN message/trigger via the first UL channel in Step-1 but does not receive the (downlink/uplink) DCI in response to the PN message/trigger as specified or discussed in Step-2 a first time period/window/duration (e.g., denoted by t1 in terms/form/number of symbols/slots/etc.) after the first or last symbol/slot/etc. of the transmission of the PN message/trigger, and/or when/if after the UE has transmitted or sent the (same) PN message/trigger max_PN times/instances—each separated by a time gap—within a second time period/window/duration (e.g., denoted by t2 in terms/form/number of symbols/slots/etc.) but does not receive the (downlink/uplink) DCI in response to the last transmission time/instance of the (same) PN message/trigger, the UE could transmit or send to the network-via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a third time period/window/duration (e.g., denoted by t3 in terms/form/number of symbols/slots/etc.) after the first or last symbol/slot/etc. of the transmission of the PN message/trigger. The value(s) of the max_PN, the time gap, the first, second and/or third time period(s)/window(s)/duration(s) t1, t2 and/or t3 could be determined according to: (i) fixed value(s) in system specification(s) and/or per RRC configuration, e.g., t1, t2, t3=0 symbol/slot/etc., t1, t2, t3=1 symbol/slot/etc., t1, t2, t3=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the first, second and/or third time period(s)/window(s)/duration(s) t1, t2 and/or t3 (e.g., in form/terms/number of slots/symbols/etc.): for example, the value(s) of t1, t2 and/or t3 could be or could correspond to random value(s) within a value range [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value(s) and the value range including value(s) of min_value and/or max_value could correspond to slot/symbol/etc. index(es); for another example, the value(s) of t1, t2 and/or t3 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
   In another example, the UE could expect to receive the (downlink/uplink) DCI in response to the transmission of the PN message/trigger comprising one or more of the components including Component-1-Component-7 as defined/specified herein in the present disclosure according to network's configuration(s) and/or indication(s) based on the corresponding UE's capability or capability signaling following those specified/described herein in the present disclosure.
      For example, the UE could expect to receive the (downlink/uplink) DCI in response to the transmission of the PN message/trigger comprising one or more of the components including Component-1, Component-2, Component-3 and/or Component-4 and/or Component-7 (i.e., except Component-5 and Component-6) according to network's configuration(s) and/or indication(s) based on the corresponding UE's capability or capability signaling following those specified/described herein in the present disclosure, and/or the UE could expect to receive the (downlink/uplink) DCI in response to the transmission of the PN message/trigger comprising one or more of the components including Component-1-Component-7 according to network's configuration(s) and/or indication(s) based on the corresponding UE's capability or capability signaling following those specified/described herein in the present disclosure but only receives the (downlink/uplink) DCI in response to the transmission of the PN message/trigger comprising one or more of the components including Component-1 (e.g., an ACK for the PN message/trigger), Component-2, Component-3 and/or Component-4 and/or Component-7 (i.e., except Component-5 and Component-6). For this design example, the UE could transmit or send to the network (e.g., the network 130)—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t2 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t2 could be determined according to: (i) fixed value(s) in system specification(s) and/or per RRC configuration, e.g., t2=0 symbol/slot/etc., t2=1 symbol/slot/etc., t2=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For instance, for (ii), the value(s) of t2 could be determined according to the time gap/duration provided/indicated in Component-2 and/or the time offset provided/indicated in Component-4 as/in part of the (downlink/uplink) DCI format in response to the PN message/trigger; for (iii), i.e., for the UE to autonomously determine or select the value(s) of the time period/window/duration t2 (e.g., in form/terms/number of slots/symbols/etc.): for example, the value(s) of t2 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t2 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission does not indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure. For this design example, the UE could determine or identify the resource(s) for the second UL channel according to the resource allocation and/or indication provided/indicated in/by Component-5 and/or Component-6 as specified herein in the present disclosure. The UE could then send or transmit the UEI report content(s)/quantity(s) associated/specific to the PN message/trigger sent/transmitted in/via the first UL channel (in Step-1) on or over the determined or identified resource(s) for the second UL channel. For this design example—e.g., the (downlink/uplink) DCI in response to the PN message/trigger transmission could indicate, provide or comprise component(s) related to dynamic scheduling of resource(s) such as Component-5g, Component-5l, Component-6g and Component-6l, the UE could have sent or transmitted the (same) PN message/trigger max_PN times or instances to indicate a transmission of the UEI report content(s)/quantity(s) associated/specific to the PN message/trigger before a timer expires—but without transmitting or sending the actual UEI report content(s)/quantity(s) associated/specific to the PN message/trigger, and/or though the UE may expect to receive from the network a (downlink/uplink) DCI in response to the PN message/trigger according to those specified herein in the present disclosure, the UE does not receive the DCI (e.g., indicating an ACK for the PN message/trigger) within the time window, wherein the value(s) of max_PN and/or the timer could be provided/configured/indicated by the network, e.g., via higher layer RRC signaling(s)/parameter(s) and/or MAC CE command(s) and/or dynamic DCI based L1 signaling(s), based on or according to a corresponding UE's capability or capability signaling, and/or the UE may or may not be provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the (downlink/uplink) DCI in response to the PN message/trigger is received p1 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, and/or when/if the earliest available UL resource(s) determined or identified according to or based on the received (downlink/uplink) DCI following those specified herein in the present disclosure (e.g., according to or based on one or more of the Component-1-Component-7) is p2 (in number of slots/symbols/etc.) earlier in time than the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel. The value(s) of p1, p2, t1 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q1 (in number of slots/symbols/etc.) earlier in time than the reception of the (downlink/uplink) DCI in response to the PN message/trigger, and/or when/if the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger is q2 (in number of slots/symbols/etc.) earlier in time than the earliest available UL resource(s) determined or identified according to or based on the received (downlink/uplink) DCI following those specified herein in the present disclosure (e.g., according to or based on one or more of the Component-1-Component-7), the UE could transmit or send to the network-via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes. Furthermore, the value(s) of q1, q2 and/or the time period/window/duration as specified/defined herein in the present disclosure could be provided/indicated/configured by the network, e.g., via higher layer RRC signaling(s)/parameter(s) and/or MAC CE command(s) and/or dynamic DCI based L1 signaling(s), according to or based on a corresponding UE's capability or capability signaling.
      For another example, the UE (e.g., the UE 116) could expect to receive the (downlink/uplink) DCI in response to the transmission of the PN message/trigger comprising one or more of the components including at least Component-5 and/or Component-6 according to network's configuration(s) and/or indication(s) based on the corresponding UE's capability or capability signaling following those specified/described herein in the present disclosure, and/or the UE could have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel. For this design example, regardless of how/when the periodic/semi-persistent PUCCH resource(s) and/or the PUSCH resource(s) such as CG PUSCH of Type1 and/or Type2 is (pre-) configured by the network for transmitting or sending the UEI report content(s)/quantity(s) as defined or specified herein in the present disclosure, the UE could determine or identify the resource(s) for the second UL channel according to the received (downlink/uplink) DCI format in Step-2, e.g., according to the resource allocation and/or indication provided/indicated in/by Component-5 and/or Component-6 as specified herein in the present disclosure provided or indicated by/in the received (downlink/uplink) DCI format in Step-2. The UE could then send or transmit the UEI report content(s)/quantity(s) associated/specific to the PN message/trigger sent/transmitted in/via the first UL channel (in Step-1) on or over the determined or identified resource(s) for the second UL channel.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel, regardless of whether or not a (downlink/uplink) DCI format in response to the PN message/trigger is received, the UE could transmit or send to the network—via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.
      For another example, when/if (or as long as) the UE have been provided or configured by the network, e.g., via higher layer RRC signaling(s)/parameter(s), the one or more periodic/semi-persistent PUCCH resources (e.g., pre-configured by the network) for sending the UEI report content(s)/quantity(s) via/in the second UL channel and/or the one or more PUSCH resources (e.g., pre-configured by the network including CG PUSCH of Type1 and/or Type2) for sending the UEI report content(s)/quantity(s) via/in the second UL channel and/or the UE receives a (downlink/uplink) DCI in response to the PN message/trigger comprising at least an ACK (e.g., in Component-1) for the transmission of the PN message/trigger, regardless of whether or not the (downlink/uplink) DCI format in response to the PN message/trigger comprises or provides or indicates component(s)—e.g., Component-5 and/or Component-6 as defined/specified herein in the present disclosure—that provides or comprises or indicates resource allocation and/or indication for the second UL channel to carry or convey the UEI report content(s)/quantity(s) associated/specific to the PN message/trigger, the UE could transmit or send to the network-via/in the second UL channel—the UEI report content(s)/quantity(s) associated/specific to the PN message/trigger using or on or over the most recent and/or available UL resource(s) including the periodic/semi-persistent PUCCH resource(s) pre-configured by the network for sending the UEI report content(s)/quantity(s) and/or the PUSCH resource(s) pre-configured by the network for sending the UEI report content(s)/quantity(s) such as CG PUSCH of Type1 and/or Type2 a time period/window/duration (e.g., denoted by t1 in terms/form/number of symbols/slots/etc.) after the first or last symbol/slot/etc. of the transmission of the PN message/trigger and/or after the first or last symbol/slot/etc. of the reception of the (downlink/uplink) DCI format in response to the transmission of the PN message/trigger. The value(s) of the time period/window/duration t1 could be determined according to: (i) fixed value(s) in system specification(s) and/or per RRC configuration, e.g., t1=0 symbol/slot/etc., t1=1 symbol/slot/etc., t1=2 symbols/slots/etc., (ii) network's configuration(s) and/or indication(s), e.g., via higher layer RRC signaling(s)/parameter(s) and/or MAC CE command(s) and/or dynamic DCI based L1 signaling(s), according to or based on a corresponding UE's capability or capability signaling, and/or (iii) UE's autonomous determination or selection, which could be further sent to the network via/by/in various UL channels/signals including CSI/beam report and/or UE's capability signaling(s). For the UE to autonomously determine or select the value(s) of the time period/window/duration t1 (e.g., in form/terms/number of slots/symbols/etc.): for example, the value(s) of t1 could be or could correspond to a random value within a value range of [min_value, max_value], wherein the value range including value(s) of min_value and/or max_value could be configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the random value and the value range including value(s) of min_value and/or max_value could correspond to a slot/symbol/etc. index; for another example, the value(s) of t1 could be (randomly) determined/selected from a set of candidate values configured, provided or indicated by the network, e.g., via higher layer RRC signaling(s)/parameter(s) and/or MAC CE command(s) and/or dynamic DCI based L1 signaling(s), according to or based on a corresponding UE's capability or capability signaling, wherein the candidate values could correspond to slot/symbol/etc. indexes.

The (downlink/uplink) DCI (in Step-2) in response to the transmission of the PN message/trigger in Step-1 could be in various DCI formats including (uplink) DCI format(s) including DCI format(s) 0_0, 0_1 and/or 0_2, (downlink) DCI format(s) including DCI format(s) 1_0, 1_1 and/or 1_2, group common DCI format(s) 2_1, 2_2, 2_3 and/or 2_4 for a group of UEs, and/or etc. When/if a group common DCI (e.g., of DCI format(s) 2_1, 2_2, 2_3 and/or 2_4) is provided or indicated in response to the PN message/trigger transmission in Step-1 via/in the first UL channel:
The group common DCI format could comprise or indicate or provide one or more sets of components (e.g., one or more of Component-1-Component-7 as defined/specified herein in the present disclosure) with each set of components dedicated or specific or associated or corresponding to a PN message/trigger or a transmission of a PN message/trigger or a configuration of PN message/trigger or an order/index of a (transmission of) PN message/trigger, and therefore, a UE among a group of UEs; optionally or alternatively, each set of components provided, comprised or provided in the group common DCI could be dedicated or specific or associated or corresponding to identification (ID) information related to a UE including a C-RNTI, a UE ID/index, and/or etc.
A UE could transmit or send a PN message/trigger in Step-1; upon detection or reception of the group common DCI in Step-2, the UE could identify or determine the set of components (e.g., one or more of Component-1-Component-7 as defined or specified herein in the present disclosure) provided/indicated in the group common DCI format that are associated or specific or dedicated to the PN message/trigger in Step-1 and/or any other identification information related to the UE. The UE could then identify or determine the resource(s) based on the identified or determined set of components following those specified herein in the present disclosure to use for transmitting or sending the second UL channel carrying or conveying the UEI report content(s)/quantity(s) associated/specific to the PN message/trigger transmitted or sent in Step-1 via/in the first UL channel.

A/the UE could be indicated or configured or provided by the network (e.g., the network 130), e.g., via higher layer RRC signaling(s)/parameter(s) and/or MAC CE command(s) and/or dynamic DCI based L1 signaling(s) based on or according to a corresponding UE's capability or capability signaling, one or more indicators to indicate to the UE to follow which one or more of the operation Mode A, Mode B and Mode C to determine or identify corresponding UL channel(s)/resource(s) for transmitting or sending the UEI beam report(s) as specified/defined herein in the present disclosure.
In one example, the one or more indicators could correspond to a higher layer RRC parameter ueiReportMode provided or indicated or configured in the higher layer RRC parameter(s)/signaling(s) including CSI-ReportConfig, CSI-ResourceConfig, UEI-ReportConfig and/or UEI-ResourceConfig that configures or provides information, configuration(s) and/or setting(s) for the UEI beam reporting. For this design example, when/if the higher layer RRC parameter ueiReportMode is set to ‘Mode A’, the UE could follow those specified in the operation Mode A and/or Mode C as specified herein in the present disclosure to determine or identify the corresponding UL channel(s)/resource(s) for sending or transmitting the UEI beam report(s); when/if the higher layer RRC parameter ueiReportMode is set to ‘Mode B’, the UE could follow those specified in the operation Mode B and/or Mode C as specified herein in the present disclosure to determine or identify the corresponding UL channel(s)/resource(s) for sending or transmitting the UEI beam report(s); and when/if the higher layer RRC parameter ueiReportMode is set to ‘Mode C’, the UE could follow those specified in the operation Mode C as specified herein in the present disclosure to determine or identify the corresponding UL channel(s)/resource(s) for sending or transmitting the UEI beam report(s).
In another example, the one or more indicators could correspond to a mode-selection DCI indicator/field in a DCI format. For this design example, the mode-selection DCI indicator/field could be of 1-bit; when/if the 1-bit mode-selection DCI indicator/field is set to ‘0’ (or ‘1’), the UE could follow those specified in the operation Mode A and/or Mode C as specified herein in the present disclosure to determine or identify the corresponding UL channel(s)/resource(s) for sending or transmitting the UEI beam report(s); and when/if the 1-bit mode-selection DCI indicator/field is set to ‘1’ (or ‘0’), the UE could follow those specified in the operation Mode B and/or Mode C as specified herein in the present disclosure to determine or identify the corresponding UL channel(s)/resource(s) for sending or transmitting the UEI beam report(s). Optionally, the mode-selection DCI indicator/field could be of 2-bit; when/if the 2-bit mode-selection DCI indicator/field is set to ‘00’ (‘01’, ‘10’ or ‘11’), the UE could follow those specified in the operation Mode A and/or Mode C as specified herein in the present disclosure to determine or identify the corresponding UL channel(s)/resource(s) for sending or transmitting the UEI beam report(s); when/if the 2-bit mode-selection DCI indicator/field is set to ‘01’ (‘00’, ‘10’ or ‘11’), the UE could follow those specified in the operation Mode B and/or Mode C as specified herein in the present disclosure to determine or identify the corresponding UL channel(s)/resource(s) for sending or transmitting the UEI beam report(s); when/if the 2-bit mode-selection DCI indicator/field is set to ‘10’ (‘00’, ‘10’ or ‘11’), the UE could follow those specified in the operation Mode C as specified herein in the present disclosure to determine or identify the corresponding UL channel(s)/resource(s) for sending or transmitting the UEI beam report(s); and the 2-bit mode-selection DCI indicator/field set to ‘11’ (‘00’, ‘01’ or ‘10’) is reserved/unused. For this design example, the mode-selection DCI indicator/field could be a new DCI indicator/field used/applied to switch between/among different operation modes (Mode A, Mode B and Mode C in the present disclosure); alternatively, one or more bits of one or more existing DCI fields in the corresponding DCI format(s) could be repurposed as the mode-selection DCI indicator/field. Furthermore, the UE could be configured or provided by the network, e.g., via higher layer RRC signaling(s)/parameter(s), whether or not the mode-selection DCI indicator/field as defined/specified herein in the present disclosure is present (or absent) in the corresponding DCI format(s). For instance, a higher layer RRC parameter modeSelectionPresentInDCI could be provided or indicated or configured in the higher layer RRC parameter(s)/signaling(s) including CSI-ReportConfig, CSI-ResourceConfig, UEI-ReportConfig and/or UEI-ResourceConfig that configures or provides information, configuration(s) and/or setting(s) for the UEI beam reporting; in this case, when/if modeSelectionPresentInDCI is configured or enabled or present or set to ‘on’, ‘enabled’, ‘1’ and/or etc., the mode-selection DCI indicator/field could be present in the corresponding DCI format(s); otherwise, e.g., when/if modeSelectionPresentInDCI is not configured or enabled or present or is absent, or is configured/present and set to ‘off’, ‘disabled’, ‘0’ and/or etc., the mode-selection DCI indicator/field may not be present or could be absent in the corresponding DCI format(s). For this design example, the corresponding DCI format(s) could be or could correspond to DCI format(s) 0_0, 0_1, 0_2, 0_3, 1_0, 1_1, 1_2 and/or 1_3.

Furthermore, the UE could indicate or send to the network their capability(s) (i.e., in form of their capability signaling/reporting) of supporting one or more of the operation Mode A, Mode B and Mode C as specified/defined herein in the present disclosure. For instance, the UE could indicate or send to the network a capability signaling/reporting comprising one or more of the following components:
{Mode A}
{Mode B}
{Mode C}
{Mode A, Mode B}
{Mode A, Mode C}
{Mode B, Mode C}
{Mode A, Mode B, Mode C}

The UE could also expect to receive from the network a (downlink/uplink) DCI in response to Step-3 in/of Mode A, Step-2 in/of Mode B and/or Step-3 in/of Mode B according to or following those specified herein in the present disclosure, within a time window starting from the first or last symbol/slot/etc. of the transmission of the beam/CSI report. The UE could be configured or provided or indicated by the network, e.g., via higher layer RRC signaling(s) and/or MAC CE command(s) and/or dynamic DCI based L1 signaling(s) based on or according to a corresponding UE's capability or capability signaling, the value(s) of the time window. In addition, the UE could indicate to the network, e.g., in form of a UE's capability via a UE's capability signaling, whether or not the UE could expect to receive from the network the (downlink/uplink) DCI in response to the PN message/trigger transmission, and/or the UE could be provided or configured or indicated by the network, e.g., via higher layer RRC signaling(s)/parameter(s) and/or MAC CE command(s) and/or dynamic DCI based L1 signaling(s) based on or according to the corresponding UE's capability or capability signaling as specified/defined herein, whether or not the UE could expect to receive from the network the (downlink/uplink) DCI in response to Step-3 in/of Mode A, Step-2 in/of Mode B and/or Step-3 in/of Mode B according to or following those specified herein in the present disclosure. The (downlink/uplink) DCI in response to the beam/CSI report transmitted/sent in/by Step-3 in/of Mode A, Step-2 in/of Mode B and/or Step-3 in/of Mode B according to or following those specified herein in the present disclosure could comprise one or more of the Component-1 to Component-7 as specified herein in the present disclosure.

According to or following those specified herein in the present disclosure, for operation Mode A, Mode B and/or Mode C according to or following those specified herein in the present disclosure, for a given length/duration of a prohibit timer (e.g., higher layer configured) specific to a transmission of a PN message/trigger on/via PUCCH resource(s) of the first UL channel as in Step-1, the UE could start the prohibit timer pn-ProhibitTimer from or X symbol(s)/slot(s)/etc. after the first (or last) symbol/slot/etc. of the transmission of an (initial) PN message/trigger, wherein the UE could determine or identity the value of X according to or based on: (i) a fixed value (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling, when/if there is/are a number (Q≥1) of measurement occasion(s)—denoted by MO(s)—for evaluating, assessing, detecting, determining and/or declaring instance(s) of the corresponding event(s) and/or the corresponding event(s) according to or following those specified herein in the present disclosure,
before the prohibit timer could expire or stop or not run; and/or
before the UE could receive a DCI in response to the transmission of the PN message/trigger (e.g., as in Step-2 in Mode A); and/or
before the UE could send or transmit the UEI beam report on the corresponding PUSCH resource(s) of the second UL channel (e.g., as in Step-3 in Mode A or Step-2 in Mode B); and/or
before the UE could receive a beam indication DCI/MAC CE to indicate a TCI state update/activation and/or a TCI codepoint update/activation, e.g., in response to the UEI beam report; and/or
before the UE could reset the event(s) evaluation process; and/or
before the UE could determine or identify a transmission of a PN message/trigger of a different version from the initial PN message/trigger according to or following those specified herein in the present disclosure.
   and/or Q is greater than or equal to threshold. Here, the UE could determine or identify the value(s) of Q and the threshold according to or based on: (1) fixed value(s) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling.

According to or following those specified herein in the present disclosure, regarding transmission(s) of the PN message/trigger on the PUCCH resource(s) of the first UL channel:
Transmission scheme A: after the UE has transmitted or sent a first (or an initial) PN message/trigger via/in a first (or initial) transmission occasion in/on one or more first PUCCH resources of the first UL channel as in Step-1, the UE could transmit or send a second (or another) PN message via/in a second (or another) transmission occasion in/on one or more second PUCCH resources of the first UL channel as in Step-1 (and/or increment the PN-COUNTER by l/one), when/if one or more of the followings are achieved, satisfied and/or held:
   There is no prohibit timer(s) running;
   There is no prohibit timer(s) running starting from or K0 symbol(s)/slot(s)/etc. after the first (or last) symbol/slot/etc. of the transmission of the first (or the initial) PN message/trigger via/in the first (or the initial) transmission occasion in/on the first PUCCH resource(s) of the first UL channel as in Step-1
   There is no prohibit timer(s) running prior to/before or K1 symbol(s)/slot(s)/etc. prior to/before the first (or last) symbol/slot/etc. of the transmission of the second (or the next) PN message/trigger via/in the second (or the next) transmission occasion in/on the second PUCCH resource(s) of the first UL channel as in Step-1

When/if one or more of the conditions mentioned herein are not achieved, satisfied and/or held, (higher layer(s) of) the UE could cancel pending PN message(s)/trigger(s) and/or pending transmission(s) of PN message(s)/trigger(s) and/or transmission of the second PN message/trigger-hence, the corresponding UEI beam reporting procedure(s), and/or reset the PN-COUNTER to zero. The UE could determine or identity the value of K0 and/or K1 according to or based on: (i) a fixed value(s) (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore,
In one example, the second transmission occasion could be the most recent/latest transmission occasion relative/next to (in time) the first transmission occasion, and the second PUCCH resource(s) could be the most recent/latest PUCCH resource(s) relative/next to (in time) the first PUCCH resource(s), wherein the first/second PUCCH resource(s) could be configured or provided for the first UL channel to carry the PN message(s)/trigger(s).
In another example, the second transmission occasion could be the most recent/latest transmission occasion relative/next to (in time) the first transmission occasion that is available/valid to carry or convey the second PN message/trigger, and the second PUCCH resource(s) could be the most recent/latest PUCCH resource(s) relative/next to (in time) the first PUCCH resource(s) that is available/valid to carry or convey the second PN message/trigger, wherein the first/second PUCCH resource(s) could be configured or provided for the first UL channel to carry the PN message(s)/trigger(s).
In addition, the first PN message/trigger (e.g., in form of a one-bit SR or UCI) and the second PN message/trigger (e.g., in form of a one-bit SR or UCI) could be initiated or triggered based on or according to a/the (same) evaluation, assessment, detection and/or declaration of a/the (same) event according to or following those specified herein in the present disclosure. In this case, the UE could transmit or send to the network, via/on one or more UL resources (e.g., DG/CG PUSCH resource(s)) of the second UL channel, a UEI beam report, wherein report quantity(s) of the UEI beam report could be obtained, determined or identified based on or according to the (same) evaluation, assessment, detection and/or declaration of the (same event). Transmission scheme B: after the UE has transmitted or sent a first (or an initial) PN message/trigger via/in a first (or initial) transmission occasion in/on one or more first PUCCH resources of the first UL channel as in Step-1, the UE could transmit or send a second (or another) PN message via/in a second (or another) transmission occasion in/on one or more second PUCCH resources of the first UL channel as in Step-1 (and/or increment the PN-COUNTER by 1/one), when/if one or more of the followings are achieved, satisfied and/or held:
There is no prohibit timer(s) running;
There is no prohibit timer(s) running starting from or K0 symbol(s)/slot(s)/etc. after the first (or last) symbol/slot/etc. of the transmission of the first (or the initial) PN message/trigger via/in the first (or the initial) transmission occasion in/on the first PUCCH resource(s) of the first UL channel as in Step-1
There is no prohibit timer(s) running prior to/before or K1 symbol(s)/slot(s)/etc. prior to/before the first (or last) symbol/slot/etc. of the transmission of the second (or the next) PN message/trigger via/in the second (or the next) transmission occasion in/on the second PUCCH resource(s) of the first UL channel as in Step-1
(Higher layer(s) of) the UE has detected and/or declared the corresponding event(s) that triggers or initiates the transmission of the first PN message/trigger according to or based on those specified herein in the present disclosure—after transmission of the first PN message/trigger, e.g., starting from or L0 symbol(s)/slot(s)/etc. after the first (or last) symbol/slot/etc. of the transmission of the first (or the initial) PN message/trigger via/in the first (or the initial) transmission occasion in/on the first PUCCH resource(s) of the first UL channel as in Step-1, (higher layer(s) of) the UE could (re-)evaluate and/or (re-)assess instance(s) of corresponding event(s) that triggers or initiates the transmission of the first PN message/trigger.

When/if one or more of the conditions mentioned herein are not achieved, satisfied and/or held, (higher layer(s) of) the UE (e.g., the UE 116) could cancel pending PN message(s)/trigger(s) and/or pending transmission(s) of PN message(s)/trigger(s) and/or transmission of the second PN message/trigger—hence, the corresponding UEI beam reporting procedure(s), and/or reset the PN-COUNTER to zero. The UE could determine or identity the value of K0 and/or K1 and/or L0 according to or based on: (i) a fixed value(s) (e.g., 0) in system specification(s), (ii) network's configuration(s)/indication(s) via higher layer RRC signaling(s)/parameter(s) and/or MAC CE command(s) and/or dynamic DCI based L1 signaling(s) according to or based on a corresponding UE's capability or capability signaling, and/or (iii) UE's autonomous determination/selection, which could be further sent to the network via various UL channels/signals and/or in part of a CSI/beam report and/or UE's capability signaling. Furthermore,
In one example, the second transmission occasion could be the most recent/latest transmission occasion relative/next to (in time) the first transmission occasion, and the second PUCCH resource(s) could be the most recent/latest PUCCH resource(s) relative/next to (in time) the first PUCCH resource(s), wherein the first/second PUCCH resource(s) could be configured or provided for the first UL channel to carry the PN message(s)/trigger(s).
In another example, the second transmission occasion could be the most recent/latest transmission occasion relative/next to (in time) the first transmission occasion that is available/valid to carry or convey the second PN message/trigger, and the second PUCCH resource(s) could be the most recent/latest PUCCH resource(s) relative/next to (in time) the first PUCCH resource(s) that is available/valid to carry or convey the second PN message/trigger, wherein the first/second PUCCH resource(s) could be configured or provided for the first UL channel to carry the PN message(s)/trigger(s).

In addition, the first PN message/trigger (e.g., in form of a one-bit SR or UCI) and the second PN message/trigger (e.g., in form of a one-bit SR or UCI) could be initiated or triggered based on or according to a/the (same) evaluation, assessment, detection and/or declaration of a/the (same) event according to or following those specified herein in the present disclosure. Alternatively, the first PN message/trigger (e.g., in form of a one-bit SR or UCI) and the second PN message/trigger (e.g., in form of a one-bit SR or UCI) could be respectively initiated or triggered based on or according to a first and a second evaluations, assessments, detections and/or declarations of a/the (same) event according to or following those specified herein in the present disclosure, wherein the first and the second evaluations/assessments/detections/declarations of the event could be different or separate. Optionally, the first PN message/trigger (e.g., in form of a one-bit SR or UCI) and the second PN message/trigger (e.g., in form of a one-bit SR or UCI) could be respectively initiated or triggered based on or according to evaluation(s), assessment(s), detection(s) and/or declaration(s) of a first event and a second event according to or following those specified herein in the present disclosure, wherein the first event and the second event could be different or separate. In this case, the UE could obtain, determine or identify, based on the first evaluation/assessment/detection/declaration of the event and/or the evaluation/assessment/detection/declaration of the first event as specified/defined herein in the present disclosure, first report quantity(s) for transmitting a first UEI beam report specific/associated/corresponding/linked to the transmission of the first PN message/trigger; and obtain, determine or identify, based on the second evaluation/assessment/detection/declaration of the event and/or the evaluation/assessment/detection/declaration of the second event as specified/defined herein in the present disclosure, second report quantity(s) for transmitting a second UEI beam report specific/associated/corresponding/linked to the transmission of the second PN message/trigger. In this case,
When/if the first report quantity(s) of/for the first UEI beam report is identical to or same as the second report quantity(s) of/for the second UEI beam report, the UE could transmit or send to the network, via/on one or more UL resources (e.g., DG/CG PUSCH resource(s)) of the second UL channel, the first/second UEI beam report comprising the first/second report quantities.
When/if the first report quantity(s) of/for the first UEI beam report is different/separate from the second report quantity(s) of/for the second UEI beam report, the UE could transmit or send to the network, via/on one or more UL resources (e.g., DG/CG PUSCH resource(s)) of the second UL channel, the first UEI beam report comprising the second report quantities.
When/if the first report quantity(s) of/for the first UEI beam report is identical to or same as the second report quantity(s) of/for the second UEI beam report, the UE could transmit or send to the network, via/on one or more UL resources (e.g., DG/CG PUSCH resource(s)) of the second UL channel, the second UEI beam report comprising the first report quantities
When/if the first report quantity(s) of/for the first UEI beam report is identical to or same as the second report quantity(s) of/for the second UEI beam report, the UE could transmit or send to the network, via/on one or more UL resources (e.g., DG/CG PUSCH resource(s)) of the second UL channel, the first (or second) UEI beam report comprising the first (or second) report quantities based on or according to one or more of: (1) the first (or second) UEI beam report has a smaller (or larger) number of UCI bits/payload size than that of the second (or first) UEI beam report, (2) network's configuration(s)/indication(s) e.g. via higher layer RRC signaling(s)/parameter(s) and/or MAC CE command(s) and/or dynamic DCI based L1 signaling(s) based on or according to a corresponding UE's capability or capability signaling, (3) the first (or second) PN message/trigger is transmitted or sent earlier (or later) in time than the transmission of the second (or first) PN message/trigger.

The UE could send or transmit or indicate to the network, e.g., via/in their corresponding capability signaling(s), their capability(s) of supporting one or more of the following components:
{Transmission scheme A and the corresponding UE's operations/behaviors specified/described therein}
{Transmission scheme B and the corresponding UE's operations/behaviors specified/described therein}
{Transmission scheme A and the corresponding UE's operations/behaviors specified/described therein, Transmission scheme B and the corresponding UE's operations/behaviors specified/described therein}

It could be by default or as a basic UE feature/functionality, e.g., when/if the UE does not send or transmit or indicate to the network the capability signaling(s) mentioned herein, to support {Transmission scheme A and the corresponding UE's operations/behaviors specified/described therein}. Furthermore, when/of PN-COUNTER becomes equal to pn-TransMax, the UE could cancel pending PN message(s)/trigger(s) and/or pending transmission(s) of PN message(s)/trigger(s)-hence, the corresponding UEI beam reporting procedure(s), and/or reset the PN-COUNTER to zero.

Throughout the present disclosure, a candidate beam is equivalent to a candidate new beam or a new beam, and a beam/“beam” reported in a UEI (beam) report or a CSI report or a beam report in general can also be referred to as or equivalent to a report content/quantity—including SSBRI/CRI, L1-RSRP/L1-SINR and/or etc.—corresponding/associated/specific to a beam reported in a UEI (beam) report or a CSI report or a beam report in general, and/or one or more report contents/quantities—including SSBRI(s)/CRI(s), L1-RSRP(s)/L1-SINR(s) and/or etc.—corresponding/associated/specific to a beam reported in a UEI (beam) report or a CSI report or a beam report in general, and/or a resource indicator such as a SSBRI or a CRI reported in a UEI (beam) report or a CSI report or a beam report in general, and/or a beam metric such as a L1-RSRP or a L1-SINR reported in a UEI (beam) report or a CSI report or a beam report in general. In addition, throughout the present disclosure, a reference signal (RS) could be equivalent to a RS resource, a RS resource index, a RS resource configuration index, a RS index and/or etc.

Throughout the present disclosure, a CSI/beam report can also be referred to as or equivalent to a UE-initiated (UEI) report of (report-) type (A), (report-) type (B) and/or (report-) type (C) as specified herein in the present disclosure, and the report content(s)/report quantity(s)/indicator(s) in a CSI/beam report can also be referred to as or equivalent to report content(s)/report quantity(s)/indicator(s) in a UEI report. As specified herein in the present disclosure, transmission of a UEI report (or equivalently, a CSI/beam report) could be preceded by transmission of a corresponding PN message, e.g., as UCI(s) via DG or Type1/Type2 CG PUSCH(s) and/or (periodic) PUCCH resource(s). Furthermore, transmission of a UEI report (or UEI report content(s)/quantity(s)) and transmission of a corresponding PN message can be in the same CSI report or reporting instance, or optionally, transmission of a UEI report (or UEI report content(s)/quantity(s)) and transmission of a corresponding PN message can be in separate CSI reports or reporting instances.

Throughout the present disclosure, unless otherwise specified, the UE could transmit/send the PN message(s)/trigger(s), e.g., in one or more or in a single or separate (UEI) report(s), of one or more or a single or separate PN configuration(s), according to those specified/defined herein in the present disclosure—e.g., configured/provided/indicated by the network (e.g., via RRC and/or MAC CE and/or DCI) subject to a UE's capability or capability signaling. In addition, a PN configuration (e.g., provided by PN-Config) as specified or defined herein in the present disclosure could also be referred to as a UEI configuration (e.g., provided by UEI-Config), and the transmission/indication of/by a PN message/trigger could also be referred to as transmission/indication of/by UEI report content(s)/UEI report(s).

Throughout the present disclosure, a radio link or beam quality could correspond to one or more absolute or differential RSRP and/or SINR values, wherein the RSRP/SINR value(s) could correspond to L1-RSRP/L1-SINR value(s) and/or filtered (e.g., L2/L3) RSRP and/or filtered (e.g., L2/L3) SINR value(s). Throughout the present disclosure, a UE could be provided or indicated or configured or informed or instructed by the network (e.g., the network 130), e.g., via higher layer RRC signaling(s)/parameter(s) and/or MAC CE command(s) and/or dynamic DCI based L1 signaling(s) based on or according to a corresponding UE's capability or capability signaling, to apply or use a two-part UCI structure/format or a one-part UCI structure/format to transmit or send a UEI report.

Throughout the present disclosure, a UEIBRI can also be referred to as or equivalent to or represented/denoted by/as a UEI-CSI indicator/indication (UEICI)—i.e., a UEIBRI used in the examples specified throughout the present disclosure can be replaced by/with a UEICI. In addition, a UEIBR can also be referred to as or equivalent to or represented/denoted by/as a UEI CSI report (UEICR) such that a UEIBR used in the examples throughout the present disclosure can be replaced by/with a UEICR.

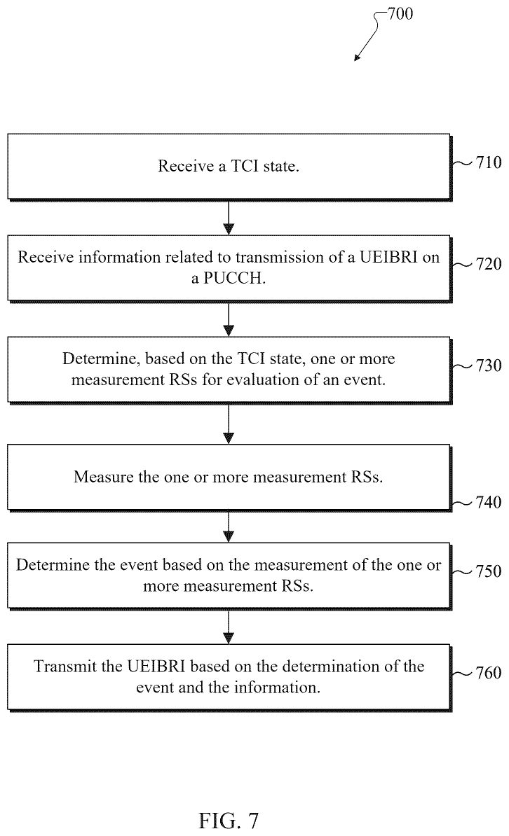

FIG. 7 illustrates an example method 700 performed by a UE in a wireless communication system according to embodiments of the present disclosure. The method 700 of FIG. 7 can be performed by any of the UEs 111-116 of FIG. 1, such as the UE 116 of FIG. 3, and a corresponding method can be performed by any of the BSs 101-103 of FIG. 1, such as BS 102 of FIG. 2. The method 700 is for illustration only and other embodiments can be used without departing from the scope of the present disclosure.

The method begins with the UE receiving a TCI state (710). The UE then receives information related to transmission of a UEIBRI on a PUCCH (720). For example, in 720, the information includes a timer for transmission of the UEIBRI or a maximum number of transmissions of the UEIBRI. In various embodiments, the PUCCH is configured with a PUCCH resource configuration and the PUCCH resource configuration is provided in a CSI report configuration for UE-initiated beam reporting.

The UE then determines, based on the TCI state, one or more measurement RSs for evaluation of an event (730). For example, in 730, the one or more measurement RSs include a first RS specific to the TCI state and the first RS corresponds to a CSI-RS indicated in the TCI state or a SS/PBCH block quasi co-located with the CSI-RS. In various embodiments, the one or more measurement RSs include one or more first RSs, information related to the one or more first RSs including IDs or indexes, of the one or more first RSs, is provided in a higher layer parameter TCI-State, and the higher layer parameter TCI-State configures the indicated TCI state.

The UE then measures the one or more measurement RSs (740). The UE then determines the event based on the measurement of the one or more measurement RSs (750). The UE then transmits the UEIBRI based on the determination of the event and the information (760). For example, in 760, the UE transmits the UEIBRI when the timer is not running and starts the timer after transmitting the UEIBRI. In various embodiments, the UE drops transmission of the UEIBRI when the maximum number of transmissions of the UEIBRI is reached.

Any of the above variation embodiments can be utilized independently or in combination with at least one other variation embodiment. The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive a transmission configuration indication (TCI) state; and
receive information related to transmission of a user equipment (UE)-initiated beam report indication (UEIBRI) on a physical uplink control channel (PUCCH); and
a processor operably coupled with the transceiver, the processor configured to:
determine, based on the TCI state, one or more measurement reference signals (RSs) for evaluation of an event;
measure the one or more measurement RSs; and
determine the event based on the measurement of the one or more measurement RSs,
wherein the transceiver is further configured to transmit, based on the determination of the event and the information, the UEIBRI.

2. The UE of claim 1, wherein the information comprises:
a timer for transmission of the UEIBRI; and
a maximum number of transmissions of the UEIBRI.

3. The UE of claim 2, wherein:
the transceiver is further configured to, when the timer is not running, transmit the UEIBRI; and
the processor is further configured to start the timer after transmitting the UEIBRI.

4. The UE of claim 2, wherein the processor is further configured to drop transmission of the UEIBRI when the maximum number of transmissions of the UEIBRI is reached.

5. The UE of claim 1, wherein:
the PUCCH is configured with a PUCCH resource configuration; and
the PUCCH resource configuration is provided in a channel state information (CSI) report configuration for UE-initiated beam reporting.

6. The UE of claim 1, wherein:
the one or more measurement RSs include a first RS specific to the TCI state; and
the first RS corresponds to:
a channel state information reference signal (CSI-RS) indicated in the TCI state; or
a synchronization signal/physical broadcast channel (SS/PBCH) block quasi co-located with the CSI-RS.

7. The UE of claim 1, wherein:
the one or more measurement RSs include one or more first RSs;
information related to the one or more first RSs including resource identities (IDs) or indexes, of the one or more first RSs, is provided in a higher layer parameter TCI-State, and
the higher layer parameter TCI-State configures the indicated TCI state.

8. A base station (BS), comprising:
a processor; and
a transceiver operably coupled with the transceiver, the processor configured to:
transmit a transmission configuration indication (TCI) state;
transmit information related to reception of a user equipment (UE)-initiated beam report indication (UEIBRI) on a physical uplink control channel (PUCCH);
transmit one or more measurement reference signals (RSs) associated with the TCI state and evaluation of an event; and
receive the UEIBRI after occurrence of the event.

9. The BS of claim 8, wherein the information comprises:
a timer for transmission of the UEIBRI; and
a maximum number of transmissions of the UEIBRI.

10. The BS of claim 9, wherein:
the UEIBRI is transmitted when the timer is not running; and
the timer is started after transmission of the UEIBRI.

11. The BS of claim 9, wherein transmission of the UEIBRI is dropped when the maximum number of transmissions of the UEIBRI is reached.

12. The BS of claim 8, wherein:
the PUCCH is configured with a PUCCH resource configuration; and
the PUCCH resource configuration is provided in a channel state information (CSI) report configuration for UE-initiated beam reporting.

13. The BS of claim 8, wherein:
the one or more measurement RSs include a first RS specific to the TCI state; and
the first RS corresponds to:
a channel state information reference signal (CSI-RS) indicated in the TCI state; or
a synchronization signal/physical broadcast channel (SS/PBCH) block quasi co-located with the CSI-RS.

14. The BS of claim 8, wherein:
the one or more measurement RSs include one or more first RSs;
information related to the one or more first RSs including resource identities (IDs) or indexes, of the one or more first RSs, is provided in a higher layer parameter TCI-State, and
the higher layer parameter TCI-State configures the indicated TCI state.

15. A method performed by a user equipment (UE), the method comprising:
receiving a transmission configuration indication (TCI) state;
receiving information related to transmission of a user equipment (UE)-initiated beam report indication (UEIBRI) on a physical uplink control channel (PUCCH);
determining, based on the TCI state, one or more measurement reference signals (RSs) for evaluation of an event;
measuring the one or more measurement RSs;
determining the event based on the measurement of the one or more measurement RSs; and
transmitting, based on the determination of the event and the information, the UEIBRI.

16. The method of claim 15, wherein the information comprises:
a timer for transmission of the UEIBRI; and
a maximum number of transmissions of the UEIBRI.

17. The method of claim 16, further comprising:
starting the timer after transmitting the UEIBRI; and
wherein the UEIBRI is transmitted when the timer is not running.

18. The method of claim 16, further comprising dropping transmission of the UEIBRI when the maximum number of transmissions of the UEIBRI is reached.

19. The method of claim 15, wherein:
the PUCCH is configured with a PUCCH resource configuration; and
the PUCCH resource configuration is provided in a channel state information (CSI) report configuration for UE-initiated beam reporting.

20. The method of claim 15, wherein:
the one or more measurement RSs include a first RS specific to the TCI state; and
the first RS corresponds to:
a channel state information reference signal (CSI-RS) indicated in the TCI state; or
a synchronization signal/physical broadcast channel (SS/PBCH) block quasi co-located with the CSI-RS.
